(19) United States
(12) Patent Application Publication
(10) Pub. No.: US 2026/0198492 A1
(43) Pub. Date: Jul. 16, 2026

(54) FORMULATIONS FOR CONTROL OR REPELLENCY OF PESTS

(71) Applicant: BEDOUKIAN RESEARCH, INC., Danbury, CT (US)

(72) Inventors: Rodrigo Oliveira da Silva, Bethel, CT (US); David Zareh Bedoukian, Redding, CT (US); Rafael Borges, Fraiburgo-Sc (BR)

(73) Assignee: BEDOUKIAN RESEARCH, INC., Danbury, CT (US)

(21) Appl. No.: 19/428,927

(22) Filed: Dec. 22, 2025

Related U.S. Application Data
(60) Provisional application No. 63/741,508, filed on Jan. 3, 2025.

(51) Int. Cl. A01N 37/06; A01N 31/06; A01N 35/06; A01N 37/18; A01N 43/06; A01N 43/16; A01P 17/00

(52) U.S. Cl. CPC A01N 37/06; A01N 31/06; A01N 35/06; A01N 37/18; A01N 43/06; A01N 43/16; A01P 17/00

(57) ABSTRACT

Control or repellency of one or more pests is obtained by disrupting intraspecific communication or interspecific communication in the one or more pests, by exposing the one or more pests to a formulation comprising one or more compounds of structure (A) represented by the structure:

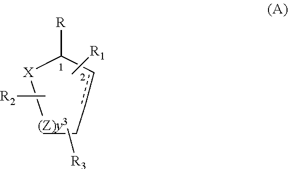

wherein the one or more compounds of structure (A) are present in an amount from about 0.001% by weight to about 99% by weight, based on the total weight of the formulation. The one or more pests are selected from agricultural pests, forestry pests, storage pests, urban pests, and public health pests. The intraspecific communications include pheromone-mediated communications associated with mating and aggregation behavior, the effect of sexual and aggregation pheromones, and attraction in general. The interspecific communications include allelochemical communications associated with oviposition behavior, the attraction effect of crops and other substrates, and attraction in general, and visual mediated communications associated with attraction behavior due the effect of colors, shapes and textures of substrates, and attraction in general.

### RELATED APPLICATION

This application claims the benefit of copending U.S. Application No. 63/741,508, filed Jan. 3, 2025, which is incorporated herein by reference in its entirety.

### BACKGROUND OF THE DISCLOSURE

### 1. Field of the Disclosure

This disclosure relates to formulations, including synergistic formulations, used to repel or control pests, including agricultural, forestry, storage, and urban/public health pests, by disrupting intraspecific communication or interspecific communication in the pests.

### 2. Description of the Related Art

The use of pesticides plays an important role in the control of pests in a variety of applications, for example, in agriculture, forestry, storage and public health. Agricultural pesticides kill or control crop pests, and are essential to increase crop productivity and, thus, to meet the growing demand caused by the rapidly growing world population. Pesticides used in forestry and storage applications help prevent pest damage to forests and storage items, respectively. Additionally, pesticides help protect the spread of disease from public health pests.

Pesticides consist of formulations with one or more active ingredients effective in pest and disease control and are commonly classified according to their use, wherein herbicides, insecticides, fungicides, nematicides and acaricides are the most commonly used. The pesticides are rarely applied in the pure form, as the products found in the market are usually formulations comprising one or more active ingredients and other substances classified as inert, which enhance their effects and facilitate their application. When these inert compounds aid the action of the active ingredient and/or modify the physico-chemical characteristics of each spray, they are called adjuvants.

Carbamate, organochlorine, pyrethroid, sulfoximine, neonicotinoid, pyridine azomethine, diamide, organophosphate, phenylpyrazole, oxadiazine, and ketoenol pesticides are commonly used against pests. Safety questions have been raised concerning the use of certain of these pesticides, and some governments have restricted the amount of the active component that may be employed in formulations. This itself presents a further problem since the efficacy of certain of these pesticides declines over time and therefore they need to be formulated at higher than effective dosages in order to maintain their effectiveness. Furthermore, some pests have developed resistance to certain of these pesticides due to their wide spread usage. Also, certain of these pesticides are relatively expensive.

Research regarding the key attributes of pesticides strongly suggests that consumers prefer products with high efficacy, long-lasting protection, and safety in use. Leading pesticide products currently available to consumers claim to meet these requirements but almost always disappoint the user for having one or more unacceptable properties. Thus, there is a need to provide products, especially Blatoddea, Coleoptera, Dermaptera, Diptera, Hemiptera, Hymenoptera, Lepidoptera, Orthoptera, Psocodea, Siphonaptera, Thysanoptera, Zygentoma, Araneae, Ixodida, Mesostigmata, Sarcoptiformes, Scorpiones, Trombidiformes, and Acari, pesticide products, which meet the preferences of consumers.

In particular, there is a need to provide a formulation which eliminates or minimizes exposure of pesticides to the people, plants, and other animals which may be exposed to areas of application. A further need is for a formulation that overcomes or minimizes resistance to conventional pesticides and provides long lasting effects, thereby limiting the need for frequent re-application to treated areas.

A yet further need is for a formulation that is safe for humans, animals and the environment that can be used to control or repel pests, and for safe and effective means to employ such chemicals.

The present disclosure provides many advantages, which shall become apparent as described below.

### SUMMARY OF THE DISCLOSURE

In accordance with this disclosure, controlling or repelling one or more pests is obtained by disrupting intraspecific communication or interspecific communication in the one or more pests, by exposing the one or more pests to a formulation comprising one or more compounds of structure (A) represented by the structure:

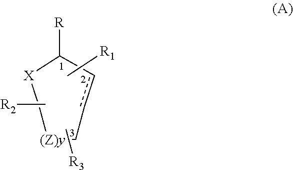

wherein
R is selected from the group consisting of —OH, ═O, —OC(O)R₄, —OR₆, —(OR₆)₂, wherein each R₆ is independently selected from an alkyl group containing from 1 to 4 carbon atoms and R₄ is a branched or straight chain, saturated or unsaturated hydrocarbyl group with zero to two double bonds and from 1 to 15 carbon atoms;
X is O or CH₂, with the proviso that when X is O, then R can only be ═O;
each Z is independently selected from the group consisting of (CH) and (CH₂);
y is a numeral selected from 1 and 2;
R₁ is selected from the group consisting of H or a branched or straight chain, saturated or unsaturated hydrocarbyl group with zero to two double bonds and from 1 to 15 carbon atoms;
R₂ is selected from the group consisting of H and a branched or straight chain, saturated or unsaturated hydrocarbyl group with zero to three double bonds and from 1 to 15 carbon atoms;
R₃ is selected from the group consisting of H and a branched or straight chain, saturated or unsaturated hydrocarbyl group with zero to three double bonds and from 1 to 15 carbon atoms, —(CH₂)ₙOH, —C(O)OR₅, —CH₂C(O)OR₇, —CH₂C(O)R₈, —C(O)NR₉R₁₀, —CH₂C(O)NR₁₁R₁₂ where each of R₅, R₇, R₈, R₉, R₁₀, R₁₁ and R₁₂ is independently selected from H and a branched or straight chain, saturated or unsaturated hydrocarbyl group with zero to three double bonds and from 1 to 15 carbon atoms and n is an integer of from 1 to 12;
the bond between the 2 and 3 positions in the ring structure may be a single or a double bond;
wherein the one or more compounds of structure (A) contain from 11 to 20 total carbon atoms; and
wherein the one or more compounds of structure (A) are present in an amount from about 0.001% by weight to about 99% by weight, based on the total weight of the formulation.

In accordance with this disclosure, the one or more pests are selected from agricultural pests, forestry pests, storage pests, and urban/public health pests.

In accordance with this disclosure, the intraspecific communications comprise pheromone-mediated communications, and the interspecific communications comprise allelochemical and visual mediated communications.

In accordance with this disclosure, the pheromone-mediated communication comprises communication associated with mating and aggregation behavior, the effect of sexual and aggregation pheromones, and attraction in general.

In accordance with this disclosure, the allelochemical-mediated communication comprises communication associated with oviposition behavior, the attraction effect of crops and other substrates, and attraction in general.

In accordance with this disclosure, the visual mediated communication comprises communication associated with attraction behavior due the effect of colors, shapes and textures of substrates.

Also, in a separate and distinct embodiment of this disclosure, controlling or repelling one or more pests is obtained by disrupting intraspecific communication or interspecific communication in the one or more pests, by exposing the one or more pests to a synergistic formulation comprising two or more compounds of structure (A). The synergistic formulation produces, when the pests are exposed to the synergistic formulation, a combined control or repellency effect greater than the sum of the separate control or repellency effects from the separate compounds of structure (A).

This disclosure also includes optical isomers, diastereomers and enantiomers of the named structures. Thus, at all stereocenters where stereochemistry is not explicitly defined, all possible epimers are envisioned. As an aspect of this disclosure, the control or repellency of the pests is by way of disrupting intraspecific communication or interspecific communication in the one or more pests, by exposing the one or more pests to a formulation of this disclosure.

Further objects, features and advantages of the present disclosure will be understood by reference to the following detailed description.

### BRIEF DESCRIPTION OF THE DRAWINGS

FIG. 1 shows results of electrophysiological responses (−mV±SE) of Spodoptera frugiperda (FAW—fall armyworm) male antennae to Control (hexanes) and 3-methyl-5-ethyl-2-cyclohexenone, in accordance with Example 1 herein. Asterisks indicate differences (P<0.01).

FIG. 2 shows results of electrophysiological responses (−mV±SE) of Spodoptera frugiperda (FAW—fall armyworm) female antennae to Control (hexanes) and 3-methyl-5-ethyl-2-cyclohexenone, in accordance with Example 1 herein. Asterisks indicate differences (P<0.001).

FIG. 3 graphically illustrates the percentage of S. frugiperda males that responded with predetermined behaviors to FAW pheromone blend (attractant) and FAW pheromone blend (attractant)+3-methyl-5-ethyl-2-cyclohexenone in a wind tunnel test, in accordance with Example 2 herein. Asterisks indicate significant differences between treatments (*p<0.05; **p<0.01; ***p<0.001).

FIG. 4 graphically illustrates the mean number of eggs laid by Spodoptera frugiperda pregnant females on control plants as compared to 3-methyl-5-ethyl-2-cyclohexenone treated plants in free-choice tests (a) and in no-choice tests (b), in accordance with Example 3 herein. Different letters indicate a significant difference between the treatments (p<0.001).

FIG. 5 shows results of Av. captures of adult Spodoptera frugiperda (FAW—fall armyworm) males after 24 h in Delta traps for T1: FAW pheromone as control (attractant) and T2: FAW pheromone (attractant) plus3-methyl-5-ethyl-2-cyclohexenone, 30% in mineral oil (repellent), in accordance with Example 4 herein. Trial performed in sorghum fields.

FIG. 6 graphically illustrates results of Av. captures of adult Spodoptera frugiperda (FAW—fall armyworm) males after 24 h in Delta traps for T1: FAW pheromone as control (attractant) and T2: FAW pheromone (attractant) plus 3-methyl-5-ethyl-2-cyclohexenone, 30% in mineral oil (repellent), in accordance with Example 4 herein. Trial performed in sorghum fields.

FIG. 7 shows results of Av. captures of adult Spodoptera exigua (BAW—beet armyworm) males after 24 h in Delta traps for T1: BAW pheromone as control (attractant) and T2: BAW pheromone (attractant) plus 3-methyl-5-ethyl-2-cyclohexenone 30% in mineral oil (repellent), in accordance with Example 4 herein. Trial performed in chili pepper fields.

FIG. 8 graphically illustrates results of Av. Captures of adult Spodoptera exigua (BAW—beet armyworm) males after 24 h in Delta traps for T1: BAW pheromone as control (attractant) and T2: BAW pheromone (attractant) plus3-methyl-5-ethyl-2-cyclohexenone, 30% in mineral oil (repellent), in accordance with Example 4 herein. Trial performed in chili pepper fields.

FIG. 9 shows results of Av. captures of adult Cydia pomonella (CM—codling moth) males after 24 h in Delta traps for T1: CM pheromone as control (attractant) and T2: CM pheromone (attractant) plus 3-methyl-5-ethyl-2-cyclohexenone, 30% in mineral oil (repellent), in accordance with Example 4 herein. Trial performed in pear orchards.

FIG. 10 graphically illustrates results of Av. Captures of adult Cydia pomonella (CW—codling moth) males after 24 h in Delta traps for T1: CM pheromone as control (attractant) and T2: CM pheromone (attractant) plus 3-methyl-5-ethyl-2-cyclohexenone, 30% in mineral oil (repellent), in accordance with Example 4 herein. Trial performed in chili pear orchards.

FIG. 11 shows results of Av. captures of adult Tuta absoluta (TLM—tomato leafminer) males after 24 h in Delta traps for T1: TLM pheromone as control (attractant) and T2: TLM pheromone (attractant) plus3-methyl-5-ethyl-2-cyclohexenone, 30% in mineral oil (repellent), in accordance with Example 4 herein. Trial performed in open tomato fields.

FIG. 12 graphically illustrates results of Av. captures of adult Tuta absoluta (TLM—tomato leafminer) males after 24 h in Delta traps for T1: TLM pheromone as control (attractant) and T2: TLM pheromone (attractant) plus3-methyl-5-ethyl-2-cyclohexenone, 30% in mineral oil (repellent), in accordance with Example 4 herein. Trial performed in open tomato fields.

FIG. 13 shows results of Av. captures of adult Dalbulus maidis (CLH—corn leafhopper) after 24 h in Yellow sticky traps for T1: Yellow color sticky trap as control (attractant) and T2: Yellow color sticky trap (attractant) plus 3-methyl-5-ethyl-2-cyclohexenone30% in mineral oil (repellent), in accordance with Example 4 herein. Trial performed in maize fields.

FIG. 14 graphically illustrates results of Av. captures of adult Dalbulus maidis (CLH—corn leafhopper) after 24 h in Yellow sticky traps for T1: Yellow color sticky trap as control (attractant) and T2: Yellow color sticky trap (attractant) plus 3-methyl-5-ethyl-2-cyclohexenone 30% in mineral oil (repellent), in accordance with Example 4 herein. Trial performed in maize fields.

FIG. 15 graphically shows results of Av. captures of adult Ceratitis capitata (Medfly—mediterranean fruit fly) after 24 h in Jackson traps for T1: Trimedlure plug as control (attractant) and T2: Trimedlure plug (attractant) plus 3-methyl-5-ethyl-2-cyclohexenone, 30% in mineral oil (repellent), in accordance with Example 4 herein. Trial performed in coffee fields.

FIG. 16 graphically illustrates shows results of Av. captures of adult Ceratitis capitata (Medfly—mediterranean fruit fly) after 24 h in Jackson traps for T1: Trimedlure plug as control (attractant) and T2: Trimedlure plug (attractant) plus 3-methyl-5-ethyl-2-cyclohexenone, 30% in mineral oil (repellent), in accordance with Example 4 herein. Trial performed in coffee fields.

FIG. 17 shows results of Av. captures of adult Anthonomus grandis (CBW—cotton boll weevil) after 360 h in Cotton boll weevil traps for T1: Grandlure pheromone as control (attractant) and T2: Grandlure pheromone (attractant) plus 3-methyl-5-ethyl-2-cyclohexenone 30% in mineral oil (repellent), in accordance with Example 4 herein. Trial performed in cotton fields.

FIG. 18 graphically illustrates shows results of Av. captures of adult Anthonomus grandis (CBW—cotton boll weevil) after 360 h in Cotton boll weevil traps for T1: Grandlure pheromone as control (attractant) and T2: Grandlure pheromone (attractant) plus 3-methyl-5-ethyl-2-cyclohexenone, 30% in mineral oil (repellent), in accordance with Example 4 herein. Trial performed in cotton fields.

FIG. 19 shows experimental arena set up: wading pool containing an impregnated cotton towel as treated surfaces and lunch bags containing a previous worn sock (exposed to skin odor volatiles) acting as attractant stimulus, in accordance with Example 5 herein.

FIG. 20 shows glass vials containing 25 males and 25 females, totalizing 50 bed bugs used per repetition, in accordance with Example 5 herein.

FIG. 21 shows a bar graph illustrating the mean percent repellency after 24 h against Cimex lectularius for towels treated with ethanol (EtOH), DEET 5% and BRI Blend 5% aged for 0, 14 and 21 days. Means followed by the same letter do not differ by the Tukey HSD test (p≤0.05). Error bars represent the standard error of the mean, in accordance with Example 5 herein.

FIG. 22 shows free-movement behavioral arena (control/untreated) fabric on top versus treated (EtOH or BRI Blend 5%) at the bottom, in accordance with Example 6 herein.

FIG. 23 shows scheme of free movement behavioral arenas coupled to high-resolution GigE camera and analyzed by Ethovison XT, to verify repellency effect of Cimex lectularius. (Adapted from: Gao, Y.; et. al., 2024), in accordance with Example 6 herein.

FIG. 24 shows bed bug movement heat-map created by Etho Vision XT, (blue color). Untreated vs Ethanol, heat map shows no preference for one of the halves, evidencing no repellency effect for Day 0 and Day 21. For Untreated vs BRI Blend 5% heat map clearly shows bed bug preference for one of the halves (untreated), evidencing significant repellency effect for Day 0 and Day 21, in accordance with Example 6 herein.

FIG. 25 shows a bar graph illustrating time spent in the treated zone for fabric treated with Ethanol (EtOH) and BRI Blend 5% at Day 0 and Day 21. Means followed by the same letter do not differ by the Tukey HSD test (p≤0.001), in accordance with Example 6 herein.

FIG. 26 shows scheme of test bedroom with release point of bed bugs and dispersal trap across doorway, in accordance with Example 7 herein.

FIG. 27 shows location of infrared-sensitive time-lapse camera, in accordance with Example 7 herein.

FIG. 28 shows a bar graph illustrating mean±SD % feeding success of bed bugs in rooms where bed was treated with Ethanol (EtOH), BRI Blend 5% at Day 0 and Day 30 and BRI Blend 2.5% at Day 30. Means followed by the same letter do not differ by the Tukey HSD test (p≤0.001), in accordance with Example 7 herein.

FIG. 29 shows bed bug activity in the treated zone for fabric treated with Ethanol (EtOH), BRI Blend 5% at Day 0, BRI Blend 5% Day 30 and BRI Blend 2.5% Day 30, in accordance with Example 7 herein.

FIG. 30 shows two egg cartons stacked together to form a single treated harborage box, in accordance with Example 8 herein.

FIG. 31 shows Two-choice arena containing 2 harborages, one treated with ethanol and one treated with one of three treatments (DEET 10%, BRI Blend 5% and Ethanol), in accordance with Example 8 herein.

FIG. 32 shows harborage box containing both water and food (regular dog food) acting as attractant stimulus (kairomones) for cockroaches, in accordance with Example 8 herein.

FIG. 33 shows a bar graph illustrating mean % of cockroaches presence for DEET 10% treatment (DEET 10% vs. ethanol), BRI Blend 5% treatment (BRI Blend 5% vs. ethanol) and EtOH treatment (ethanol vs. ethanol). Means followed by the same letter do not differ by the Tukey HSD test (p≤0.001), in accordance with Example 8 herein.

FIG. 34 shows female scorpions in a deli cup prior release into the test arenas, in accordance with Example 9 herein.

FIG. 35 shows test arenas containing BRI Blend 5% treated lids versus ethanol treated lids, in accordance with Example 9 herein.

FIG. 36 shows a bar graph illustrating mean % of scorpion presence for lids/harborages treated with BRI Blend 5% and lids/harborages treated with only ethanol (EtOH). Means followed by the same letter do not differ by the Tukey HSD test (p<0.001), in accordance with Example 9 herein.

### DESCRIPTION OF THE EMBODIMENTS

Controlling or repelling one or more pests selected from, for example, Blatoddean pests, Coleopteran pests, Dermapteran pests, Dipteran pests, Hemipteran pests, Hymenopteran pests, Lepidopteran pests, Orthopteran pests, Psocodean pests, Siphonapteran pests, Thysanopteran pests, Zygentoman pests, Araneae pests, Ixodidan pests, Mesostigmatan pests, Sarcoptiformes pests, Scorpiones pests, Trombidiformes pests, and Acari pests, is accomplished by disrupting intraspecific communication or interspecific communication in the one or more pests, by exposing the one or more pests to a formulation comprising one or more compounds of structure (A) represented by the structure:

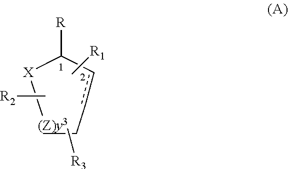

wherein
R is selected from the group consisting of —OH, ═O, —OC(O)R₄, —OR₆, —(OR₆) 2, wherein each R₆ is independently selected from an alkyl group containing from 1 to 4 carbon atoms and R₄ is a branched or straight chain, saturated or unsaturated hydrocarbyl group with zero to two double bonds and from 1 to 15 carbon atoms;
X is O or CH₂, with the proviso that when X is O, then R can only be ═O;
each Z is independently selected from the group consisting of (CH) and (CH₂);
y is a numeral selected from 1 and 2;
R₁ is selected from the group consisting of H or a branched or straight chain, saturated or unsaturated hydrocarbyl group with zero to two double bonds and from 1 to 15 carbon atoms;
R₂ is selected from the group consisting of H and a branched or straight chain, saturated or unsaturated hydrocarbyl group with zero to three double bonds and from 1 to 15 carbon atoms;
R₃ is selected from the group consisting of H and a branched or straight chain, saturated or unsaturated hydrocarbyl group with zero to three double bonds and from 1 to 15 carbon atoms, —(CH₂)ₙOH, —C(O)OR₅, —CH₂C(O)OR₇, —CH₂C(O)R₈, —C(O)NR₉R₁₀, —CH₂C(O)NR₁₁R₁₂ where each of R₅, R₇, R₈, R₉, R₁₀, R₁₁ and R₁₂ is independently selected from H and a branched or straight chain, saturated or unsaturated hydrocarbyl group with zero to three double bonds and from 1 to 15 carbon atoms and n is an integer of from 1 to 12;
the bond between the 2 and 3 positions in the ring structure may be a single or a double bond;
wherein the compounds of structure (A) contain from 11 to 20 total carbon atoms; and
wherein the one or more compounds of structure (A) are present in an amount from about 0.001% by weight to about 99% by weight, based on the total weight of the formulation.

Also, in a separate and distinct embodiment of this disclosure, controlling or repelling one or more pests is obtained by disrupting intraspecific communication or interspecific communication in the one or more pests, by exposing the one or more pests to a synergistic formulation comprising two or more compounds of structure (A). The synergistic formulation produces, when the pests are exposed to the synergistic formulation, a combined control or repellency effect greater than the sum of the separate control or repellency effects from the separate compounds of structure (A), at comparable concentrations.

In an embodiment, the formulations, including synergistic formulations, are used to repel or control pests, including agricultural, forestry, storage, urban/public health pests, and the like. The one or more agricultural, forestry, storage, and urban/public health pests are selected from, for example, Blatoddean pests, Coleopteran pests, Dermapteran pests, Dipteran pests, Hemipteran pests, Hymenopteran pests, Lepidopteran pests, Orthopteran pests, Psocodean pests, Siphonapteran pests, Thysanopteran pests, Zygentoman pests, Araneae pests, Ixodidan pests, Mesostigmatan pests, Sarcoptiformes pests, Scorpiones pests, Trombidiformes pests, and Acari pests.

In another embodiment, the one or more pests are selected from beetles, flies, ants, moths, butterflies, grasshoppers, thrips, mites, true bugs, bed bugs, aphids, weevils, ants, leafhoppers, crickets, mealybugs, scales, psyllids, wasps, ticks, spiders, scorpions, locusts, termites, bees, stinkbugs, caterpillars, larva, whiteflies, crickets, cockroaches, fleas, earwigs, grubs, fruit flies, midges, scarabs, mosquitoes, hornets, silverfishes, firebrats, bristletails, lice, and the like.

In a further embodiment, the pests are selected from pests of fruits and tree nuts, pests of vegetables, pests of field crops, pests of row crops, soil pests, seed pests, pests of ornamentals, pests of herbs and spices, pests of trees, palm tree pests, pests of turf, pests of pasture, forestry pests, pest of greenhouses, storage pests, grain pests, structural pests, urban pests, disease vector pests, public health pests and veterinary pests, and the like.

A preferred group of compounds of structure (A) are those wherein R is —OH, ═O, O(O)CR; R₁ is H or CH₃; R₂ is H or CH₃; R₃ is H or a branched or straight chain, saturated or unsaturated hydrocarbyl group with zero to three double bonds, and from 1 to 11 carbon atoms; and wherein the compounds of structure (A) contain from 6 to 20 total carbon atoms.

A preferred group of compounds of structure (A) are those wherein R is ═O or —OH, X is CH₂, Z is (CH) or (CH₂), y is 1, the bond between positions 2 and 3 is a single bond, R₁ is H, R₂ is H, and R₃ is an alkenyl group having at least 11 carbon atoms and 1 or 2 double bonds.

A further preferred group of compounds of structure (A) are those wherein R is ═O or —OH, X is CH₂, Z is (CH) or (CH₂), y is 1, the bond between positions 2 and 3 is a single bond, R₁ is an alkyl group having at least 5 carbon atoms, R₂ is H, and R₃ is —C(O)OR₅, and R₃ is an alkyl or alkenyl group containing at least 3 carbon atoms.

Another preferred group of compounds of structure (A) are those wherein R is ═O, X is O, Z is CH or CH₂, y is 1 or 2, the bond between positions 2 and 3 is a single bond, R₁ is an alkyl group of from 7 to 11 carbon atoms, R₂ is H, and R₃ is H or CH₃.

A preferred compound of structure (A) is represented by the formula:

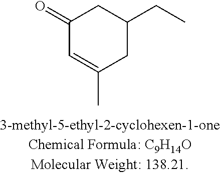

An especially preferred group of compounds of structure (A) include methyl jasmonate, methyl dihydrojasmonate, methyl dihydrojasmolate (methyl 2-(3-hydroxy-2-pentylcyclopentyl)acetate), ethyl dihydrojasmonate, propyl dihydrojasmonate, geranyl cyclopentanone (apritone, cyclopentanone, 2-(3,7-dimethyl-2,6-octadienyl)-), methyl apritone (cyclopentanone, 2-(3,7-dimethyl-2,6-nonadien-1-yl)-), delta-dodecalactone, gamma-dodecalactone, gamma-undecalactone, gamma methyl dodecalactone, gamma-tridecalactone, gamma methyl tridecalactone, gamma-tetradecalactone, 3-methyl-5-ethyl-2-cyclohexen-1-one, 3-methyl-5-propyl-2-cyclohexenone, 3-methyl-5-butyl-2-cyclohexenone, 3-methyl-5-pentyl-2-cyclohexenone, 3-methyl-5-hexyl-2-cyclohexenone, and 3-methyl-5-heptyl-2-cyclohexenone.

Representative examples of compounds of structure (A) include, but are not limited to,

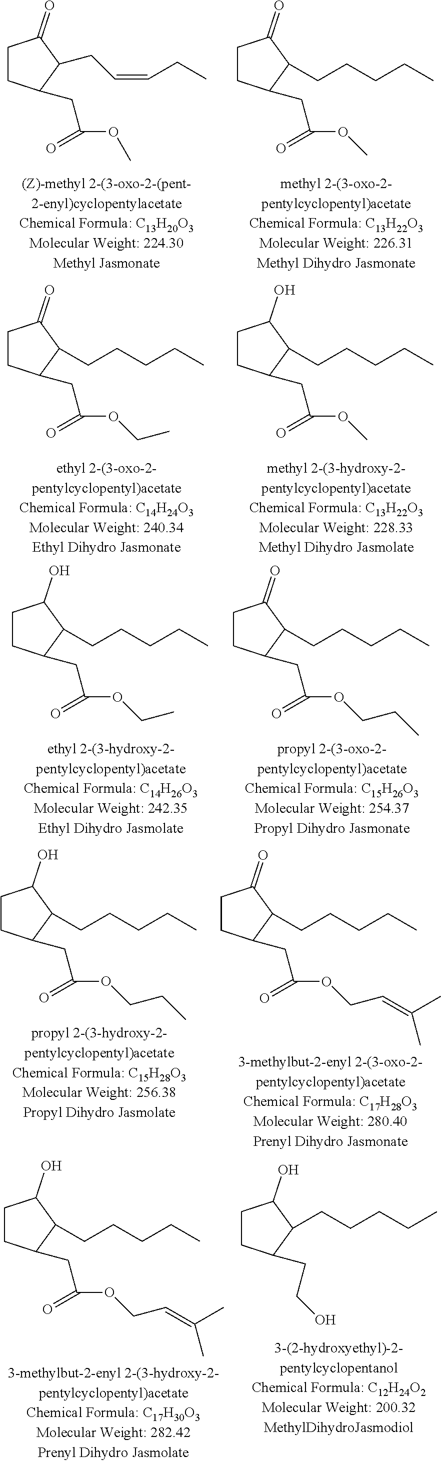

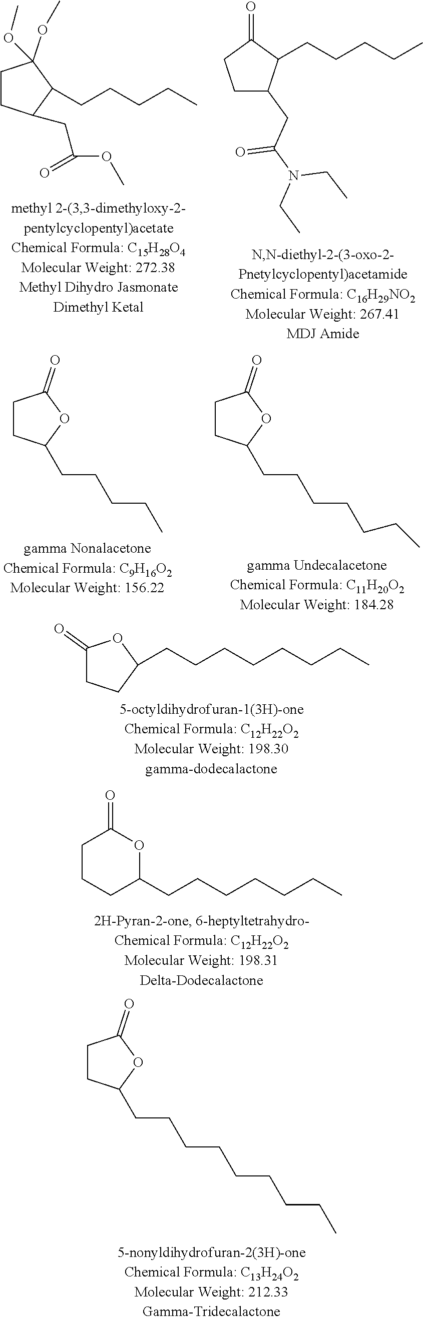

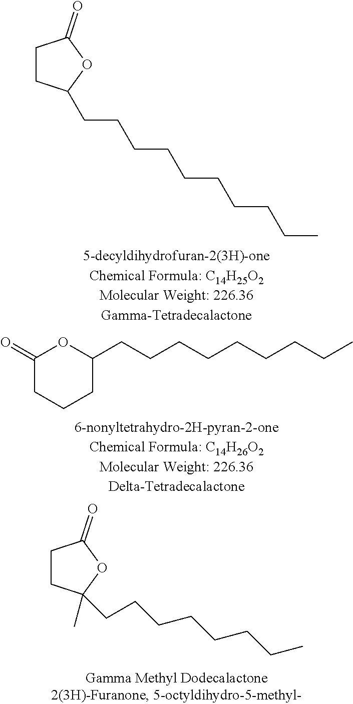 [SMILES: CCCCCCCCCCC1CCC(=O)O1 ; CCCCCCCCCC1CCCC(=O)O1 ; CCCCCCCCC1(C)CCC(=O)O1]

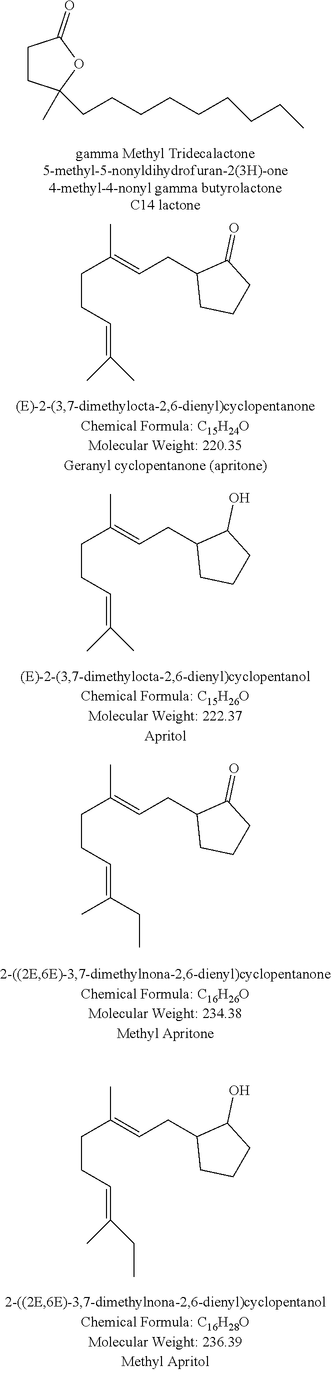 [SMILES: CCCCCCCCCC1(C)CCC(=O)O1 ; CC(C)=CCC/C(C)=C/CC1CCCC1=O ; CC(C)=CCC/C(C)=C/CC1CCCC1O ; CC/C(C)=C/CC/C(C)=C/CC1CCCC1=O ; CC/C(C)=C/CC/C(C)=C/CC1CCCC1O]

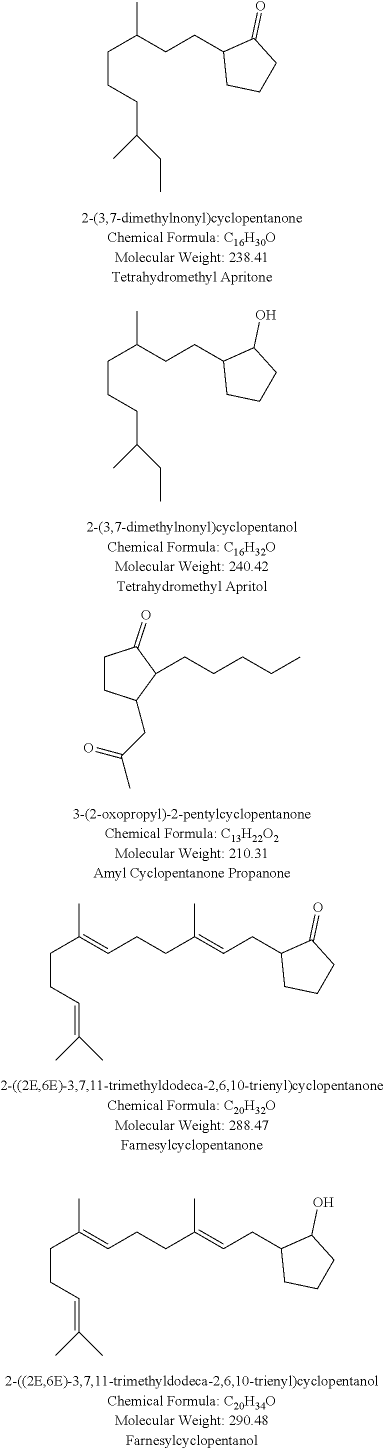 [SMILES: CCC(C)CCCC(C)CCC1CCCC1=O ; CCC(C)CCCC(C)CCC1CCCC1O ; CCCCCC1C(=O)CCC1CC(C)=O ; CC(C)=CCC/C(C)=C/CC/C(C)=C/CC1CCCC1=O ; CC(C)=CCC/C(C)=C/CC/C(C)=C/CC1CCCC1O]

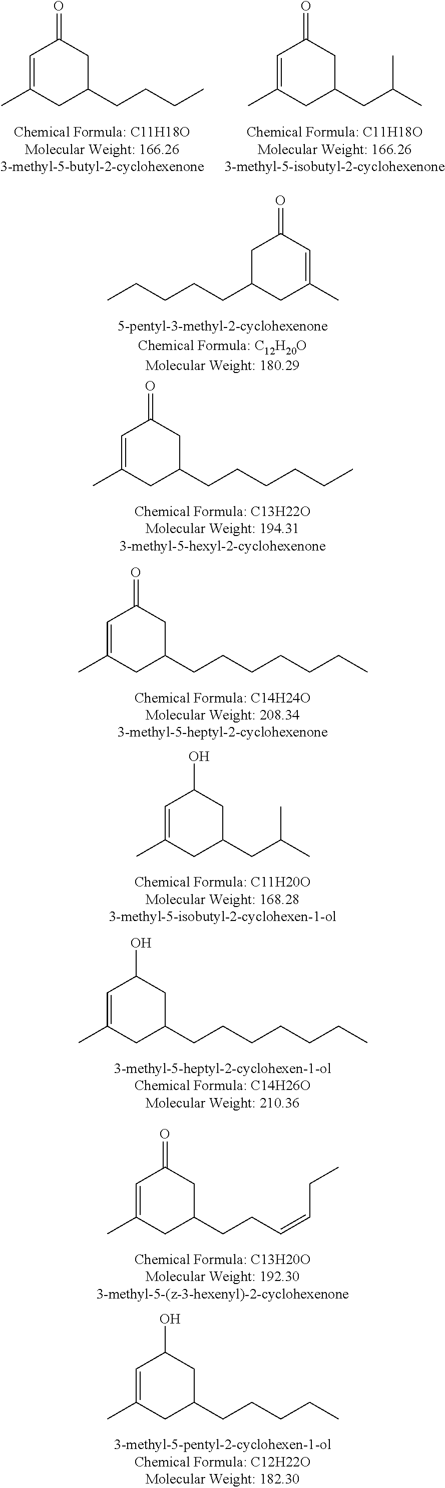

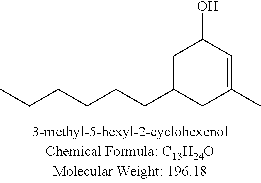

In an embodiment, the one or more compounds of structure (A) can be present in the formulations of this disclosure in an amount from about 0.001% by weight to about 90% by weight, or from about 0.001% by weight to about 75% by weight, or from about 0.001% by weight to about 50% by weight, or from about 0.001% by weight to about 25% by weight, or from about 0.001% by weight to about 10% by weight, or from about 0.001% by weight to about 5% by weight, based on the total weight of the formulation.

In another embodiment, the one or more compounds of structure (A) can be present in the formulations of this disclosure in an amount from about 0.001% by weight to about 95% by weight, or from about 0.1% by weight to about 95% by weight, or from about 10% by weight to about 95% by weight, or from about 25% by weight to about 95% by weight, or from about 50% by weight to about 95% by weight, or from about 75% by weight to about 95% by weight, based on the total weight of the formulation.

The active one or more compounds of structure (A) may be formulated into any suitable formulations such as for example, including but not limited to, granules, dusts, soluble powders, wettable powders, pastes, emulsifiable concentrates, aerosols, ultra low-volume concentrates, flowable suspensions, oils, sprays, lures, biodegradable flakes, or the like.

The amount of the formulation comprising the one or more compounds of structure (A) will depend upon the type of agricultural, forestry, storage, urban, public health formulation, or the like, used and the particular pest against which the formulation is employed.

In an embodiment, the formulation is used in a controlling or repelling amount, needed to achieve an observable effect on a pest, for example, the effect of diminishing the occurrence and/or activity of a pest in a locus. This effect may come about when pest populations are repelled from a locus, pests are incapacitated in, or around, a locus, by disruption of intraspecific communication or interspecific communication in the pest. The intraspecific communication includes pheromone-mediated communication, and the interspecific communication includes allelochemical-mediated communication and visual mediated communications. The pheromone-mediated communication includes communication associated with mating and aggregation behavior, the effect of sexual and aggregation pheromones, and attraction in general. The allelochemical-mediated communication comprises communication associated with oviposition behavior, the attraction effect of crops and other substrates, and attraction in general. The visual mediated communication comprises communication associated with attraction behavior due the effect of colors, shapes, and textures of substrates. Also, a combination of these effects can occur. Generally, pest populations, activity, or both are desirably reduced more than fifty percent, preferably more than 90 percent, and most preferably more than 99 percent.

In general, an effective amount of active ingredient (i.e., the one or more compounds of structure (A)) for controlling or repelling pests is about 100 kilograms per hectare or less, or about 500 grams per hectare or less, or about 100 grams per hectare or less, or about 1 gram per hectare or less, or about 0.1 grams per hectare or less, or about 50 kilograms per hectare or less, or about 250 grams per hectare or less, or about 50 grams per hectare or less, or about 0.5 grams per hectare or less, about 0.05 grams per hectare or less, or about 2.525 kilograms per hectare or less, or about 125 grams per hectare or less, about 75 grams per hectare or less, about 25 grams per hectare or less, or about 5 grams per hectare or less, or about 2.5 grams per hectare or less, about 0.25 grams per hectare or less. A effective amount for controlling or repelling is dependent on the particular pest, and also the particular target of application including, for example, fruits and tree nuts, vegetables, field crops, row crops, soil, seeds, ornamentals, herbs and spices, trees, palm trees, turf, pasture, forestry, greenhouses, storage, grains, structural, urban, disease vectors, public health, veterinary, and the like.

Illustrative pests that can be controlled or repelled in accordance with the methods of this disclosure include, for example, pests from the Phylum Arthropoda; pests from the Subphylum Hexapoda; pests from the Class Insecta; and pests are selected from beetles, flies, ants, moths, butterflies, grasshoppers, thrips, mites, true bugs, bed bugs, aphids, weevils, ants, leafhoppers, crickets, mealybugs, scales, psyllids, wasps, ticks, spiders, scorpions, locusts, termites, bees, stinkbugs, caterpillars, larva, whiteflies, crickets, cockroaches, fleas, earwigs, grubs, fruit flies, midges, scarabs, mosquitoes, hornets, silverfishes, firebrats, bristletails, and lice.

Illustrative pests of the Order Blatoddea that can be controlled or repelled in accordance with the methods of this disclosure include, for example, pests from the Family Archotermopsidae including, but not limited to, Zootermopsis spp.; pests from the Family Blattidae including, but not limited to, Blatta spp., Blatta orientalis (oriental cockroach), Periplaneta spp., Periplaneta americana (American cockroach), Periplaneta australasiae (Australian cockroach), Periplaneta brunnea (brown cockroach) and Periplaneta fuliginosa (smokybrown cockroach); pests from the Family Blattelidae including, but not limited to, Blatella spp, Blattella germanica (German cockroach), Supella spp, and Supella longipalpa (brownbanded cockroach); pests from the Family Kalotermitidae including, but not limited to, Cryptotermes spp., Cryptotermes brevis (West Indian drywood termite), Kalotermes spp., Incistitermes spp. (drywood termites), Marginitermes spp. (drywood termites) and Neotermes spp; pests from the Family Rhinotermitidae including, but not limited to, Coptotermes spp., Coptotermes curvignathus, Coptotermes gestroi (Asian subterranean termite), Coptotermes frenchii, Coptotermes formosanus (formosan subterranean termite), Heterotermes spp., Heterotermes aureus, Heterotermes tenuis (subterranean termite), Reticulitermes spp. (subterranean termites), Reticulitermes banyulensis, Reticulitermes grassei, Reticulitermes flavipes (eastern subterranean termite), Reticulitermes hesperus (western subterranean termite), Reticulitermes santonensis, Reticulitermes speratus, Reticulitermes tibialis, Reticulitermes virginicus and Schedorhinotermes spp; pests from the Family Termitidae including, but not limited to, Cornitermes spp., Cornitermes cumulans, Macrotermes spp., Microcerotermes spp. (harvester termites), Microtermes obesi, Nasutitermes spp., Nasutitermes corniger (conehead termite), Neocapritermes spp., Procornitermes spp., Syntermes spp, and Velocitermes spp.

Illustrative pests of the Order Coleoptera that can be controlled or repelled in accordance with the methods of this disclosure include, for example, pests from the Family Anobiidae including, but not limited to, Lasioderma spp., Lasioderma serricorne; pests from the Family Bostrichidae including, but not limited to, Prostephanus truncatus (larger grain borer) and Rhizopertha dominica (lesser grain borer); pests from the Family Brentidae including, but not limited to, Apion spp., Cylas spp, and Cylas formicarius (sweet potato weevil); pests from the Family Buprestidae including, but not limited to, Agrilus spp. (jewel beetles) and Agrilus planipennis (emerald ash borer); pests from the Family Cerambycidae including, but not limited to, Anisopodus spp., Anisopodus lignicola, Anoplophora glabripennis (Asian longhorned beetle), Hedypathes betulinus, Migdolus fryanus (sugarcane rhizome borer), Oncideres spp., Oncideres impluviata, Trachyderes spp., Trachyderes succinctus, Trachyderes thoracicus; pests from the Family Cleridae including, but not limited to, Necrobia rufipes (red-legged ham beetle) and Necrobia ruficollis (red-shouldered ham beetle); pests from the Family Cryptophagidae including, but not limited to, Atomaria linearis (pygmy mangold beetle); pests from the Family Chrysomelidae including, but not limited to, Aulacophore spp., Cerotoma spp., Cerotoma trifurcate (bean leaf beetle), Chaetocnema spp., Colapsis spp., Costalimaita spp., Costalimaita ferruginea, Delocrania cossyphoides, Diabrotica spp. (cucumber beetles or corn rootworms), Diabrotica barberi (Northern corn rootworm), Diabrotica speciosa (cucurbit beetle), Diabrotica virgifera (Western corn rootworm), Epilachna varivestis (Mexican bean beetle), Leptinotarsa decemlineata (Colorado potato beetle), Oulema melanopus (cereal leaf beetle), Oulema oryzae, Paraselenis flava, Phyllotreta spp, and Zabrotes spp; pests from the Family Curculionidae including, but not limited to, Anthonomus spp. (weevils), Anthonomus eugenii (pepper weevil), Anthonomus grandis (cotton boll weevil), Anthonomus musculus (cranberry weevil), Anthonomus pomorum (apple blossom weevil), Anthonomus rubi (strawberry blossom weevil), Aracanthus spp., Aracanthus mourei, Aulacophore spp., Bothynoderes punctiventris (beet root weevil), Bruchus spp., Bruchus pisorum (pea weevil) Callosobruchus maculatus (southern cowpea weevil), Ceutorhynchus spp., Ceutorhynchus assimilis (cabbage seedpod weevil), Ceutorhynchus napi (cabbage curculio), Conotrachelus spp., Conotrachelus nenuphar (plum curculio), Conotrachelus psidii (guava weevil), Cosmopolites sordidus, (banana weevil), Cratosomus spp., Cratosomus bombina, Cratosomus flavofasciatus, Cylindrocpturus adspersus (sunflower stem weevil), Deporaus marginatus (mango leaf-cutting weevil), Euscepes postfasciatus, Gonipterus gibberus, Heilipus spp., Heilipus catagraphus, Homalinotus spp., Homalinotus coriaceus (black coconut bunch weevil), Hypera spp., Hypera postica (alfalfa weevil), Hyperodes spp. (Hyperodes weevil), Lissorhoptrus oryzophilus (rice water weevil), Listronotus bonariensis, Metamasius hemipterus (West Indian sugarcane weevil), Naupactus spp., Naupactus optatus, Otiorhynchus spp., Pantomorus spp., Pantomorus cervinus (Fuller's rose weevil), Parisoschoenus obesulus, Rhinostomus spp., Rhinostomus barbirostris, Rhynchophorus spp., Rhynchophorus bilineatus (black palm weevil), Rhynchophorus cruentatus (palmetto weevil), Rhynchophorus ferrugineus (red palm weevil), Rhynchophorus palmarum (South American palm weevil), Rhynchophorus phoenicis (African palm weevil), Rhynchophorus vulneatus (coconut weevil), Sitona lineatus (pea leaf weevil), Sitophilus spp. (grain weevils), Sitophilus granarius (granary weevil), Sitophilus oryzae (rice weevil), Sitophilus zeamais (maize weevil), Sphenophorus levis (sugarcane weevil) and Sternochetus mangiferae (mango seed weevil); pests from the Family Dermestidae including, but not limited to, Dermestes lardarius (larder beetle) Dermestes maculates (hide beetle), Trogoderma granarium (khapra beetle) and Trogoderma variabile (warehouse beetle); pests from the Family Elateridae including, but not limited to Agriotes spp. (wireworms), Agriotes brevis. (click beetle), Agriotes lineatus. (lined click beetle), Agriotes obscurus. (dusky wireworm), Agriotes sordidus, Agriotes sputator. (common click beetle), Aeolus melliculus, Anchastus spp., Anchastus quadrimaculatus, Ctenicera spp, and Melanotus communis; pests from the Family Lyctidae including, but not limited to, Lyctus spp; pests from the Family Meloidae including, but not limited to, Epicauta spp, and Epicauta atomaria; pests from the Family Melolonthidae including, but not limited to, Aegopsis spp., Aegopsis bolboceridus, Liogenys spp, and Liogenys suturalis; pests from the Family Nitidulidae including, but not limited to, Carpophilus spp. (sap beetles), Carpophilus davidsoni (Australian sap beetle), Carpophilus dimidiatus (corn sap beetle), Carpophilus hemipterus (dried fruit beetle), Carpophilus truncatus (Carpophilus beetle), Lobiopa spp. and Lobiopa insularis; pests from the Family Scarabaeidae including, but not limited to, Apogonia spp. (grubs), Ataenius spretulus (Black Turgrass Ataenius), Cotinus nitidis (Green June beetle), Cyclocephala spp. (grubs), Diloboderus spp., Diloboderus abderus, Melolontha (common European cockchafer), Oryctes spp, Oryctes rhinoceros (coconut rhinoceros beetle), Paracotalpa granicollis, Phyllophaga spp. (May/June beetle) and Phyllophaga cuyabana, pests from the Family Scolytidae including, but not limited to, Dendroctonus spp., Dendroctonus adjunctus (roundheaded pine beetle), Dendroctonus barberi (Southwestern pine beetle) Dendroctonus brevicomis (Western pine beetle), Dendroctonus frontalis, (Southern pine beetle), Dendroctonus ponderosae, (mountain pine beetle), Dendroctonus pseudotsugae (Douglas fir beetle), Dendroctonus rhizophagus, Dendroctonus rufipennis (spruce beetle), Dendroctonus simplex (Eastern larch beetle), Dendroctonus valens (red turpentine beetle), Dryocoetes confusus (Western balsam bark beetle), Hypothenemus hampei (coffee berry borer), Ips spp., Ips calligraphus (six-spined engraver beetle), Ips grandicollis (Eastern five-spined engraver beetle), Ips paraconfusus (California five-spined bark beetle), Ips perturbatus (Northern spruce engraver beetle), Ips pini (North American pine engraver beetle), Ips sexdentatus (six-toothed bark beetle), Ips typographus (European spruce bark beetle), Megaplatypus spp., Megaplatypus mutatus, Scolytus spp. (wood beetles), Scolytus schevyrewi (banded elm bark beetle), Tomicus spp., Tomicus piniperda, (large pine shoot beetle), Xylosandrus spp., and Xylosandrus germanus (black stemborer); pests from the Family Silvanidae including, but not limited to, Cryptolestes ferrugineus (rusty grain beetle), Cryptolestes pusillus (flat grain beetle) and Cryptolestes turcicus (Turkish grain beetle); pests from the Family Tenebrionidae including, but not limited to, Alphitobius spp., Alphitobius diaperinus (lesser mealworm beetle), Lagria villosa, Tribolium spp. (flour beetles), Tribolium audax (American black four beetle) Tribolium castaneum (red flour beetle) and Tribolium confusum (confused flour beetle); pests from the Family Trogossitidae including, but not limited to, Oryzaephilus mercator (merchant grain beetle) and Oryzaephilus surinamensis (sawtoothed grain beetle).

Illustrative pests of the Order Dermaptera that can be controlled or repelled in accordance with the methods of this disclosure include, for example, pests from the Family Forficulidae including, but not limited to, Doru spp., Forficula spp, and Forficula auricularia (European earwig).

Illustrative pests of the Order Diptera that can be controlled or repelled in accordance with the methods of this disclosure include, for example, pests from the Family Agromyzidae including, but not limited to, Agromyza spp., Agromyza frontella (Alfalfa blotch leafminer), Liriomyza spp., Liriomyza brassica (serpentine leafminer), Gracillia perseae (persea leaf miner); pests from the Family Anthomyiidae including, but not limited to, Delia spp. (root and seed maggots), Delia platura (seedcorn maggot) and Pegomyia betae (beet leafminer); pests from the Family Cecidomyiidae including, but not limited to, Contarinia spp., Dasineura spp., Dasineura brassicae (cabbage gall midge), Dasineura mali (apple leaf gall midge), Sitodiplosis mosellana (orange wheat blossom midge) and Stenodiplosis spp; pests from the Family Chironomidae including, but not limited to, Oscinella frit (frit fly); pests from the Family Culicidae including, but not limited to, Aedes spp., Aedes aegypti (yellow fever mosquito), Aedes albopictus (Asian tiger mosquito), Anopheles spp., Anopheles darlingi (American malaria mosquito), Anopheles gambiae (African malaria mosquito), Culex spp., Culex quinquefasciatus (Southern house mosquito) and Culex pipiens (Common house mosquito); pests from the Family Drosophilidae including, but not limited to, Drosophila spp., Drosophila melanogaster (vinegar fruit fly) and Drosophila suzukii (spotted wing drosophila); pests from the Family Muscidae including, but not limited to, Musca spp., Musca autumnalis (face fly), Musca domestica (house fly), Fannia spp., Fannia canicularis (little house fly), Fannia scalaris (latrine fly), Stomoxys calcitrans (stable fly); pests from the Family Sarcophagidae including, but not limited to, Cochliomyia spp; pests from the Family Sciaridae including, but not limited to, Cochliomyia spp; pests from the Family Tabanidae including, but not limited to, Chrysops spp., Tabanus spp., and Haematobia irritans (horn fly); pests from the Family Tachinidae including, but not limited to, Gasterophilus intestinalis (horse bot fly), Oestrus ovis (sheep bot fly), Hypoderma lineatum (common cattle grub); pests from the Family Tephritidae including, but not limited to, Anastrepha spp., Anastrepha fraterculus (South American fruit fly), Anastrepha ludens (Mexican fruit fly), Anastrepha obliqua (West Indian fruit fly), Anastrepha suspensa (Caribbean fruit fly), Bactrocera spp., Bactrocera carambolae (carambola fruit fly), Bactrocera dorsalis (oriental fruit fly), Bactrocera latifrons (Malaysian fruit fly), Bactrocera oleae (olive fruit fly), Bactrocera tryoni (Queensland fruit fly), Bactrocera zonata (peach fruit fly), Ceratitis spp., Ceratitis capitata (Mediterranean fruit fly), Ceratitis rosa (natal fruit fly), Dacus spp., Rhagoletis spp., Rhagoletis cerasi (cherry fruit fly), Rhagoletis pomonella (apple maggot), Zeugodacus spp. and Zeugodacus cucurbitae (melon fly).

Illustrative pests of the Order Hemiptera that can be controlled or repelled in accordance with the methods of this disclosure include, for example, pests from the Family Aleyrodidae including, but not limited to, Aleurodes spp., Aleurodes proletella (cabbage whitefly), Aleurodicus disperses, Aleurothrixus floccosus (woolly whitefly), Bemisia spp., Bemisia argentifolii (silverleaf whitefly), Bemisia tabaci (sweet potato whitefly), Trialeurodes spp., Trialeurodes vaporariorum (greenhouse whitefly) and Trialeurodes abutiloneus (bandedwing whitefly); pests from the Family Alydidae including, but not limited to, Neomegalotomus spp., and Neomegalotomus parvus. pests from the Family Aphididae including, but not limited to, Acrythosiphon pisum (pea aphid), Aphis spp., Aphis gossypii (cotton aphid), Aphis pomi (apple aphid), Aulacorthum solani (foxglove aphid), Brachycolus noxius (Russian aphid), Brachycorynella asparagi (asparagus aphid), Brevicoryne brassicae (cabbage aphid), Cerataphis spp., Cerataphis latanie (palm aphid), Chaetosiphon spp., Chaetosiphon fragaefollii (strawberry aphid), Dysaphis plantaginea (rosy apple aphid), Empoasca spp., Eriosoma spp., Eriosoma lanigerum (woolly apple aphid), Lipaphis spp., Lipaphis erysimi (mustard aphid), Macrosiphum spp., Macrosiphum euphorbiae (potato aphid), Macrosiphum granarium (English grain aphid), Macrosiphum rosae (rose aphid), Melanaphis sacchari (sugarcane aphid), Metopolophium dirhodum (rose grain aphid), Myzus persicae (green peach aphid), Rhapalosiphum spp., Rhapalosiphum maida (corn leaf aphid), Rhapalosiphum padi (oat bird-cherry aphid), Rhopasosiphum rufiabdominale (rice root aphid), Schizaphis graminum (greenbug), Sipha spp., Sipha flava (yellow sugarcane aphid), Sipha maydis, Sitobion avenae (English grain aphid), Therioaphis spp, and Toxoptera spp; pests from the Family Cercopidae including, but not limited to, Mahanarva spp., Mahanarva fimbriolata (spittlebug); pests from the Family Cicadellidae including, but not limited to, Acrogonia citrina, Acrogonia virescens, Aphrophora spp., Bucephalogonia xanthophis, Dalbulus spp., Dalbulus maidis (corn leafhopper), Dilobopterus spp., Dilobopterus costalimai, Empoasca spp., Ferrariana trivittata, Fingeriana dubia, Homalodisca ignorata, Idioscopus nitidulus (mango leafhopper), Macugonalia leucomelas, Macrosteles quadrilineatus (aster leafhopper), Nephotettix spp., Nephotettix cinctipes (green leafhopper), Oncometopia facialis, Parathona gratiosa, Philaenus spp., Plesiommata corniculate, Sogatella furcifera (white-backed planthopper) and Sonesimia grossa; pests from the Family Cimicidae including, but not limited to, Cimex spp. Cimex hemipterus (tropical bed bug) and Cimex lectularius (bed bug); pests from the Family Coccidae including, but not limited to Coccus spp; pests from the Family Coreidae including, but not limited to, Anisoscelis spp., Anisoscelis marginellus, Diactor spp., Diactor bilineatus, Leptocorisa spp., Holymenia spp., Holymenia clavigera, Leptocorisa oratorius (rice ear bug), Leptoglossus spp., Leptoglossus gonagra, Leptoglossus zonatus (leaf-footed bug), Phthia spp., Phthia picta, Sphictyrtus spp, and Sphictyrtus chrysis; pests from the Family Diaspididae including, but not limited to, Aonidiella spp., Aonidiella aurantii (California red scale), Aonidiella citrina (yellow scale), Aspidiotus spp., Aspidiotus destructor, Aspidiotus nerii (oleander scale), Ceroplastes spp., Ceroplastes rubens (red wax scale), Chionaspis spp., Chrysomphalus spp., Chrysomphalus aonidum (Florida red scale), Icerya purchasi (cottony cushion scale), Lepidosaphes spp., Parlatoria spp., Parlatoria oleae (olive scale), Parlatoria pergandii (chaff scale), Parlatoria ziziphi (ebony scale), Quadraspidiotus perniciosus (San Jose scale), Saissetia spp., Saissetia oleae (black scale), Toumeyella spp., Unaspis spp., Unaspis mabilis, Unaspis yanonensis (arrowhead scale); pests from the Family Margarodidae including, but not limited to, Eurhizococcus spp, and Eurhizococcus brasiliensis (ground pearl); pests from the Family Membracidae including, but not limited to, Membracis foliate; pests from the Family Miridae including, but not limited to, Collaria scenica, Monalonium annulipes, Lygus spp., Lygus hesperus (western tarnished plant bug), Lygus lineolaris (tarnished plant bug), Phytocoris spp., Phytocoris californicus, Phytocoris relativus; pests from the Family Ortheziidae including, but not limited to, Orthezia spp, and Orthezia praelonga; pests from the Family Pentatomidae including, but not limited to, Chinavia spp., Chinavia hilaris (green stinkbug), Dichelops melacanthus, (green belly stink bug), Edessa meditabunda (green and brown stinkbug), Euschistus spp., Euschistus conspersus (consperse stinkbug), Euschistus heros (neotropical brown stinkbug), Euschistus obscurus (pale-lined stink bug), Euschistus servus (brown stink bug), Euschistus tristigmus (dusky stinkbug), Halyomorpha halys, (brown marmorated stink bug), Lagynotomus spp, Nezara viridula (southern green stink bug), Oebalus spp., Oebalus poecilus, (small rice stinkbug), Piezodorus guildinii (redbanded stink bug), Thyanta perditor, Tibraca spp, and Tibraca limbativentris (rice stalk stink bug); pests from the Family Phylloxeridae including, but not limited to, Daktulosphaira vitifoliae (grape phylloxera); pests from the Family Pseudococcidae including, but not limited to, Planococcus spp., Planococcus citri (citrus mealybug), Planococcus ficus (vine mealybug), Pseudococcus spp., Pseudococcus calceolariae (scarlet mealybug), Pseudococcus longispinus (long-tailed mealybug), Pseudococcus maritimus (grape mealybug) and Pseudococcus viburni (tuber mealybug); pests from the Family Psyllidae including, but not limited to, Bactericera spp., Bactericera cockerelli (potato psyllid), Cacopsylla spp., Cacopsylla pyricola (pear sucker), Ctenarytaina spatulate (rose gum psyllid), Diaphorina spp., Diaphorina citri (Asian citrus psyllid), Glycaspis brimblecombei (Red Gum Lerp Psyllid); pests from the Family Reduviidae including, but not limited to, Panstrongylus spp., Panstrongylus megistus, Rhodnius spp., Rhodnius prolixus, Triatoma spp., Triatoma brasiliensis, Triatoma infestans (kissing bug) and Triatoma lecticularia; pests from the Family Rhyparochromidae including, but not limited to Neopamera bilobate; pests from the Family Thaumastocoridae including, but not limited to, Thaumastocoris spp, and Thaumastocoris pereginus.

Illustrative pests of the Order Hymenoptera that can be controlled or repelled in accordance with the methods of this disclosure include, for example, pests from the Family Apidae including, but not limited to, Apis spp., Apis cerana (Asiatic honeybee), Apis mellifera (honeybee), Trigona sponipes and Xylocopa spp.; pests from the Family Eulophidae including, but not limited to, Epichrysocharis burwelli and Leptocybe invasa; pests from the Family Formicidae including, but not limited to, Acromyrmex spp., Atta spp., Atta bisphaerica, Atta capiguara, Atta cephalotes, Atta laevigata (Caribbean pine leaf cutting ant), Atta mexicana, Atta sexdens, Atta sexdens rubropilosa, Atta sexdens sexdens, Atta texana (Texas leafcutting ant), Camponotus spp., Camponotus atriceps, Camponotus crassus, Camponotus rufipes, Camponotus sericeiventris (shimmering golden sugar ant), Formica spp., Linepithema humile (Argentine ant), Monomorium spp., Monomorium floricola (bicolored trailing ant), Monomorium minimum (little black ant), Monomorium pharaonis (pharaoh ant), Paratrechina longicornis (black crazy ant), Pheidole spp., Pheidole megacephala (big-headed ant), Pogonomyrmex spp., Solenopsis spp., Solenopsis invicta (red imported fire ant), Solenopsis saevissima (Brazilian fire ant), Tapinoma spp., Tapinoma melanocephalum (ghost ant), Tapinoma sessile (odorous house ant), Tetranomorium spp, and Wasmannia auropunctata (little fire ant); pests from the Family Siricidae including, but not limited to, Sirex spp., Sirex noctilio; pests from the Family Vespidae including, but not limited to, Polistes spp., Vespa spp, and Vespula.

Illustrative pests of the Order Lepidoptera that can be controlled or repelled in accordance with the methods of this disclosure include, for example, pests from the Family Cossidae including, but not limited to, Cossus (carpenter moth), Zeuzera coffeae (red branch borer) and Zeuzera pyrina (leopard moth); pests from the Family Crambidae including, but not limited to, Chilo spp., Chilo supressalis (Asiatic rice borer) Cnaphalocerus medinalis (grass leafroller), Crambus spp. (sod webworms), Cydalima spp., Cydalima perspectalis (box tree moth), Diaphania spp., Diaphania indica (cucumber moth) Diatraea spp., Diatraea grandiosella (southwestern corn borer), Diatraea saccharalis (sugarcane borer), Duponchelia fovealis, Leucinodes orbonalis (eggplant borer), Megastes spp., Neoleucinodes elegantalis (tomato fruit borer), Nymphula depunctalis (rice caseworm), Ostrinia spp., Ostrinia furnacalis, (Asian corn borer), Ostrinia nubilalis (European corn borer), Scirpophaga incertulas (yellow stem borer or rice yellow stem borer); pests from the Family Depressariidae including, but not limited to, Cerconota anomella, Stenoma spp., Stenoma catenifer (avocado seed moth); pests from the Family Erebidae including, but not limited to, Anomis sabulifera (jute looper), Anticarsia gemmatalis (velvetbean caterpillar), Eupseudosoma spp., Hypocala andremona, Lymantria spp., Lymantrya dispar (spongy moth), Lymantria dispar asiatica (Asian spongy moth), Lymantria dispar japonica (Japanese spongy moth), Sarsina violascens, Setora nitens, Thagona spp., Thagona postropaea; pests from the Family Gelechiidae including, but not limited to, Anacampsis phytomiella, Anarsia spp., Anarsia lineatella (peach twig borer), Anthistarcha binocularis, Keiferia spp., Keiferia lycopersicella (tomato pinworm), Pectinophora spp., Pectinophora gossypiella (pink bollworm), Phthorimaea spp., Phthorimaea operculella (potato tuberworm), Sitotroga cerealella, (angoumois grain moth), Tecia solanivora (Guatemalan potato tuber moth), Tuta spp, and Tuta absoluta (tomato leafminer); pests from the Family Geometridae including, but not limited to, Thyrinteina arnobia, pests from the Family Gracillariidae including, but not limited to, Conopomorpha spp., Conopomorpha cramerella (cocoa pod borer), Conopomorpha sinensis (litch fruit borer), Phyllocnistis spp, and Phyllocnistis citrella (citrus leaf miner); pests from the Family Lyonetiidae including, but not limited to, Leucoptera spp, Leucoptera coffeella, Perileucoptera spp, and Perileucoptera coffeella (coffee leaf miner); pests from the Family Megalopygidae including, but not limited to, Podalia spp., Podalia orsilochs, Megalopyge spp, and Megalopyge lanata; pests from the Family Mimallonidae including, but not limited to, Cicinnus callipius and Mimallo amilia; pests from the Family Nymphalidae including, but not limited to, Brassolis spp., Brassolis sophorae and Mechanitis spp.; pests from the Family Noctuidae including, but not limited to, Agrotis spp., Agrotis ipsilon (ipsilon moth), Alabama spp., Alabama argillacea (cotton leafworm), Anagrapha spp., Anagrapha falcifera (celery looper), Anticarsia spp., Anticarsia gemmatalis (velvet bean moth) Autographa spp., Autographa gamma (silver Y moth), Chrysodeixis spp., Chrysodeixis includens (soybean looper), Euxoa spp., Euxoa auxiliaris (army cutworm), Feltia spp., Graphania spp., Helicoverpa spp., Helicoverpa armigera (cotton bollworm), Helicoverpa gelotopoeon (South American bollworm moth), Helicoverpa zea (corn earworm), Heliothis spp., Heliothis virescens (tobacco budworm), Loxagrotis spp., Loxagrotis albicosta (Western bean cutworm), Mamestra spp., Mamestra brassicae (cabbage moth), Mythimna spp., Mythimna unipuncta (rice armyworm), Plusia spp., Pseudaletia spp., Pseudoplusia spp., Rachiplusia spp., Rachiplusia nu, Sesamia spp., Sesamia nonagrioides (corn stalk borer), Spodoptera spp., Spodoptera cosmioides (black armyworm), Spodoptera eridania (Southern armyworm), Spodoptera exigua, (beet armyworm), Spodoptera frugiperda (fall armyworm), Spodoptera littoralis (Egyptian cotton leafworm), Spodoptera litura (tobacco cutworm), Trichoplusia spp., Trichoplusia ni (cabbage looper); pests from the Family Phycitidae including, but not limited to, Hyalospila ptychis; pests from the Family Plutellidae including, but not limited to, Plutella spp., Plutella xylostella (diamondback moth); pests from the Family Pyralidae including, but not limited to, Acrobasis spp., Acrobasis vaccinii (cranberry fruitworm), Amyelois spp., Amyelois transitella (navel orangeworm), Cadra spp., Cadra cautella (almond moth), Cryptoblabes spp., Cryptoblabes gnidiella, (honeydew moth), Dioryctria spp., Ectomyelois spp., Ectomyelois ceratoniae (carob moth), Elasmopalpus spp., Elasmopalpus lignosellus (lesser cornstalk borer), Ephestia spp., Ephestia elutella, (cacao moth), Ephestia kuehniella (Mediterranean flour moth), Hypsipyla spp., Hypsipyla grandella, (mahogany shoot borer), Plodia spp, and Plodia interpunctella (Indian meal moth); pests from the Family Riodinidae including, but not limited to Euselasia spp.; pests from the Family Saturnidae including, but not limited to, Citheronia brissotii, Eacles imperialis, Lonomia spp. and Lonomia obliqua; pests from the Family Thaumetopoeidae including, but not limited to, Thaumetopoea spp., Thaumetopoea pityocampa (pine processionary moth) and Thaumetopoea processionea, (oak processionary moth); pests from the Family Tineidae including, but not limited to, Tinea spp., Tinea pellionella (casemaking clothes moth), Tineola spp, and Tineola bisselliella (webbing clothes moth); pests from the Family Tortricidae including, but not limited to, Adoxophyes spp., Adoxophyes orana (summer fruit tortrix), Archips spp., Archips argyrospila, (fruittree leafroller), Archips rosana, (rose tortrix moth), Archips semiferana, (oak leafroller), Archips xylosteana, (brown oak tortrix), Argyrotaenia spp., Argyrotaenia citrana (orange tortrix), Bonagota spp., Bonagota salubricola (Brazilian apple leafroller), Choristoneura spp., Choristoneura fumiferana (Eastern spruce budworm), Choristoneura occidentalis (Western spruce budworm), Choristoneura pinus, (jack pine budworm), Choristoneura rosaceana (obliquebanded leafroller), Cryptophlebia spp., Cryptophlebia batrachopa, (macadamia nut borer), Cryptophlebia leucotreta, (false codling moth), Cryptophlebia ombrodelta, (litchi fruit moth), Cydia spp., Cydia latiferreana (hazelnut-filbertworm), Cydia nigricana (pea moth), Cydia pomonella, (codling moth), Dichrorampha spp., Ecdytolopha spp., Ecdytolopha aurantiana (citrus fruit borer), Endopiza spp., Endopiza viteana (grape berry moth), Epiphyas spp., Epiphyas postvittana (lightbrown apple moth), Eulia spp., Eulia ministrana, Eupoecilia spp., Eupoecilia ambiguella (European grape berry moth), Grapholita spp., Grapholita funebrana (plum fruit moth), Grapholita molesta (Oriental peach moth), Gymnandrosoma spp, aurantianum (macadamia nut borer), Lobesia spp., Lobesia botrana (European grapevine moth), Pandemis spp., Pandemis pyrusana (apple pandemis), Paralobesia spp., Proeulia spp., Rhopobota spp., Rhopobota naevana (blackheaded fireworm), Sparganothis spp., Sparganothis pilleriana (leaf-rolling tortrix), Sparganothis sulfureana (blueberry leafroller), Tortrix spp., Tortrix viridana (European oak leafroller).

Illustrative pests of the Order Orthoptera that can be controlled or repelled in accordance with the methods of this disclosure include, for example, pests from the Family Acrididae including, but not limited to, Chorthippus spp., Chorthippus gregaria (desert locust), Locusta spp., Locusta migratoria (European migratory locust), Melanoplus spp, Valanga spp., and Valanga nigricornis, the Javanese grasshopper; pests from the Family Gryllidae including, but not limited to, Anurogryllus muticus, Gryllus spp, and Gryllus assimilis; pests from the Family Gryllotalpidae including, but not limited to, Gryllotalpa gryllotalpa (European mole cricket); pests from the Family Tettigoniidae including, but not limited to, Anabrus simplex (Mormon cricket), Microcentrum retinerve (angular-winged katydid), Pterophylla camellifolia (common true katydid) and Scudderia furcata (fork-tailed bush katydid).

Illustrative pests of the Order Psocodea that can be controlled or repelled in accordance with the methods of this disclosure include, for example, pests from the Family Haematopinidae including, but not limited to, Haematopinus spp. (cattle and hog lice); pests from the Family Linognathidae including, but not limited to, Linognathus ovillus (sheep louse); pests from the Family Liposcelididae including, but not limited to, Liposcelis spp, and Liposcelis divinatorius (booklice); pests from the Family Menoponidae including, but not limited to, Menacanthus stramineus (chicken body louse) and Menopon gallinea (common hen house); pests from the Family Pediculidae including, but not limited to, Pediculus humanus capitis (human body louse) and Pediculus humanus (human body lice); pests from the Family Pthiridae including, but not limited to, Pthirus pubis (crab louse); pests from the Family Trichodectidae including, but not limited to, Bovicola ovis (sheep biting louse).

Illustrative pests of the Order Siphonaptera that can be controlled or repelled in accordance with the methods of this disclosure include, for example, pests from the Family Hectopsyllidae including, but not limited to, Tunga spp., and Tunga penetrans; pests from the Family Pulicidae including, but not limited to, Ctenocephalides spp., Ctenocephalides canis (dog flea), Ctenocephalides felis felis (cat flea) and Pulex irritans (human flea).

Illustrative pests of the Order Thysanoptera that can be controlled or repelled in accordance with the methods of this disclosure include, for example, pests from the Family Thripidae including, but not limited to, Caliothrips brasiliensis, Enneothrips enigmaticus (peanut thrips), Frankliniella spp., Frankliniella fusca (tobacco thrips), Frankliniella occidentalis (western flower thrips), Frankliniella shultzei Frankliniella williamsi (corn thrips), Heliothrips haemorrhaidalis (greenhouse thrips), Retithrips spp., Retithrips syriacus (black vine thrips), Riphiphorothrips spp., Riphiphorothrips cruentatus (grapevine thrips), Scirtothrips spp., Scirtothrips aurantii (South African citrus thrips), Scirtothrips citri (California citrus thrips) Scirtothrips dorsalis (chilli thrips), Selenothrips spp., Selenothrips rubrocinctus, Thrips spp., Taeniothrips spp, and Taeniothrips rhopalantennalis.

Illustrative pests of the Order Zygentoma that can be controlled or repelled in accordance with the methods of this disclosure include, for example, pests from the Family Lepismatidae including, but not limited to, Lepisma spp., Lepisma saccharinum (silverfish) and Thermobia spp. (firebrats).

Illustrative pests of the Class Arachnida that can be controlled or repelled in accordance with the methods of this disclosure include, for example, pests from the Subphylum Chelicerata.

Illustrative pests of the Order Aranae that can be controlled or repelled in accordance with the methods of this disclosure include, for example, pests from the Family Ctenidae including, but not limited to, Phoneutria spp, and Phoneutria nigriventer; pests from the Family Sicariidae including, but not limited to, Loxosceles spp.; pests from the Family Theridiidae including, but not limited to Latrodectus spp.

Illustrative pests of the Order Ixodida that can be controlled or repelled in accordance with the methods of this disclosure include, for example, pests from the Family Ixodidae including, but not limited to, Amblyomma spp., Amblyomma americanum (lone star tick), Amblyomma cajennense (cayenne tick), Boophilus spp. Dermacentor spp., Dermacentor variabilis (American dog tick), Ixodes spp., Ixodes scapularis (black-legged tick), Rhipicephalus spp, and Rhipicephalus sanguineus (brown dog tick).

Illustrative pests of the Order Mesostigmata that can be controlled or repelled in accordance with the methods of this disclosure include, for example, pests from the Family Varroidae including, but not limited to, Varroa destructor (honey bee mite).

Illustrative pests of the Order Sarcoptiformes that can be controlled or repelled in accordance with the methods of this disclosure include, for example, pests from the Family Acaridae including, but not limited to, Acarus spp., Acarus siro (grain mite) and Rhizoglyphus spp.

Illustrative pests of the Order Scorpiones that can be controlled or repelled in accordance with the methods of this disclosure include, for example, pests from the Family Buthidae including, but not limited to, Androctonus spp., Buthus spp., Centruroides spp., Centruroides sculpturatus (Arizona bark scorpion), Hottentotta spp., Leiurus spp., Parabuthus spp., Tityus spp., Tityus bahiensis (Brazilian scorpion), Tityus serrulatus (Brazilian yellow scorpion) and Tityus stigmurus.

Illustrative pests of the Order Trombidiformes that can be controlled or repelled in accordance with the methods of this disclosure include, for example, pests from the Family Eriophyidae including, but not limited to, Aceria spp., Aceria guerreronis (coconut mite), Aceria mangiferae (mango bud mite), Aculops spp., Aculops lycopersici (tomato russet mite), Aculops pelekasi, Aculus pelekassi, Aculus schlechtendali (apple rust mite), Eriophyes spp., Phyllocoptruta oleivora (citrus rust mite) and Tegolophus perseaflorae (avocado bud mite); pests from the Family Tarsonemidae including, but not limited to, Acarapsis woodi (tracheal mite of honeybees), Polyphagotarsonemus latus (broad mite), Phytonemus pallidus (cyclamen mite); pests from the Family Tenuipalpidae including, but not limited to, Brevipalpus spp., Brevipalpus obovatus (privet mite) and Brevipalpus phoenicis (red and black flat mite); pests from the Family Tetranychidae including, but not limited to, Eotetranycus spp., Eotetranychus carpini (yellow spider mite), Oligonychus spp., Oligonychus coffee, Oligonychus ilicus (southern red mite), Panonychus spp., Panonychus citri (citrus red mite), Panonychus ulmi (European red mite), Tetranychus spp, and Tetranychus urticae (twospotted spider mite).

The formulations of this disclosure can be formulated to exhibit broad spectrum control or repellant activity. It is usually necessary to add other substances so that the formulation may be used at the required concentration and in an appropriate form, permitting ease of application, handling, transportation, storage, and maximum control or repellant activity. Thus, the formulations of this disclosure are formulated into, for example, concentrated emulsions, dusts, emulsifiable concentrates, fumigants, gels, granules, microencapsulations, seed treatments, suspension concentrates, suspoemulsions, tablets, water soluble liquids, water dispersible granules or dry flowables, wettable powders, and ultra-low volume solutions.

The formulations can be applied as aqueous suspensions or emulsions prepared from concentrated formulations. Such water-soluble, water-suspendable, or emulsifiable formulations are either solids, usually known as wettable powders, water dispersible granules, liquids usually known as emulsifiable concentrates, or aqueous suspensions. Wettable powders, which may be compacted to form water dispersible granules, comprise an intimate mixture of the formulation, a carrier, and surfactants. The concentration of the active ingredient (i.e., one or more compounds of structure (A)) is usually from about 10% to about 100% by weight. The carrier is usually selected from among the attapulgite clays, the montmorillonite clays, the diatomaceous earths, or the purified silicates. Effective surfactants, comprising from about 0.5% to about 10% of the wettable powder, are found among sulfonated lignins, condensed naphthalenesulfonates, naphthalenesulfonates, alkylbenzenesulfonates, alkyl sulfates, and non-ionic surfactants such as ethylene oxide adducts of alkyl phenols.

Emulsifiable concentrates of formulations comprise a convenient concentration of an active ingredient (i.e., one or more compounds of structure (A)), such as from about 50 to about 500 grams per liter of liquid dissolved in a carrier that is either a water miscible solvent or a mixture of water-immiscible organic solvent and emulsifiers. Useful organic solvents include aromatics, especially xylenes and petroleum fractions, especially the high-boiling naphthalenic and olefinic portions of petroleum such as heavy aromatic naphtha. Other organic solvents may also be used, such as the terpenic solvents including rosin derivatives, aliphatic ketones such as cyclohexanone, and complex alcohols such as 2-ethoxyethanol. Suitable emulsifiers for emulsifiable concentrates are selected from conventional anionic and non-ionic surfactants.

Aqueous suspensions comprise suspensions of water-insoluble formulations dispersed in an aqueous carrier at a concentration in the range from about 5% to about 50% by weight. Suspensions are prepared by finely grinding the formulation and vigorously mixing it into a carrier comprised of water and surfactants. Ingredients, such as inorganic salts and synthetic or natural gums may, also be added to increase the density and viscosity of the aqueous carrier. It is often most effective to grind and mix the formulation at the same time by preparing the aqueous mixture and homogenizing it in an implement such as a sand mill, ball mill, or piston-type homogenizer. The formulation in suspension might be microencapsulated in plastic polymer.

Oil dispersions (OD) comprise suspensions of organic solvent-insoluble formulations finely dispersed in a mixture of organic solvent and emulsifiers at a concentration in the range from about 2% to about 50% by weight. One or more formulations might be dissolved in the organic solvent. Useful organic solvents include aromatics, especially xylenes and petroleum fractions, especially the high-boiling naphthalenic and olefinic portions of petroleum such as heavy aromatic naphtha. Other solvents may include vegetable oils, seed oils, and esters of vegetable and seed oils. Suitable emulsifiers for oil dispersions are selected from conventional anionic and non-ionic surfactants. Thickeners or gelling agents are added in the formulation of oil dispersions to modify the rheology or flow properties of the liquid and to prevent separation and settling of the dispersed particles or droplets.

The formulations of this disclosure may also be applied as granular compositions that are particularly useful for applications to the soil. Granular compositions usually contain from about 0.5% to about 10% by weight of the active ingredient (i.e., one or more compounds of structure (A)), dispersed in a carrier that comprises clay or a similar substance. Such compositions are usually prepared by dissolving the formulation in a suitable solvent and applying it to a granular carrier, which has been pre-formed to the appropriate particle size, in the range of from about 0.5 mm to about 3 mm carrier and formulation, and then crushing and drying to obtain the desired granular particle size. Another form of granules is a water emulsifiable granule (EG). It is a formulation consisting of granules to be applied as a conventional oil-in-water emulsion of the active ingredient(s), either solubilized or diluted in an organic solvent, after disintegration and dissolution in water. Water emulsifiable granules comprise one or several active ingredient(s), either solubilized or diluted in a suitable organic solvent that is (are) absorbed in a water soluble polymeric shell or some other type of soluble or insoluble matrix.

Dusts containing a formulation are prepared by intimately mixing the formulation in powdered form with a suitable dusty carrier, such as kaolin clay, ground volcanic rock, and the like. Dusts can suitably contain from about 1% to about 10% of the active ingredient (i.e., one or more compounds of structure (A)). Dusts may be applied as a seed dressing or as a foliage application with a dust blower machine.

It is equally practical to apply a formulation in the form of a solution in an appropriate organic solvent, usually petroleum oil, such as the spray oils.

The formulations of this disclosure can also be applied in the form of an aerosol composition. In such compositions, the active ingredient (i.e., one or more compounds of structure (A)), is dissolved or dispersed in a carrier, which is a pressure-generating propellant mixture. The aerosol composition is packaged in a container from which the mixture is dispensed through an atomizing valve.

Fumigants have a relatively high vapor pressure and hence can exist as a gas in sufficient concentrations to control or repel pests in enclosed spaces, e.g., storage spaces. The controlling and repelling effect of the fumigant is proportional to its concentration and the exposure time. They are characterized by a good capacity for diffusion and act by penetrating the pest's respiratory system or being absorbed through the pest's cuticle. Fumigants are applied to control stored product pests under gas proof sheets, in gas sealed rooms or buildings, or in special chambers.

The formulations may be microencapsulated by suspending the active ingredient particles or droplets in plastic polymers of various types. By altering the chemistry of the polymer or by changing factors in the processing, microcapsules may be formed of various sizes, solubility, wall thicknesses, and degrees of penetrability. These factors govern the speed with which the active ingredient within is released, which in turn, affects the residual performance, speed of action, and odor of the product. The microcapsules might be formulated as suspension concentrates or water dispersible granules.

Oil solution concentrates are made by dissolving the formulation in a solvent that will hold the active ingredient in solution. Advantages of oil solutions include better storage stability, better penetration of crevices, and better adhesion to greasy surfaces.

Another embodiment is an oil-in-water emulsion, wherein the emulsion comprises oily globules which are each provided with a lamellar liquid crystal coating and are dispersed in an aqueous phase, wherein each oily globule comprises at least one formulation which is active, and is individually coated with a monolamellar or oligolamellar layer comprising: (1) at least one non-ionic lipophilic surface-active agent, (2) at least one non-ionic hydrophilic surface-active agent, and (3) at least one ionic surface-active agent, wherein the globules having a mean particle diameter of less than 800 nanometers.

Generally, the formulations of this disclosure can also contain other components. These components include, but are not limited to, wetters, spreaders, stickers, penetrants, buffers, sequestering agents, drift reduction agents, compatibility agents, anti-foam agents, cleaning agents, and emulsifiers. A few components are described below.

A wetting agent is a substance that when added to a liquid increases the spreading or penetration power of the liquid by reducing the interfacial tension between the liquid and the surface on which it is spreading. Wetting agents are used for two main functions in formulations: during processing and manufacture to increase the rate of wetting of powders in water to make concentrates for soluble liquids or suspension concentrates; and during mixing of a product with water in a spray tank to reduce the wetting time of wettable powders and to improve the penetration of water into water-dispersible granules. Examples of wetting agents used in wettable powder, suspension concentrate, and water-dispersible granule formulations are: sodium lauryl sulfate; sodium dioctyl sulfosuccinate; alkyl phenol ethoxylates; and aliphatic alcohol ethoxylates.

A dispersing agent is a substance that adsorbs onto the surface of particles, helps to preserve the state of dispersion of the particles, and prevents them from reaggregating. Dispersing agents are added to formulations to facilitate dispersion and suspension during manufacture, and to ensure the particles redisperse into water in a spray tank. They are widely used in wettable powders, suspension concentrates, and water-dispersible granules. Surfactants that are used as dispersing agents have the ability to adsorb strongly onto a particle surface and provide a charged or steric barrier to reaggregation of particles. The most commonly used surfactants are anionic, non-ionic, or mixtures of the two types. For wettable powder formulations, the most common dispersing agents are sodium lignosulfonates. For suspension concentrates, very good adsorption and stabilization are obtained using polyelectrolytes, such as sodium-naphthalene-sulfonate-formaldehyde-condensates. Tristyrylphenol ethoxylate phosphate esters are also used. Non-ionics such as alkylarylethylene oxide condensates and EO-PO block copolymers are sometimes combined with anionics as dispersing agents for suspension concentrates. In recent years, new types of very high molecular weight polymeric surfactants have been developed as dispersing agents. These have very long hydrophobic ‘backbones’ and a large number of ethylene oxide chains forming the ‘teeth’ of a ‘comb’ surfactant. These high molecular weight polymers can give very good long-term stability to suspension concentrates because the hydrophobic backbones have many anchoring points onto the particle surfaces. Examples of dispersing agents used in formulations are: sodium lignosulfonates; sodium naphthalene sulfonate formaldehyde condensates; tristyrylphenol-ethoxylate-phosphate-esters; aliphatic alcohol ethoxylates; alkyl ethoxylates; EO-PO block copolymers; and graft copolymers.

An emulsifying agent is a substance that stabilizes a suspension of droplets of one liquid phase in another liquid phase. Without the emulsifying agent, the two liquids would separate into two immiscible liquid phases. The most commonly used emulsifier blends contain an alkylphenol or an aliphatic alcohol with twelve or more ethylene oxide units and the oil-soluble calcium salt of dodecylbenzenesulfonic acid. A range of hydrophile-lipophile balance (“HLB”) values from about 8 to about 18 will normally provide good stable emulsions. Emulsion stability can sometimes be improved by the addition of a small amount of an EO-PO block copolymer surfactant.

A solubilizing agent is a surfactant that will form micelles in water at concentrations above the critical micelle concentration. The micelles are then able to dissolve or solubilize water-insoluble materials inside the hydrophobic part of the micelle. The types of surfactants usually used for solubilization are non-ionics, sorbitan monooleates, sorbitan monooleate ethoxylates, and methyl oleate esters.

Surfactants are sometimes used, either alone or with other additives such as mineral or vegetable oils as adjuvants to spray-tank mixes to improve the biological performance of the formulation on the target. The types of surfactants used for bioenhancement depend generally on the nature and mode of action of the formulation. However, they are often non-ionics such as: alkyl ethoxylates; linear aliphatic alcohol ethoxylates; and aliphatic amine ethoxylates.

A carrier or diluent in a formulation is a material added to the formulation to give a product of the required strength. Carriers are usually materials with high absorptive capacities, while diluents are usually materials with low absorptive capacities. Carriers and diluents are used in the formulation of dusts, wettable powders, granules, and water-dispersible granules.

Organic solvents are used mainly in the formulation of emulsifiable concentrates, oil-in-water emulsions, suspoemulsions, oil dispersions, and ultra-low volume formulations, and to a lesser extent, granular formulations. Sometimes mixtures of solvents are used. The first main groups of solvents are aliphatic paraffinic oils such as kerosene or refined paraffins. The second main group (and the most common) comprises the aromatic solvents such as xylene and higher molecular weight fractions of C9 and C10 aromatic solvents. Chlorinated hydrocarbons are useful as cosolvents to prevent crystallization when the formulation is emulsified into water. Alcohols are sometimes used as cosolvents to increase solvent power. Other solvents may include vegetable oils, seed oils, and esters of vegetable and seed oils.

Thickeners or gelling agents are used mainly in the formulation of suspension concentrates, oil dispersions, emulsions and suspoemulsions to modify the rheology or flow properties of the liquid and to prevent separation and settling of the dispersed particles or droplets. Thickening, gelling, and anti-settling agents generally fall into two categories, namely water-insoluble particulates, and water-soluble polymers. It is possible to produce suspension concentrate and oil dispersion formulations using clays and silicas. Examples of these types of materials, include, but are not limited to, montmorillonite, bentonite, magnesium aluminum silicate, and attapulgite. Water-soluble polysaccharides in water based suspension concentrates have been used as thickening-gelling agents for many years. The types of polysaccharides most commonly used are natural extracts of seeds and seaweeds or are synthetic derivatives of cellulose. Examples of these types of materials include, but are not limited to, guar gum; locust bean gum; carrageenam; alginates; methyl cellulose; sodium carboxymethyl cellulose (SCMC); and hydroxyethyl cellulose (HEC). Other types of anti-settling agents are based on modified starches, polyacrylates, polyvinyl alcohol, and polyethylene oxide. Another good anti-settling agent is xanthan gum.

Microorganisms can cause spoilage of formulated products. Therefore, preservation agents are used to eliminate or reduce their effect. Examples of such agents include, but are not limited to: propionic acid and its sodium salt; sorbic acid and its sodium or potassium salts; benzoic acid and its sodium salt; p-hydroxybenzoic acid sodium salt; methyl p-hydroxybenzoate; and 1,2-benzisothiazolin-3-one (BIT).

The presence of surfactants often causes water-based formulations to foam during mixing operations in production and in application through a spray tank. In order to reduce the tendency to foam, anti-foam agents are often added either during the production stage or before filling into bottles. Generally, there are two types of anti-foam agents, namely silicones and non-silicones. Silicones are usually aqueous emulsions of dimethyl polysiloxane, while the non-silicone anti-foam agents are water-insoluble oils, such as octanol and nonanol, or silica. In both cases, the function of the anti-foam agent is to displace the surfactant from the air-water interface.

“Green” agents (e.g., adjuvants, surfactants, solvents) can reduce the overall environmental footprint of the formulations. Green agents are biodegradable and generally derived from natural and/or sustainable sources, e.g., plant and animal sources. Specific examples are: vegetable oils, seed oils, and esters thereof, also alkoxylated alkyl polyglucosides.

The formulations of this disclosure may be applied to any locus. Particular loci to apply such formulations include loci where alfalfa, almonds, apples, barley, beans, canola, corn, cotton, crucifers, flowers, fodder species (Rye Grass, Sudan Grass, Tall Fescue, Kentucky Blue Grass, and Clover), fruits, lettuce, oats, oil seed crops, oranges, peanuts, pears, peppers, potatoes, rice, sorghum, soybeans, strawberries, sugarcane, sugarbeets, sunflowers, tobacco, tomatoes, wheat (for example, Hard Red Winter Wheat, Soft Red Winter Wheat, White Winter Wheat, Hard Red Spring Wheat, and Durum Spring Wheat), and other valuable crops are growing or the seeds thereof are going to be planted.

The formulations of this disclosure may also be applied where plants, such as crops, are growing, or forests, or storage areas, and where there are low levels (even no actual presence) of pests that can commercially damage such plants, trees, or storage items. Applying such formulations in such locus is to benefit the plants or trees being grown in such locus. Such benefits, may include, but are not limited to: helping the plant or tree grow a better root system; helping the plant or tree better withstand stressful growing conditions; improving the health of a plant or tree; improving the yield of a plant or tree (e.g. increased biomass and/or increased content of valuable ingredients); improving the vigor of a plant or tree (e.g. improved plant growth and/or greener leaves); improving the quality of a plant or tree (e.g. improved content or composition of certain ingredients); and improving the tolerance to abiotic and/or biotic stress of the plant or tree.

The formulations of this disclosure may be applied with ammonium sulfate when growing various plants or trees as this may provide additional benefits.

The formulations of this disclosure may be applied on, in, or around plants or trees genetically modified to express specialized traits, such as Bacillus thuringiensis (for example, Cry1Ab, Cry1Ac, Cry1Fa, Cry1A.105, Cry2Ab, Vip3A, mCry3A, Cry3Ab, Cry3Bb, Cry34Ab1/Cry35Ab1), other insecticidal toxins, or those expressing herbicide tolerance, or those with “stacked” foreign genes expressing insecticidal toxins, herbicide tolerance, nutrition-enhancement, or any other beneficial traits.

The formulations of this disclosure may be applied to the foliar and/or fruiting portions of plants to control or repel pests. Either such formulations will come in direct contact with the pest, or the pest will consume such formulation when eating the plant or while extracting sap or other nutrients from the plant.

The formulations of this disclosure may also be applied to the soil, and when applied in this manner, root and stem feeding pests may be controlled or repelled. The roots may absorb such formulations thereby taking it up into the foliar portions of the plant to control or repel above ground chewing and sap feeding pests.

Systemic movement of the formulations in plants may be utilized to control or repel pests on one portion of the plant by applying (for example by spraying a locus) a formulation of this disclosure to a different portion of the plant. For example, control or repellency of foliar-feeding insects may be achieved by drip irrigation or furrow application, by treating the soil with for example pre- or post-planting soil drench, or by treating the seeds of a plant before planting.

The formulations of this disclosure may be encapsulated inside, or placed on the surface of a capsule. The size of the capsules can range from nanometer size (about 100-900 nanometers in diameter) to micrometer size (about 10-900 microns in diameter).

The formulations of this disclosure may also be applied to invasive pests. Pests around the world have been migrating to new environments (for such pest) and thereafter becoming a new invasive species in such new environment. Such formulations may also be used on such new invasive species to control or repel them in such new environments.

Before the formulation may be used or sold commercially, such formulation typically undergoes lengthy evaluation processes by various governmental authorities (local, regional, state, national, and international). Voluminous data requirements are specified by regulatory authorities and must be addressed through data generation and submission by the product registrant or by a third party on the product registrant's behalf. These governmental authorities then review such data and if a determination of safety is concluded, provide the potential user or seller with product registration approval. Thereafter, in that locality where the product registration is granted and supported, such user or seller may use or sell such formulation.

The formulations described above can be prepared by any convenient means, for example, by mixing the active compound (i.e., one or more compounds of structure (A)) with one or more other carriers or vehicles such as, including but not limited to, those described herein before.

In an embodiment, a synergistic effect can be exhibited with the formulations of this disclosure.

Preferred embodiments of this disclosure are set forth in the clauses below.

1. A method for controlling or repelling one or more pests, the method comprising disrupting intraspecific communication and/or interspecific communication in said one or more pests, by exposing said one or more pests to a formulation comprising one or more compounds of structure (A) represented by the structure:

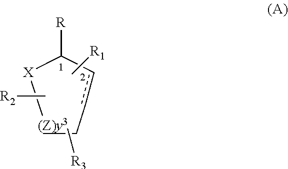

wherein
R is selected from the group consisting of —OH, ═O, —OC(O)R₄, —OR₆, —(OR₆) 2, wherein each R₆ is independently selected from an alkyl group containing from 1 to 4 carbon atoms and R₄ is a branched or straight chain, saturated or unsaturated hydrocarbyl group with zero to two double bonds and from 1 to 15 carbon atoms;
X is O or CH₂, with the proviso that when X is O, then R can only be ═O;
each Z is independently selected from the group consisting of (CH) and (CH₂);
y is a numeral selected from 1 and 2;
R₁ is selected from the group consisting of H or a branched or straight chain, saturated or unsaturated hydrocarbyl group with zero to two double bonds and from 1 to 15 carbon atoms;
R₂ is selected from the group consisting of H and a branched or straight chain, saturated or unsaturated hydrocarbyl group with zero to three double bonds and from 1 to 15 carbon atoms;
R₃ is selected from the group consisting of H and a branched or straight chain, saturated or unsaturated hydrocarbyl group with zero to three double bonds and from 1 to 15 carbon atoms, —(CH₂)ₙOH, —C(O)OR₅, —CH₂C(O)OR₇, —CH₂C(O)R₈, —C(O)NR₉R₁₀, —CH₂C(O)NR₁₁R₁₂ where each of R₅, R₇, R₈, R₉, R₁₀, R₁₁ and R₁₂ is independently selected from H and a branched or straight chain, saturated or unsaturated hydrocarbyl group with zero to three double bonds and from 1 to 15 carbon atoms and n is an integer of from 1 to 12;
the bond between the 2 and 3 positions in the ring structure may be a single or a double bond;
wherein the compounds of structure (A) contain from 11 to 20 total carbon atoms; and
wherein the one or more compounds of structure (A) are present in an amount from about 0.001% by weight to about 99% by weight, based on the total weight of the formulation.

2. The method according to clause 1 wherein the one or more pests are selected from the group consisting of agricultural pests, forestry pests, storage pests, urban pests, and public health pests.

3. The method according to clause 1 wherein the intraspecific communications comprise pheromone-mediated communications, and the interspecific communications comprise allelochemical and visual mediated communications.

4. The method according to clause 3 wherein the pheromone-mediated communication comprises communication associated with mating and aggregation behavior, the effect of sexual and aggregation pheromones, and attraction.

5. The method according to clause 3 wherein the allelochemical-mediated communication comprises communication associated with oviposition behavior, the attraction effect of crops and other substrates, and attraction.

6. The method according to clause 3 wherein the visual mediated communication comprises communication associated with attraction behavior due the effect of colors, shapes, and textures of substrates

7. The method according to clause 1 wherein the one or more pests are selected from the group consisting of Blatoddean pests, Coleopteran pests, Dermapteran pests, Dipteran pests, Hemipteran pests, Hymenopteran pests, Lepidopteran pests, Orthopteran pests, Psocodean pests, Siphonapteran pests, Thysanopteran pests, Zygentoman pests, Araneae pests, Ixodidan pests, Mesostigmatan pests, Sarcoptiformes pests, Scorpiones pests, Trombidiformes pests, and Acari pests.

8. The method according to clause 1 wherein the one or more pests are selected from the group consisting of beetles, flies, ants, moths, butterflies, grasshoppers, thrips, mites, true bugs, bed bugs, aphids, weevils, ants, leafhoppers, crickets, mealybugs, scales, psyllids, wasps, ticks, spiders, scorpions, locusts, termites, bees, stinkbugs, caterpillars, larva, whiteflies, crickets, cockroaches, fleas, earwigs, grubs, fruit flies, midges, scarabs, mosquitoes, hornets, silverfishes, firebrats, bristletails, and lice.

9. The method according to clause 1 wherein the one or more pests are selected from the group consisting of pests of fruits and tree nuts, pests of vegetables, pests of field crops, pests of row crops, soil pests, seed pests, pests of ornamentals, pests of herbs and spices, pests of trees, palm tree pests, pests of turf, pests of pasture, forestry pests, pest of greenhouses, storage pests, grain pests, structural pests, urban pests, disease vector pests, public health pests, and veterinary pests.

10. The method according to clause 1 wherein the one or more compounds of structure (A) are present in an amount from about 0.001% by weight to about 90% by weight, or from about 0.001% by weight to about 75% by weight, or from about 0.001% by weight to about 50% by weight, or from about 0.001% by weight to about 25% by weight, or from about 0.001% by weight to about 10% by weight, or from about 0.001% by weight to about 5% by weight, based on the total weight of the formulation.

11. The method according to clause 1 wherein the one or more compounds of structure (A) comprise a compound wherein R is —OH, ═O, O(O)CR; R₁ is H or CH₃; R₂ is H or CH₃; R₃ is H or a branched or straight chain, saturated or unsaturated hydrocarbyl group with zero to three double bonds, and from 1 to 11 carbon atoms; and wherein the compounds of structure (A) contain from 6 to 20 total carbon atoms.

12. The method according to clause 1 wherein the one or more compounds of structure (A) comprise a compound wherein R is ═O or —OH, X is CH₂, Z is (CH) or (CH₂), y is 1, the bond between positions 2 and 3 is a single bond, R₁ is H, R₂ is H, and R₃ is an alkenyl group having at least 11 carbon atoms and 1 or 2 double bonds.

13. The method according to clause 1 wherein the one or more compounds of structure (A) comprise a compound wherein R is ═O or —OH, X is CH₂, Z is (CH) or (CH₂), y is 1, the bond between positions 2 and 3 is a single bond, R₁ is an alkyl group having at least 5 carbon atoms, R₂ is H, and R₃ is —C(O)OR₅, and R₅ is an alkyl or alkenyl group containing at least 3 carbon atoms.

14. The method of clause 1 wherein the one or more compounds of structure (A) comprise a compound wherein R is ═O, X is O, Z is CH or CH₂, y is 1 or 2, the bond between positions 2 and 3 is a single bond, R₁ is an alkyl group of from 7 to 11 carbon atoms, R₂ is H, and R₃ is H or CH₃.

15. The method according to clause 1 wherein the one or more compounds of structure (A) are selected from the group consisting of

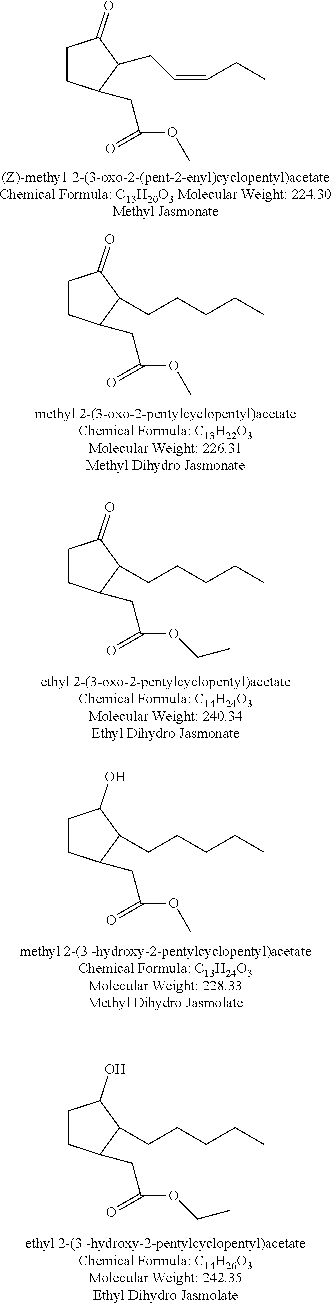 [SMILES: CC/C=C\CC1C(=O)CCC1CC(=O)OC ; CCCCCC1C(=O)CCC1CC(=O)OC ; CCCCCC1C(=O)CCC1CC(=O)OCC ; CCCCCC1C(O)CCC1CC(=O)OC ; CCCCCC1C(O)CCC1CC(=O)OCC]

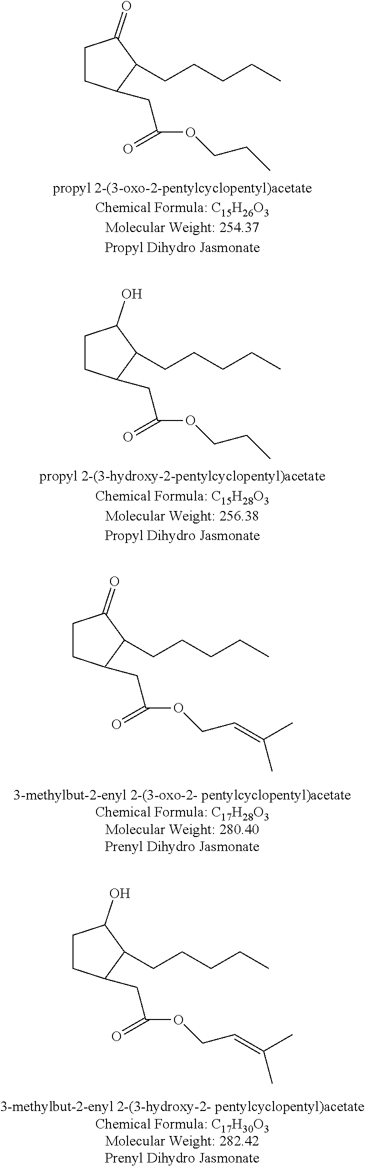 [SMILES: CCCCCC1C(=O)CCC1CC(=O)OCCC ; CCCCCC1C(O)CCC1CC(=O)OCCC ; CCCCCC1C(=O)CCC1CC(=O)OCC=C(C)C ; CCCCCC1C(O)CCC1CC(=O)OCC=C(C)C]

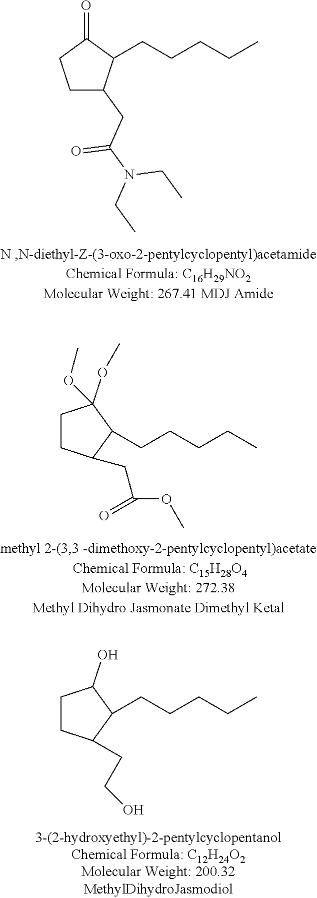 [SMILES: CCCCCC1C(=O)CCC1CC(=O)N(CC)CC ; CCCCCC1C(CC(=O)OC)CCC1(OC)OC ; CCCCCC1C(O)CCC1CCO]

16. The method according to clause 1 wherein the one or more compounds of structure (A) are selected from the group consisting of:

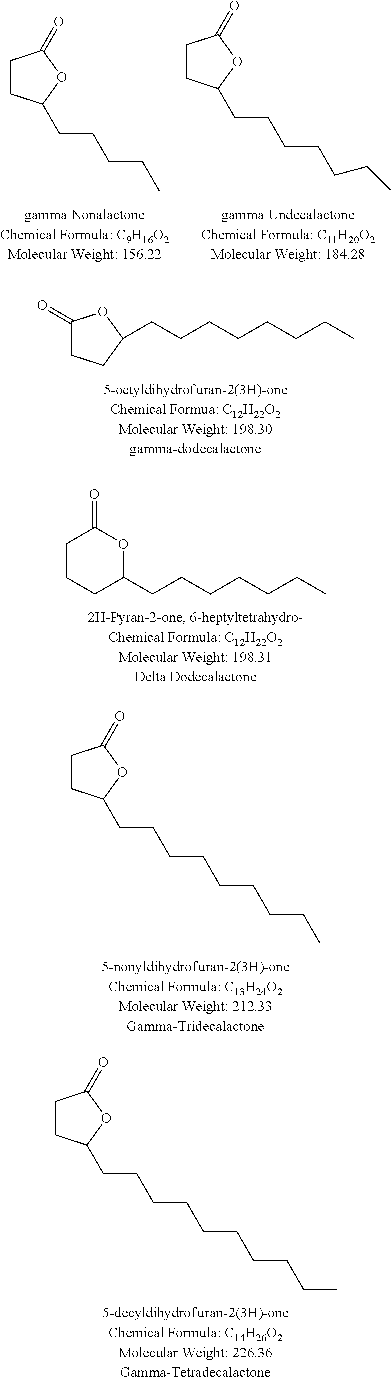 [SMILES: CCCCCC1CCC(=O)O1 ; CCCCCCCC1CCC(=O)O1 ; CCCCCCCCC1CCC(=O)O1 ; CCCCCCCC1CCCC(=O)O1 ; CCCCCCCCCC1CCC(=O)O1 ; CCCCCCCCCCC1CCC(=O)O1]

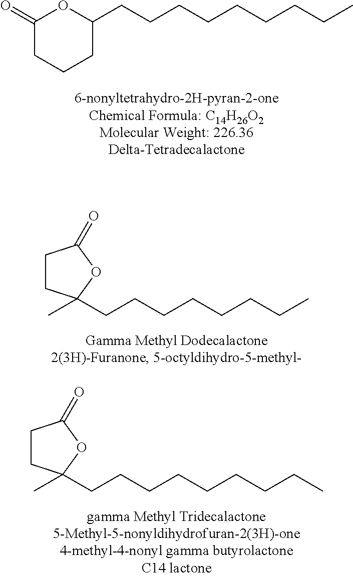 [SMILES: CCCCCCCCCC1CCCC(=O)O1 ; CCCCCCCCC1(C)CCC(=O)O1 ; CCCCCCCCCC1(C)CCC(=O)O1]

17. The method according to clause 1 wherein the one or more compounds of structure (A) are selected from the group consisting of

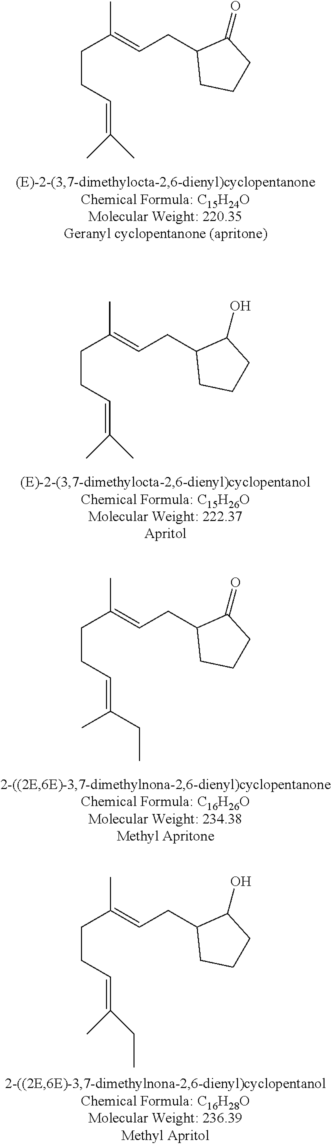 [SMILES: CC(C)=CCC/C(C)=C/CC1CCCC1=O ; CC(C)=CCC/C(C)=C/CC1CCCC1O ; CC/C(C)=C/CC/C(C)=C/CC1CCCC1=O ; CC/C(C)=C/CC/C(C)=C/CC1CCCC1O]

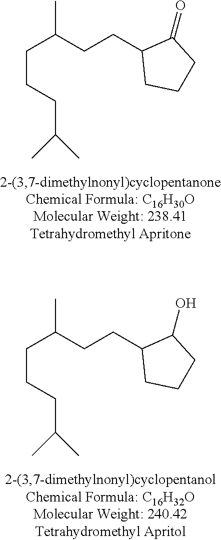 [SMILES: CC(C)CCCC(C)CCC1CCCC1=O ; CC(C)CCCC(C)CCC1CCCC1O]

18. The method according to clause 1 wherein the one or more compounds of structure (A) are selected from the group consisting of:

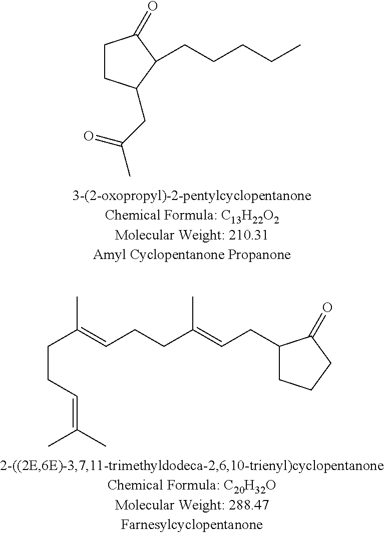 [SMILES: CCCCCC1C(=O)CCC1CC(C)=O ; CC(C)=CCC/C(C)=C/CC/C(C)=C/CC1CCCC1=O]

19 The method according to clause 1 wherein the one or more compounds of structure (A) are selected from the group consisting of

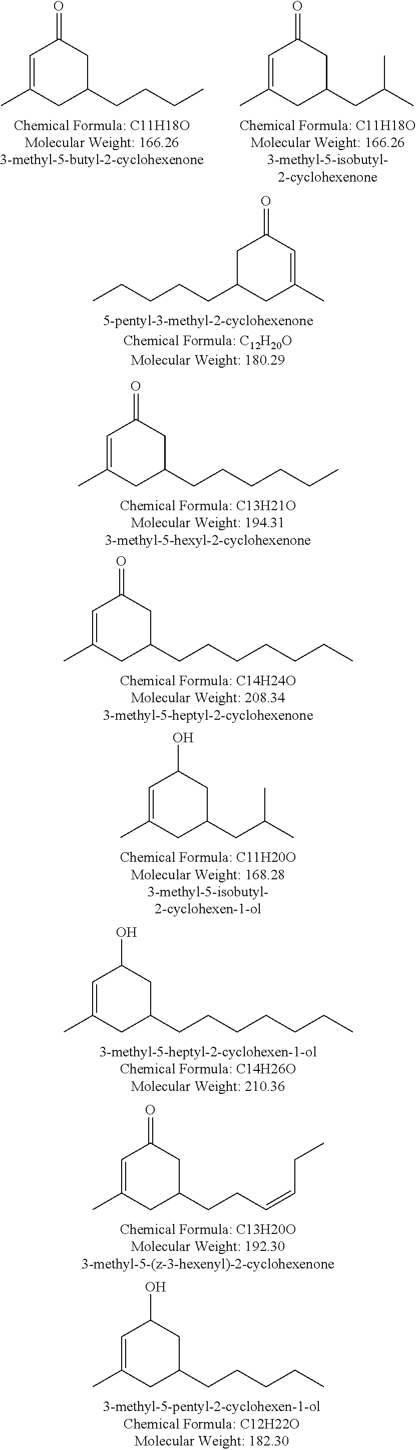

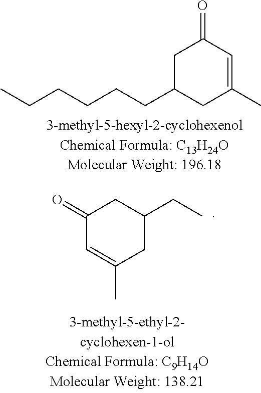

20. The method according to clause 1 wherein the one or more compounds of structure (A) is represented by the formula:

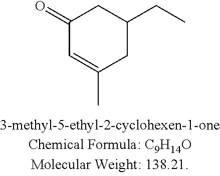

21 The method according to clause 1 wherein the one or more compounds of structure (A) comprise methyl jasmonate, methyl dihydrojasmonate, ethyl dihydrojasmonate, propyl dihydrojasmonate, geranyl cyclopentanone (apritone, cyclopentanone, 2-(3,7-dimethyl-2,6-octadienyl)-), methyl apritone (cyclopentanone, 2-(3,7-dimethyl-2,6-nonadien-1-yl)-), delta-dodecalactone, gamma-dodecalactone, gamma-undecalactone, gamma methyl dodecalactone, gamma-tridecalactone, gamma methyl tridecalactone, gamma-tetradecalactone, 3-methyl-5-ethyl-2-cyclohexenone, 3-methyl-5-propyl-2-cyclohexenone, 3-methyl-5-butyl-2-cyclohexenone, 3-methyl-5-pentyl-2-cyclohexenone, 3-methyl-5-hexyl-2-cyclohexenone, or 3-methyl-5-heptyl-2-cyclohexenone.

22. The method according to clause 1 wherein the formulation further comprises one or more of a carrier or diluent, an organic solvent, a rheological modifier or gelling agent, a preservation agent, a surfactant, or any combination thereof.

23. The method according to clause 1 wherein the formulation further comprises one or more of a wetter, a spreader, a sticker, a penetrant, a buffer, a sequestering agent, a drift reduction agent, a compatibility agent, an anti-foam agent, a cleaning agent, a plasticizer agent, an antifreeze agent, an UV blocking agent, an anti-oxidant agent, an emulsifier, a film former, or any combination thereof.

24 The method according to clause 1 wherein the formulation is formulated into granules, dusts, soluble powders, wettable powders, pastes, emulsifiable concentrates, aerosols, ultra low-volume concentrates, flowable suspensions, oils, sprays, lures, biodegradable flakes, microcapsules, plastic flakes, emulsions, microemulsions, wax emulsions, pellets, natural waxes, synthetic waxes, resins, glues, puffers, membrane systems, film systems, pouches, bubble caps, blocks, monoliths, gels, polyacrylamide plugs, tablets, mesoporous materials, polymer tubes, or any combination thereof.

25. The method according to clause 1 wherein the formulation is formulated into a sprayable, solid, semi-solid, liquid form, thermal fogging, or nebulization form.

26. The method according to clause 1 wherein the formulation is a controlled released system, or is diffused, or is released actively or passively.

27. The method according to clause 1 wherein the formulation is distributed in agricultural applications within a total area, perimeter, border, specific rows, lines, or any combination thereof.

28. The method according to clause 27 wherein the formulation is applied manually, mechanically, or electronically in agricultural applications directly or indirectly on crops.

29. The method according to clause 1 wherein the formulation is applied or distributed in forestry applications within the total area, perimeter, border, single trees, groups of trees, or any combination thereof.

30. The method according to clause 29 wherein the formulation is applied manually, mechanically, or electronically in forestry applications directly or indirectly on trees.

31. The method according to clause 1 wherein the formulation is distributed in storage area applications within the total area, perimeter, border, internal areas, external areas, or any combination thereof.

32. The method according to clause 31 wherein the formulation is applied manually, mechanically, or electronically, directly or indirectly on storage areas.

33. The method according to clause 1 wherein the formulation is distributed in urban area applications within the total area, perimeter, border, internal areas, external areas, homes, buildings, residences, streets, parks, public spaces, or any combination thereof.

34. The method according to clause 33 wherein the formulation applied manually, mechanically or electronically, directly or indirectly on urban areas.

35. The method according to clause 1 wherein the formulation is a synergistic formulation.

36. The method according to clause 35 wherein the synergistic formulation produces, when the pests are exposed to the synergistic formulation, a combined repellency effect greater than the sum of the separate repellency effects from the separate compounds of structure (A) at comparable concentrations.

37. The method according to clause 1 the one or more compounds of structure (A) are present in an amount from about 100 kilograms per hectare or less, or about 500 grams per hectare or less, or about 100 grams per hectare or less, about 1 gram per hectare or less, or about 0.1 grams per hectare or less.

38. The method according to clause 1 further comprising applying said formulation to loci where agave, alfalfa, almonds, anise, apples, apricots, artichokes, asparagus, avocados, bananas, barley, basil, bay leaves, beans, beets, bell peppers, berries, blackberries, blueberries, broccoli, Brussels sprouts, buckwheat, cabbage, canola, carrots, cashews, cassava, cauliflower, celery, cherries, chestnuts, chickpeas, cocoa, coconut, coffee, corn, coriander, cotton, cranberry, crucifers, cucumbers, dates, eggplant, flowers, fennel, figs, flax, grapes, guava, hazelnuts, hemp, hop, fodder species including rye grass, Sudan grass, tall fescue, Kentucky blue grass, and clover; fruits, garlic, grapefruit, kale, kiwi, leek, lentils, lettuce, limes, lemons, loquats, lychee. macadamia, mango, melons, millet, mint, mulberry, mustard, nectarines, nuts, oats, oil seed crops, okra, olives, onions, oranges, oregano, papaya, parsley, parsnip, passion fruit, peaches, peanuts, peas, pears, peppers, persimmons, pineapples, pistachios, plums, pomegranate, potatoes, pumpkins, quinoa, rapeseed, raspberries, rice, rosemary, rye, saffron, sage, shallots, sesame, star fruit, sorghum, soybeans, spinach, strawberries, sugarcane, sugar beets, sunflowers, sweet potatoes, tea, tobacco, tomatoes, thyme, vanilla, walnuts, watermelon, wheat or yerba mate is growing, or the seeds thereof are going to be planted.

39. The method according to clause 1 further comprising applying said formulation to loci where Angelica tree, American elm, Ashe juniper, Balsam fir, Blackwood, Cedar, Chestnut Oak, Douglas-fir, Eastern White pine, Engelman spruce, Eucalyptus, Firs, Gambel oak, Hemlocks, Hickory, Ipe, Jack pine, Juniper, Loblolly pine, Longleaf pine, Mahogany, Oaks, Peroba, Pines, Pinus, Ponderosa pine, Red maple, Redwood, Rubber tree, Shortleaf pine, Spruce, Sugar maple Sugar pine, Wattles, Western hemlock, Western Larch, Western white pine, or White Oak is growing, or the seeds thereof are going to be planted

40. The method according to clause 1 wherein the one or more pests are selected from the group consisting of pests from Phylum Arthropoda, or from Subphylum Hexapoda, or from Subphylum Chelicerata, or from Class Insecta, or from Class Arachnida.

While we have shown and described several embodiments in accordance with our disclosure, it is to be clearly understood that the same may be susceptible to numerous changes apparent to one skilled in the art. Therefore, we do not wish to be limited to the details shown and described but intend to show all changes and modifications that come within the scope of the appended claims.

### EXAMPLES

### Example 1

### Electroantenography (EAG)

Electroantenography (EAG) analysis was performed using adult males and females of Spodoptera frugiperda (FAW—fall armyworm) using the “Puff” electroantennographic technique. The antennae of the adults were excised and carefully attached to an electrode with the aid of conductive gel (Signa gel, Parker Labs, USA). After mounting the antenna, the electrode was introduced into a glass tube with humidified and continuous airflow (0.3 ml/min) which conducted the tested analytes.

For the tests, 10 μl aliquot of standard solutions of each test compound were applied to strips of filter paper (2.0 cm×1.0 cm), with the solvent being allowed to evaporate for 60 s before the strip was placed into the cartridge, then inserted in a disposable Pasteur pipette cartridge. It was then connected to the pulse generator system (“Puff”) (Stimulus Controller, Type CS-55, Syntech). Considering that the samples were diluted to a concentration of 100 ng/μL when was added 10 μL of this solution, each tested antenna received a total of 1000 ng of a compound.

Following the protocol described in Syntech (2015), three types of control were performed before testing the candidate compounds: a) Clean Pasteur pipette, used to check the presence of contamination; b) Pasteur pipette+filter paper, to test contamination on the filter paper; c) Pasteur pipette+filter paper+n-hexane, used to check for contamination in it, as well as to identify and eliminate mechanical responses from the antenna. Thus, the response to a compound was only considered when it presents antenna depolarization with an area significantly larger than the response area observed in the test with the solvent. Additionally, as the running minutes pass, the antenna tends to lose sensitivity, so to monitor and correct this decline, a reference stimulus was used at regular intervals throughout the test period (Syntech, 2015).

The maximum antenna depolarization data for each extract were first corrected by the area of their respective controls, thus eliminating any effect of mechanical response on the antennas. The normality and homogeneity of the data were analyzed using the Shapiro-Wilk and Bartlett tests, respectively. Comparisons were performed using Student's t-test or the Wilcoxon rank sum test when the normality assumption was invalid.

Compound 3-methyl-5-ethyl-2-cyclohexen-1-one elicited statistically significant electrophysiological response amplitude for male and female S. frugiperda antennae when compared to the control (hexanes).

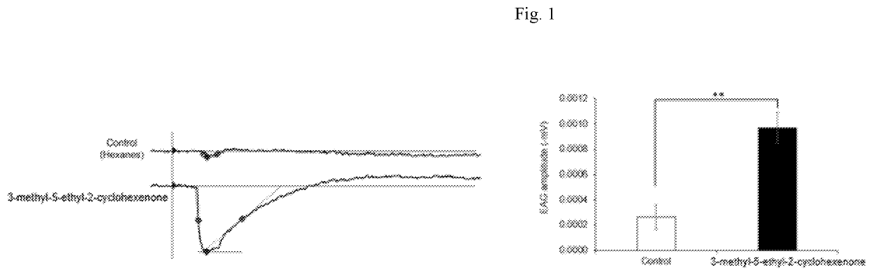

FIG. 1 shows results of electrophysiological responses (−mV±SE) of Spodoptera frugiperda (FAW—fall armyworm) male antennae to Control (hexanes) and 3-methyl-5-ethyl-2-cyclohexen-1-one. Asterisks indicate differences (P<0.01).

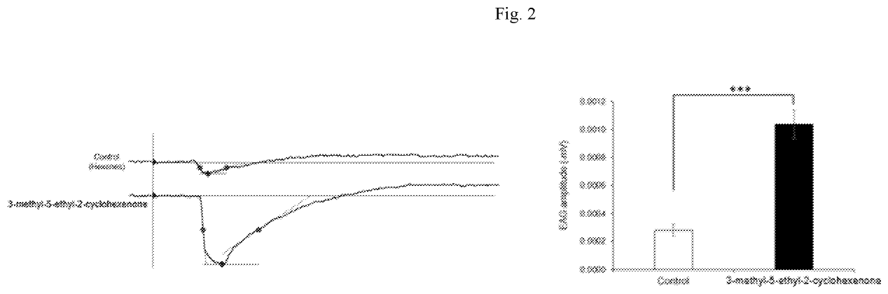

FIG. 2 shows results of electrophysiological responses (−mV±SE) of Spodoptera frugiperda (FAW—fall armyworm) female antennae to Control (hexanes) and 3-methyl-5-ethyl-2-cyclohexen-1-one. Asterisks indicate differences (P<0.001).

### Example 2

### Wind Tunnel Bioassay

Bioassays with S. frugiperda adults were conducted in a wind tunnel [170 cm long×55 cm wide×30 cm high, airflow 0.3 m/s, under red light (0.3 lux), at 26° C. in a darkroom. Treatments were applied on filter paper strips (1.5 cm long and 0.5 cm wide) (Whatman no. 1), placed on acrylic support 15 cm above the wind tunnel floor and 15 cm from the upwind end of the tunnel. Males were acclimatized to room conditions 1 h before the tests, were released individually, and kept for 10 min for evaluation. The behavioral monitored steps were: taking flight, moving antennae, zigzag flight, and landing on the odor source. For each treatment, from 20 to 32 replicates were carried out, and insects were used only once. The bioassays was performed from 4 to 6 hours (22-24 h) within scotophase for S. frugiperda. Bioassays with food attractants were carried out between 6-10 μm, the time of greatest attraction for insects in the field.

The behaviors observed in the wind tunnel were analyzed using a generalized linear model (GLM) with binomial distribution. For that, the data were compared separately by sex, and behavior. Significant differences between treatments were analyzed according to the confidence interval of means obtained by the model (binomial p<0.05).

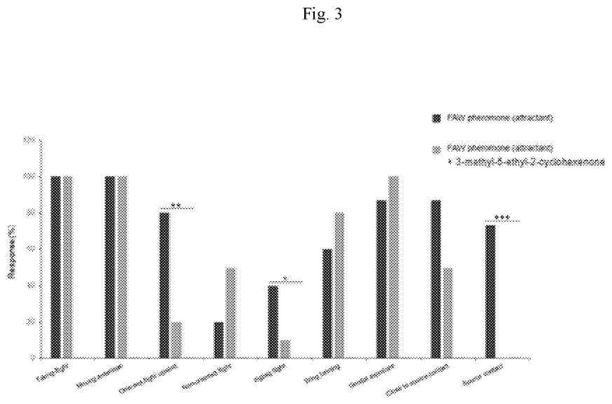

Evaluating the repellent effect of 3-methyl-5-ethyl-2-cyclohexen-1-one compound, when added to FAW pheromone blend (attractant) was observed a lower proportion of insects flying close to the odor source (FIG. 3, GLM: χ2 (34-32)=2.009, p=0.134)), and a significant reduction in the proportion of males that touched the source (repellency) (FIG. 3; GLM: χ2 (34-32)=10.552, p<0.001).

FIG. 3 graphically illustrates the percentage of S. frugiperda males that responded with predetermined behaviors to FAW pheromone blend (attractant) and FAW pheromone blend (attractant)+3-methyl-5-ethyl-2-cyclohexen-1-one in a wind tunnel test. Asterisks indicate significant differences between treatments (*p<0.05; **p<0.01; ***p<0.001).

### Example 3

### Oviposition Bioassay

Behavioral assays were performed using dual-choice and no-choice tests. In dual-choice bioassay, six newly emerged couples of S. frugiperda were released in cages (100×70×50 cm) covered with fabric voile containing 01 corn plant, as well as honey solution (10%) as a food source. The insects were kept in the cage for two days for acclimatization and mating before starting the bioassays. The bioassay started on the 3rd day after releasing the insects, the corn plant kept in the cage for insect acclimation was removed, and the treatments were added in opposite positions, 50 cm apart from each other. The test cages contained: 01 control plant, 01 treated plant, honey solution (10%), and six couples of three-day-old S. frugiperda. No-choice tests were performed using smaller cages (35×100 cm), but following the same procedure used in the free-choice assay. After the insect adaptation period, a control or treated plant was added to the center of each cage along with a container containing a honey solution as a food source.

For both assays, free-choice, and no-choice, after 24 hours the number of eggs in each plant was evaluated. Five replicates (cages) were performed for the dual-choice test and four per treatment in the no-choice tests. In both assays, the plants received 1 ml of the solution containing 15 mg of the compound 3-methyl-5-ethyl-2-cyclohexen-1-one prepared on Tween® 20 0.1%. Control plants received 1 mL of the Tween base solution to eliminate any repellent or attractive effect of it.

Data was analyzed using a generalized linear model (GLM) with quasi-poisson error distribution. All analyses were performed using the R software (www.R-project.org) version 2.8.1.

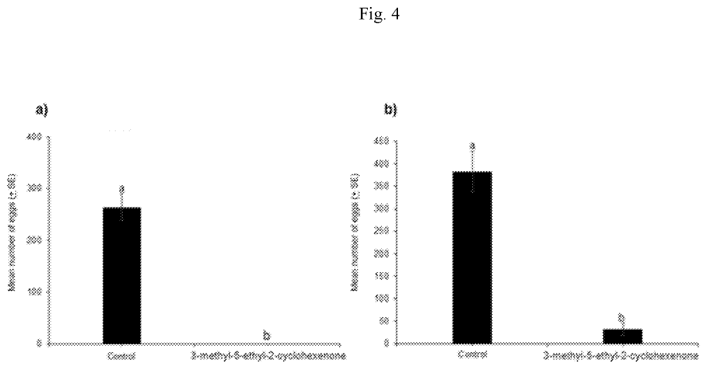

When plants were treated with 3-methyl-5-ethyl-2-cyclohexen-1-one in both tests, pregnant females of S. frugiperda oviposit significantly more eggs on control plants compared to treated plants: free-choice tests (FIG. 4a; GLM: F(7-6)-153, p<0.001); no-choice tests (FIG. 4b; GLM: F(11-10)=24.51, p<0.001).

FIG. 4 graphically illustrates the mean number of eggs laid by Spodoptera frugiperda pregnant females on control plants as compared to 3-methyl-5-ethyl-2-cyclohexen-1-one treated plants in free-choice tests (a) and in no-choice tests (b). Different letters indicate a significant difference between the treatments (p<0.001).

### Example 4

### Field Trap Shutdown

Trials were performed in several locations, evaluating different crops and pest species to evaluate field repellency efficacy using the trap shutdown method (capture reduction) when comparing traps containing an attraction source (pheromones and/or color visual stimuli) versus traps containing an attraction source (pheromones and/or color visual stimuli) plus a repellent. The type of traps used varied according the preferred style for each species (validated standard). At least 3 repetitions (traps) were evaluated for each treatment and traps were distributed across the field separated at least 25 m apart. The number of insects captured was evaluated at least for 24 h.

Traps containing an attractant source+3-methyl-5-ethyl-2-cyclohexen-1-one had significantly less captures than traps containing only an attractant source. The trap shutdown (capture reduction) was observed for different pest species, demonstrating disruption effect of pheromones and visual attractancy stimuli-mediated communications (repellency) at field conditions.

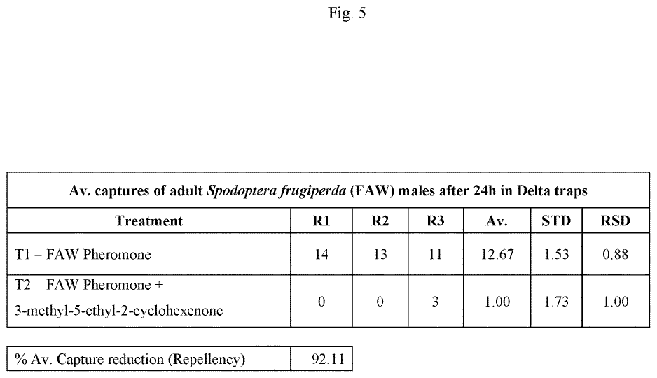

FIG. 5 shows results of Av. captures of adult Spodoptera frugiperda (FAW—fall armyworm) males after 24 h in Delta traps for T1: FAW pheromone as control (attractant) and T2: FAW pheromone (attractant) plus 3-methyl-5-ethyl-2-cyclohexen-1-one 30% in mineral oil (repellent). Trial performed in sorghum fields.

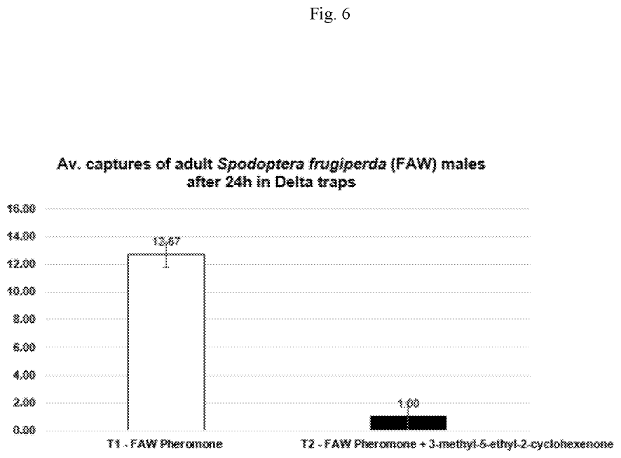

FIG. 6 graphically illustrates results of Av. captures of adult Spodoptera frugiperda (FAW—fall armyworm) males after 24 h in Delta traps for T1: FAW pheromone as control (attractant) and T2: FAW pheromone (attractant) plus 3-methyl-5-ethyl-2-cyclohexen-1-one, 30% in mineral oil (repellent). Trial performed in sorghum fields.

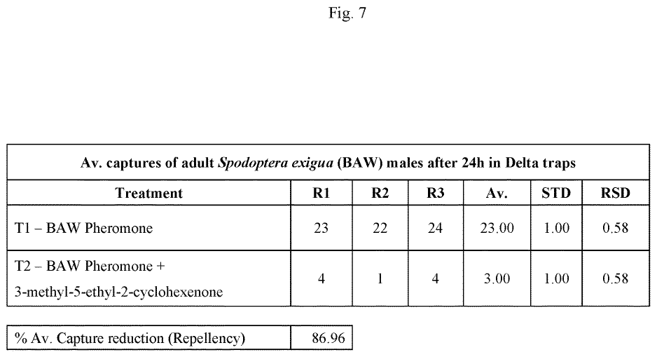

FIG. 7 shows results of Av. captures of adult Spodoptera exigua (BAW-beet armyworm) males after 24 h in Delta traps for T1: BAW pheromone as control (attractant) and T2: BAW pheromone (attractant) plus 3-methyl-5-ethyl-2-cyclohexen-1-one, 30% in mineral oil (repellent). Trial performed in chili pepper fields.

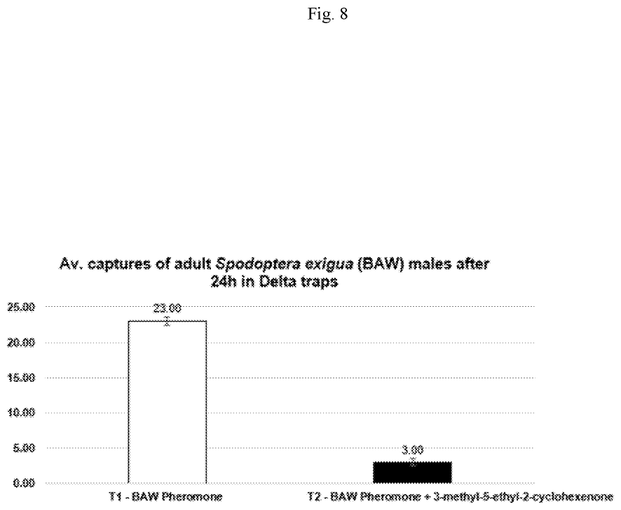

FIG. 8 graphically illustrates results of Av. Captures of adult Spodoptera exigua (BAW-beet armyworm) males after 24 h in Delta traps for T1: BAW pheromone as control (attractant) and T2: BAW pheromone (attractant) plus 3-methyl-5-ethyl-2-cyclohexen-1-one, 30% in mineral oil (repellent). Trial performed in chili pepper fields.

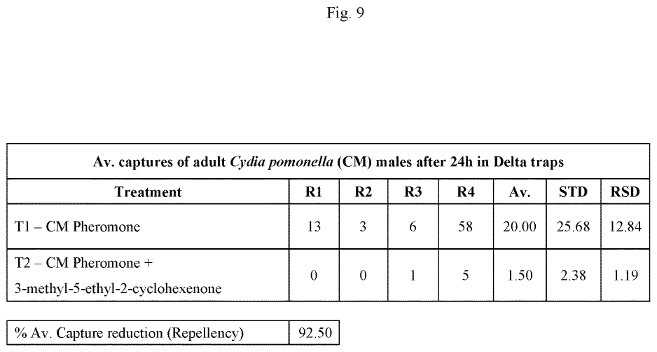

FIG. 9 shows results of Av. captures of adult Cydia pomonella (CM—codling moth) males after 24 h in Delta traps for T1: CM pheromone as control (attractant) and T2: CM pheromone (attractant) plus 3-methyl-5-ethyl-2-cyclohexen-1-one, 30% in mineral oil (repellent). Trial performed in pear orchards.

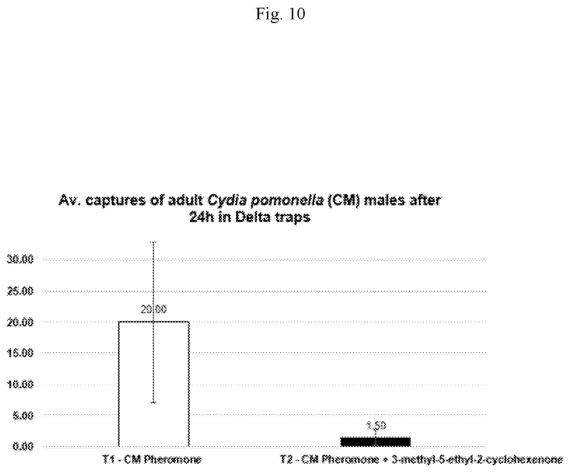

FIG. 10 graphically illustrates results of Av. Captures of adult Cydia pomonella (CM—codling moth males after 24 h in Delta traps for T1: CM pheromone as control (attractant) and T2: CM pheromone (attractant) plus 3-methyl-5-ethyl-2-cyclohexen-1-one 30% in mineral oil (repellent). Trial performed in chili pear orchards.

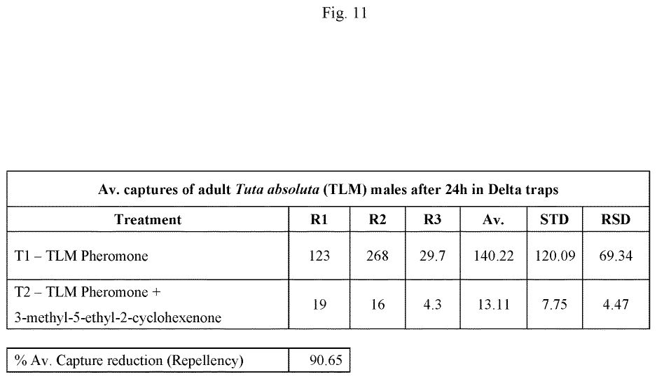

FIG. 11 shows results of Av. captures of adult Tuta absoluta (TLM—tomato leafminer) males after 24 h in Delta traps for T1: TLM pheromone as control (attractant) and T2: TLM pheromone (attractant) plus 3-methyl-5-ethyl-2-cyclohexen-1-one 30% in mineral oil (repellent). Trial performed in open tomato fields.

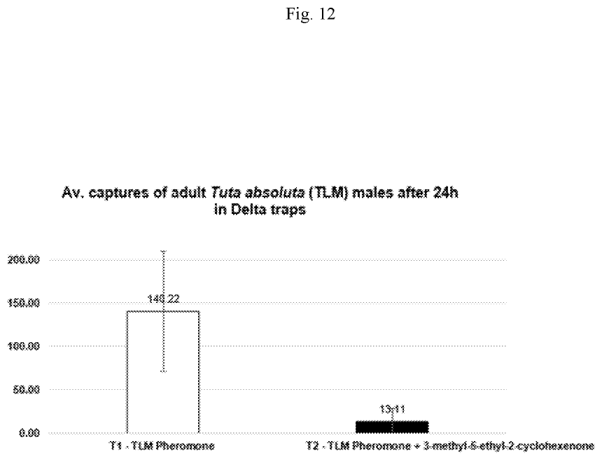

FIG. 12 graphically illustrates results of Av. captures of adult Tuta absoluta (TLM—tomato leafminer) males after 24 h in Delta traps for T1: TLM pheromone as control (attractant) and T2: TLM pheromone (attractant) plus 3-methyl-5-ethyl-2-cyclohexen-1-one, 30% in mineral oil (repellent). Trial performed in open tomato fields.

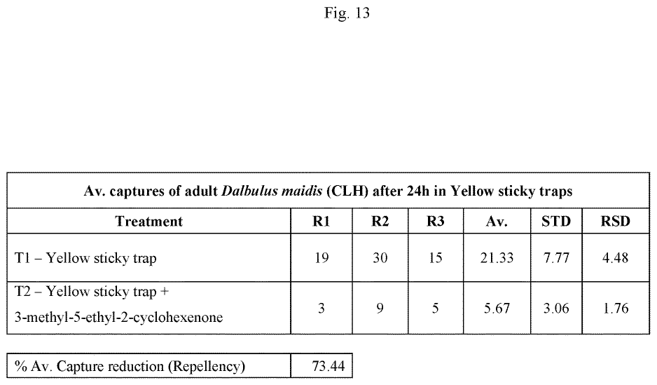

FIG. 13 shows results of Av. captures of adult Dalbulus maidis (CLH—corn leafhopper) after 24 h in Yellow sticky traps for T1: Yellow color sticky trap as control (attractant) and T2: Yellow color sticky trap (attractant) plus 3-methyl-5-ethyl-2-cyclohexen-1-one, 30% in mineral oil (repellent). Trial performed in maize fields.

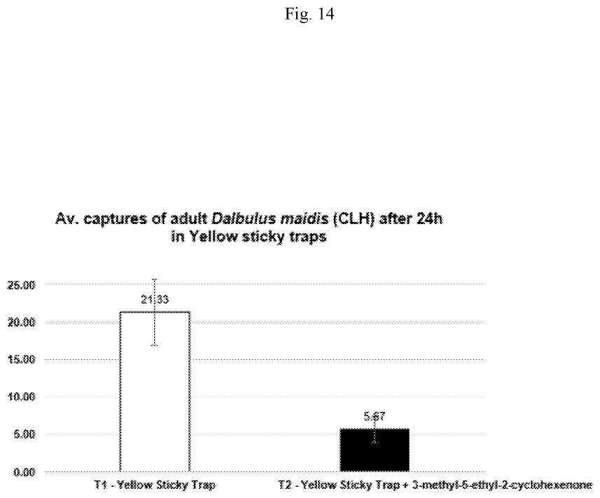

FIG. 14 graphically illustrates results of Av. captures of adult Dalbulus maidis (CLH—corn leafhopper) after 24 h in Yellow sticky traps for T1: Yellow color sticky trap as control (attractant) and T2: Yellow color sticky trap (attractant) plus 3-methyl-5-ethyl-2-cyclohexen-1-one 30% in mineral oil (repellent). Trial performed in maize fields.

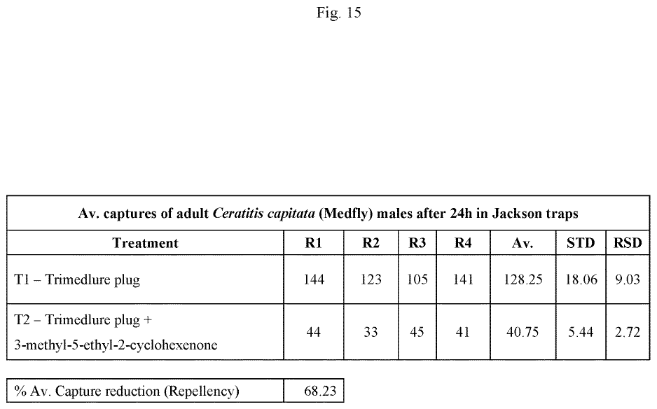

FIG. 15 graphically shows results of Av. captures of adult Ceratitis capitata (Medfly—mediterranean fruit fly) after 24 h in Jackson traps for T1: Trimedlure plug as control (attractant) and T2: Trimedlure plug (attractant) plus 3-methyl-5-ethyl-2-cyclohexen-1-one, 30% in mineral oil (repellent). Trial performed in coffee fields.

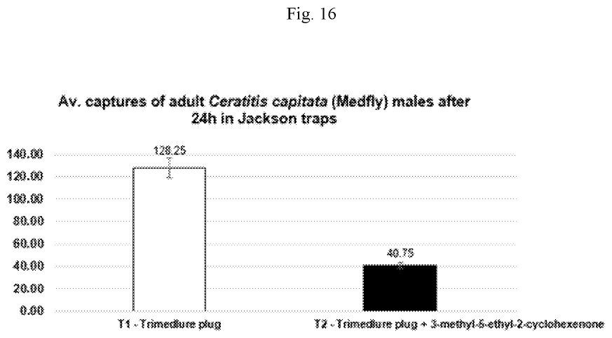

FIG. 16 graphically illustrates shows results of Av. captures of adult Ceratitis capitata (Medfly—mediterranean fruit fly) after 24 h in Jackson traps for T1: Trimedlure plug as control (attractant) and T2: Trimedlure plug (attractant) plus 3-methyl-5-ethyl-2-cyclohexen-1-one 30% in mineral oil (repellent). Trial performed in coffee fields.

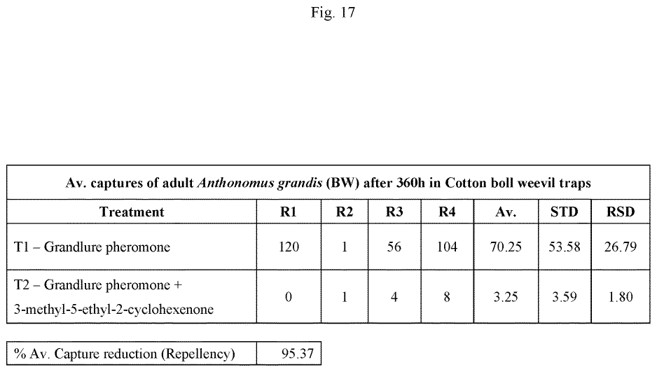

FIG. 17 shows results of Av. captures of adult Anthonomus grandis (CBW—cotton boll weevil) after 360 h in Cotton boll weevil traps for T1: Grandlure pheromone as control (attractant) and T2: Grandlure pheromone (attractant) plus 3-methyl-5-ethyl-2-cyclohexen-1-one, 30% in mineral oil (repellent). Trial performed in cotton fields.

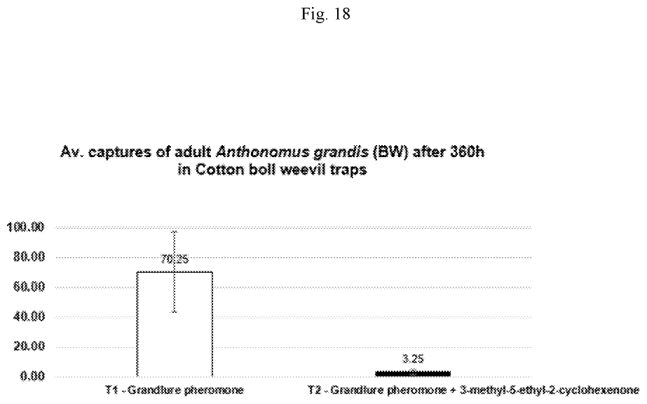

FIG. 18 graphically illustrates shows results of Av. captures of adult Anthonomus grandis (CBW—cotton boll weevil) after 360 h in Cotton boll weevil traps for T1: Grandlure pheromone as control (attractant) and T2: Grandlure pheromone (attractant) plus 3-methyl-5-ethyl-2-cyclohexen-1-one, 30% in mineral oil (repellent). Trial performed in cotton fields.

### Example 5

Repellency Bioassay—One-Choice Test in Arenas Against Bed Bugs (Cimex lectularius)

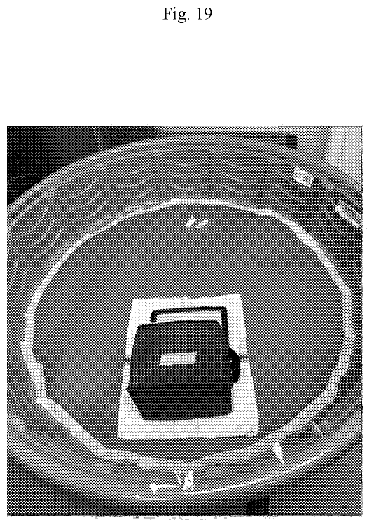

One-choice bioassays to verify the repellency effect of some compounds by disrupting intraspecific communication associated with attraction behavior promoted by host odors (kairomones) and/or substrates and textures (harborage/shelter), using adult males and females of Cimex lectularius (common bed bug) of Harold Harlan strain (insecticide susceptible lab population) were performed. Experimental arenas consisted of brand-new wading pools (114.3×20.1 cm, Polygroup Services N.A., Inc., El paso, TX). The bottom of each pool was lined with builder's paper (Pratt Industries, Inc., Conyers, GA) for bed bugs to have traction. The paper was sealed to the pool surface using silicone (Advance Silicone 2® Kitchen & Bath Sealant, Clear, GE, Rocky Hill, CT) to prevent bugs from getting underneath the contractor's paper, and to keep them on the surface of the experimental arena. Cotton dish towels (38.1×63.5 cm) were impregnated with compounds prior the start of the tests, being used as “treated surfaces” and allowed to age 0, 14 and 21 days in indoor environment conditions (room temperature). After the aging period, towels were kept in sealed mylar bags until the moment of the tests. Towels were removed from mylar bags, folded in half and placed in the arena randomly along the perimeter, then brand new and untreated lunch bags (20.3×15.2×15.2 cm, ePromos Promotional Products, St. Cloud, MN) were fully opened and placed on top of the towel, with a sock that was previously placed inside (Fruit of the Loom, inc., Bowling Green, KY). The socks were previously conditioned for approximately 8 hours, by the same individual to reduce variability. Lunch bag was mimicking the effect of a harborage/shelter to the insects and the worn socks contained some level of natural skin volatiles that act as attractant stimulus to bed bugs (kairomones). The positioning of the towel plus lunch bag in each arena was random. (FIG. 19).

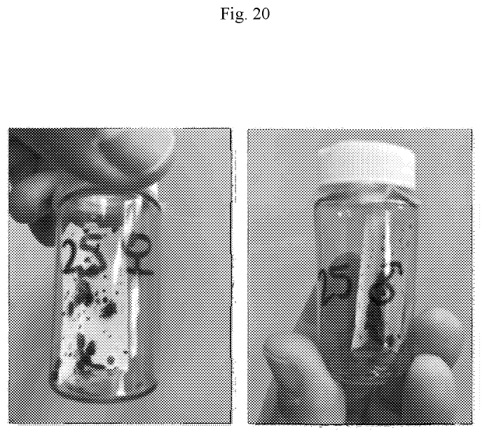

Treatments consisted of only ethanol (as negative control), DEET 5% (as positive control) and BRI Blend 5% (mixture of methyl 2 (-3-oxo-2-pentylcyclopentyl)acetate, delta-dodecalactone, 3-methyl-5-ethyl-2-cyclohexenone, gamma methyl dodecalactone, tetrahydromethyl apritone, geranyl cyclopentanone (apritone, cyclopentanone, 2-(3,7-dimethyl-2,6-octadienyl)-), 3-methyl-5-(z-3-hexenyl)-2-cyclohexenone, methyl apritol, gamma-tridecalactone, N,N-diethyl-2-(3-oxo-2-pentylcyclopentyl) acetamide, prenyl dihydro jasmonate, gamma-dodecalactone, farnesylcyclopentanone, 3-methyl-5-hexyl-2-cyclohexenol, methyl 2-(3,3-dimethoxy-2-penthylcyclopentyl)acetate and methyl jasmonate). Fifty bed bugs (25 males and 25 females) were placed in clear glass vials (FIG. 20) and then turned upside down in the center of the arenas and allowed to move freely about in the arenas. The bed bugs could choose to find harborage under the towels, in the lunch bags, in the socks or remain in the open (arena) with no harborage, which is contrary to their natural behavior, evidencing a sign of repellency effect. Each experimental unit (replicate) was repeated four times per each treatment, totalizing 200 bed bugs used per treatment. After 24 hours, bed bugs in the test arena were removed, and bed bugs that were in the arena were placed in sealed plastic bags and frozen to be evaluated and recorded later.

FIG. 19 shows experimental arena set up: wading pool containing an impregnated cotton towel as treated surfaces and lunch bags containing a previous worn sock (exposed to skin odor volatiles) acting as attractant stimulus.

FIG. 20 shows glass vials containing 25 males and 25 females, totalizing 50 bed bugs used per repetition.

### Results:

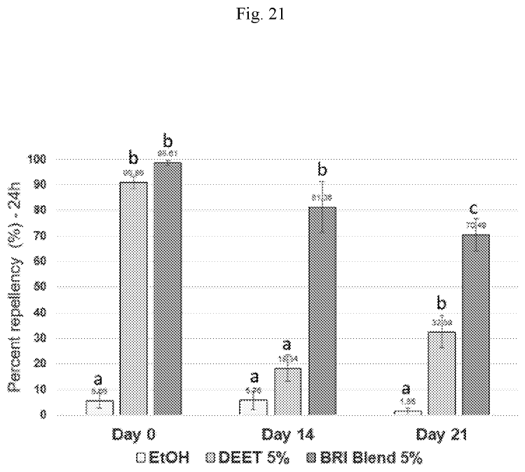

A one-way ANOVA statistical analysis was performed (SPSS, version 28.0.0.0 (190); IBM, Armonk, NY) to observe the effects of the potential repellency of different compounds tested against bed bugs. For general reference Day 0, Day 14 and Day 21 were plotted together and Tukey's HSD test was performed to assess differences between treatments and aging times (FIG. 21).

### Day 0:

Day 0 showed significant differences between groups (one-way ANOVA; F_{2,9}=59.082, p<0.001). Ethanol (EtOH) was different than both treatment groups (p<0.001) with an average repellency effect of 5.66%. DEET 5% and BRI Blend 5% did not differ from each other (p=0.089) with 90.86% and 98.61% average repellency effect respectively.

### Day 14:

Day 14 aged treated towels showed significant differences among groups (one-way ANOVA; F_{2,9}=57.502, p<0.001). Ethanol (EtOH) was different than BRI Blend 5% with 5.76% and 81.36% average repellency effect respectively, but did not differ from DEET 5% which had 18.34% average repellency effect (p<0.180).

### Day 21:

Day 21 aged treated towels also showed significant differences among groups (one-way ANOVA; F_{2,9}=44.373, p<0.001). Ethanol (EtOH) had an average percent repellency effect of 1.55%, DEET 5% had 32.59% and BRI Blend 5% had 70.49%.

Overall, BRI Blend 5% showed satisfactory repellency effect from Day 0 to Day 21 significantly differing from Ethanol (EtOH, negative control) at each time point and different from DEET 5% (positive control) on Day 14 and 21.

DEET 5% (positive control) appeared to lose repellency properties after 14 days, as there was an increase in bed bugs recovered on both Day 14 and Day 21, compared to the lower numbers recovered from Day 0 lunch bag+towel (reduction in the repellency effect).

BRI Blend 5% repellency effect was effective enough to disrupt intraspecific communication associated with attraction behavior promoted by host skin odors (kairomones) and/or substrates and textures (harborage/shelter).

FIG. 21 illustrates the results of Example 5. FIG. 21 is a bar graph illustrating the mean percent repellency after 24 h against Cimex lectularius for towels treated with ethanol (EtOH), DEET 5% and BRI Blend 5% aged for 0, 14 and 21 days. Means followed by the same letter do not differ by the Tukey HSD test (p≤0.05). Error bars represent the standard error of the mean.

### Example 6

Repellency Bioassay—Free-Moving Behavior Video Tracking Against Bed Bugs (Cimex lectularius)

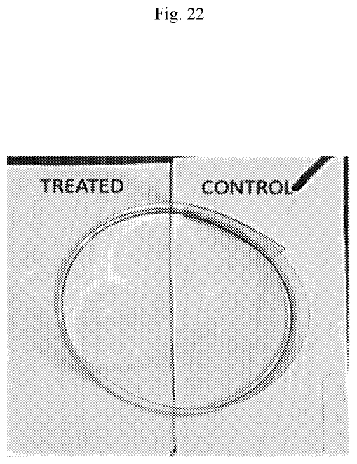

Free moving bioassays were performed to verify the repellency effect of some compounds, using adult males and females of Cimex lectularius (common bed bug) of FMR strain (pyrethroid resistant population) were performed. Experimental units consisted of open-top plastic arenas, divided into two equal halves (FIG. 22). The bottom of the plastic areas (substrate) consisted of cotton dish towels (38.1×63.5 cm). Those cotton dish towels were impregnated with compounds prior the start of the tests, being used as “treated surfaces” and allowed to age 0, 14 and 21 days in indoor environment conditions (room temperature). After the aging period, towels were kept in sealed mylar bags until the moment of the tests. Each arena was constructed by affixing two 7.5 cm×3.75 cm rectangles to a 7.5 cm×7.5 cm plywood squares using Gorilla Heavy-Duty Spray Adhesive (Gorilla Glue Company, Cincinnati, OH). One of these rectangles was treated with Ethanol (EtOH) only, while the other received BRI Blend 5% (mixture of methyl 2 (-3-oxo-2-pentylcyclopentyl)acetate, delta-dodecalactone, 3-methyl-5-ethyl-2-cyclohexenone, gamma methyl dodecalactone, tetrahydromethyl apritone, geranyl cyclopentanone (apritone, cyclopentanone,2-(3,7-dimethyl-2,6-octadienyl)-), 3-methyl-5-(z-3-hexenyl)-2-cyclohexenone, methyl apritol, gamma-tridecalactone, N,N-diethyl-2-(3-oxo-2-pentylcyclopentyl) acetamide, prenyl dihydro jasmonate, gamma-dodecalactone, farnesylcyclopentanone, 3-methyl-5-hexyl-2-cyclohexenol, methyl 2-(3,3-dimethoxy-2-penthylcyclopentyl)acetate and methyl jasmonate), and applications were done prior to cutting the substrate. The pieces of substrate were placed parallel to each other on the plywood squares to create an interface between treated and untreated areas.

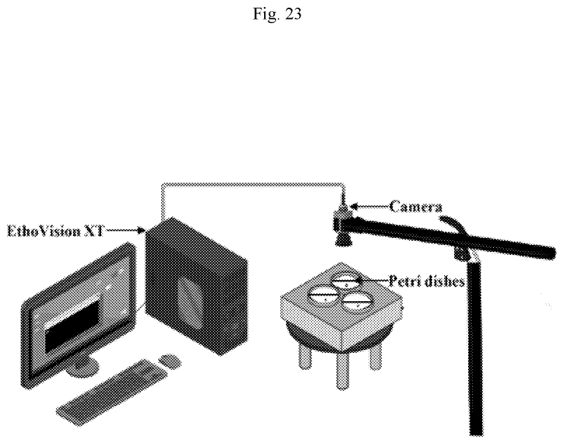

After the substrates were glued to the plywood, a plastic circular ring (1.3 cm×17.8 cm, 5 cm diameter, Apollo Write-On Transparency Film; ACCO Brands, Lincolnshire, IL) was cut and adhered to the intersection of the two substrates, with equal area on both sides of the ring, using hot glue (Chenille Kraft Glue Sticks, Pacon Corporation, Appleton, WI). Vaseline was applied to top edge of each ring to prevent beg bug escape. After constructing the arenas (FIG. 23), either a single adult male or female bed bug was placed into the center of the untreated side of each arena and kept contained under 20 mL plastic vials (DWK life Sciences, Wertheim, Germany) for five minutes of acclimation period.

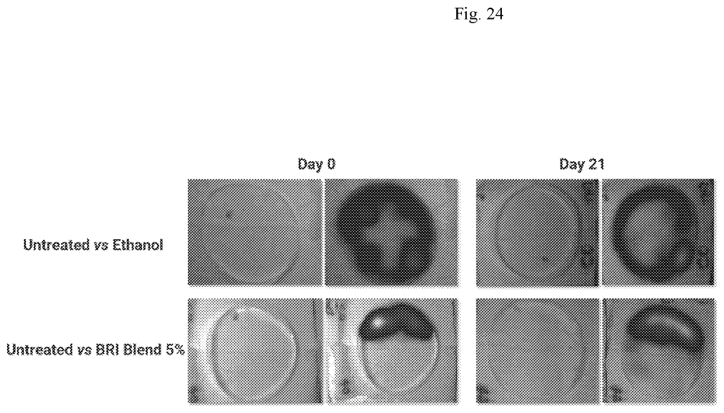

Bed bugs were then released and gently agitated using a pair of forceps to ensure movement before recording was initiated. Video footage was captured using a high-resolution GigE camera (Basler acA 1300-60 gc) with manual iris and focus lens (4.5-12.5 mm, 0.5 in manual iris) and fitted with IR pass filter (Heliopan Infrarot 850). One IR illuminator light (model: CM-IR110; CMVision, Houston, TX) was placed next to the camera. Recordings were stopped after 15 minutes and were taken using Noldus Media Recorder version 5 software (Noldus Information Technologies, Wageningen, Netherlands). Bed bug recordings were tracked and analyzed using EthoVision XT version 15 (Noldus) to determine the amount of time spent in the untreated and treated portions of the arena (FIG. 24). The differencing detection method was used to analyze data. For each treatment/sex combination, 5 replicates were done. Data was removed from bugs that either escaped from arenas or did not move for more than 60 seconds.

FIG. 22 shows free-movement behavioral arena (control/untreated) fabric on top versus treated (EtOH or BRI Blend 5%) at the bottom.

FIG. 23 shows scheme of free movement behavioral arenas coupled to high-resolution GigE camera and analyzed by Ethovison XT, to verify repellency effect of Cimex lectularius. (Adapted from: Gao, Y.; et. al., 2024).

FIG. 24 shows the results of Example 6. FIG. 24 shows bed bug movement heat-map created by Etho Vision XT, (blue color). Untreated vs Ethanol, heat map shows no preference for one of the halves, evidencing no repellency effect for Day 0 and Day 21. For Untreated vs BRI Blend 5% heat map clearly shows bed bug preference for one of the halves (untreated), evidencing significant repellency effect for Day 0 and Day 21.

### Results:

Time spent in the treated zone was compared among all groups at each aging time using analysis of variance (ANOVA), followed by Tukey's pairwise comparison.

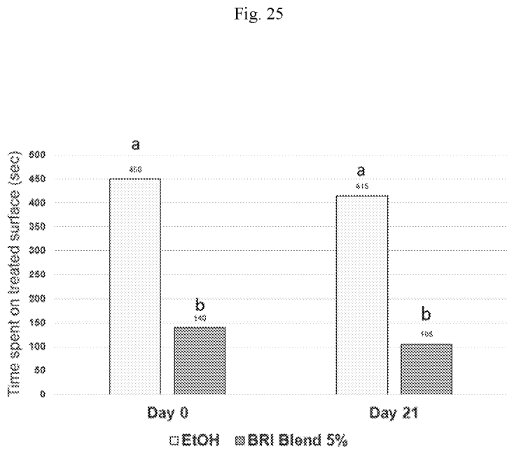

Time spent in the treated zone was significant different among treatment groups at all product aging times (0d: F_{2,27}=28.6, P<0.001); 21d: F_{2,27}=10.3, p<0.001). On both evaluation times (Day 0 and Day 21), bed bugs spent significantly less time in the zones treated with BRI blend 5% when compared to treatment of Ethanol (EtOH) only (FIG. 25).

FIG. 25 shows the results from Example 6. FIG. 25 shows a bar graph illustrating time spent in the treated zone for fabric treated with Ethanol (EtOH) and BRI Blend 5% at Day 0 and Day 21. Means followed by the same letter do not differ by the Tukey HSD test (p≤0.001).

### Example 7

Repellency Bioassay—Simulated Bedroom Environment Against Bed Bugs (Cimex lectularius)

Bioassays to verify the repellency effect of some compounds by disrupting intraspecific communication associated with attraction promoted by human host odors like CO₂, skin volatiles (kairomones) and body temperature, using adult males and females of Cimex lectularius (common bed bug) of Harold Harlan strain (insecticide susceptible lab population) within a simulated bedroom environment were performed. The repellency efficacy of test substances (fresh—day 0 and after 30 days) was evaluated by comparing bed bug feeding success on treatment nights against feeding success on control nights, where only ethanol (EtOH) was applied. In addition, an infrared-sensitive time-lapse camera was used to monitor bed bug activity.

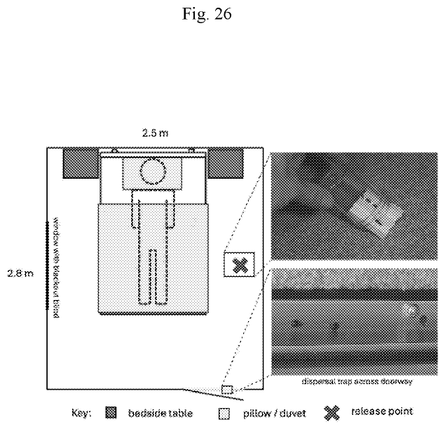

An aluminum channel was fitted across the doorway to trap any bugs that attempted to disperse from the room (FIG. 26). The vertical face of the channel, inside the room, was covered with black masking tape to allow bed bugs to climb up. The inside of the channel was clean and smooth, making it impossible for them to climb out. The dispersal trap made it possible to determine the impact of the treatment on dispersal.

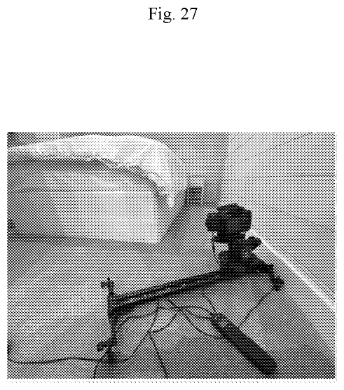

The room was maintained at 20±1° C. by a thermostatically controlled electric fan heater. Humidity in the room was monitored but not controlled. Ambient humidity throughout the trial ranged from 50-60% RH during the days and nights where the room was unoccupied, and reached a peak of 75% RH during the nights when the investigator was sleeping in the bed. An infrared-sensitive camera controlled with an intervalometer (FIG. 27) was used to monitor bed bug activity throughout the night. The room was illuminated with an infrared floodlight. The camera was set to take photographs every 5 seconds. Focus stacking software (Zerene Stacker, Version. 1.04) was used to combine the resulting set of images into a single image, showing bed bug activity throughout the night.

The BRI Blend (mixture of methyl 2 (-3-oxo-2-pentylcyclopentyl)acetate, delta-dodecalactone, 3-methyl-5-ethyl-2-cyclohexenone, gamma methyl dodecalactone, tetrahydromethyl apritone, geranyl cyclopentanone (apritone, cyclopentanone,2-(3,7-dimethyl-2,6-octadienyl)-), 3-methyl-5-(z-3-hexenyl)-2-cyclohexenone, methyl apritol, gamma-tridecalactone, N,N-diethyl-2-(3-oxo-2-pentylcyclopentyl) acetamide, prenyl dihydro jasmonate, gamma-dodecalactone, farnesylcyclopentanone, 3-methyl-5-hexyl-2-cyclohexenol, methyl 2-(3,3-dimethoxy-2-penthylcyclopentyl)acetate and methyl jasmonate) was diluted to 2.5 and 5% in ethanol and decanted into a handheld trigger spray. The treatment was applied to all vertical sides of the bed base. The bed base measured 190×120×30 cm, making a total treatment area of 1.86 m². The total volume required to achieve full coverage was 50 mL, so the application rate was 26.9 ml/m². All treatments were applied at 20° C. and c. 50% RH. After the treatment was applied the room was aired out for 2 hours with the window and door open to allow the ethanol to evaporate fully. The encasements covering the bed base were replaced between replicates to remove any residual repellent from previous nights.

Adult bed bugs (Cimex lectularius) were selected from cultures maintained at CimexStore Ltd, Wye Valley, Gloucestershire, UK. The cultures are maintained at 26° C. and fed weekly on human volunteers. One hour before the start of the trial, a cohort of 50 unfed adult bed bugs were placed on the floor of the test environment (marked ‘X’ in in FIG. 26), confined under an upturned 60 mL plastic pot, and allowed to settle. At approximately 23:00, the time-lapse camera was started, the pot covering the bed bugs was removed and the investigator climbed into bed. In the morning, the camera was stopped, and the room was carefully searched for bed bugs. The recovered bugs were assessed for feeding status. For the 30-day aged assessments, the treated encasements were removed from the bed bases and hung on washing lines in a ventilated storage area.

### Results:

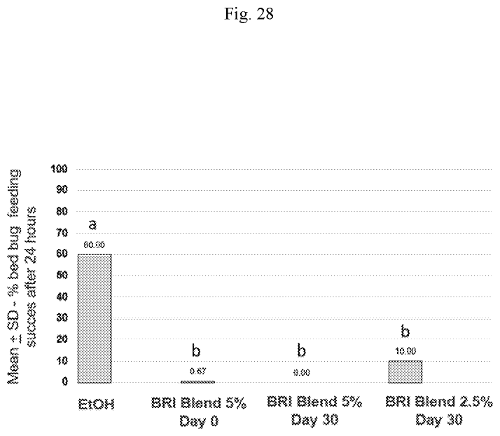

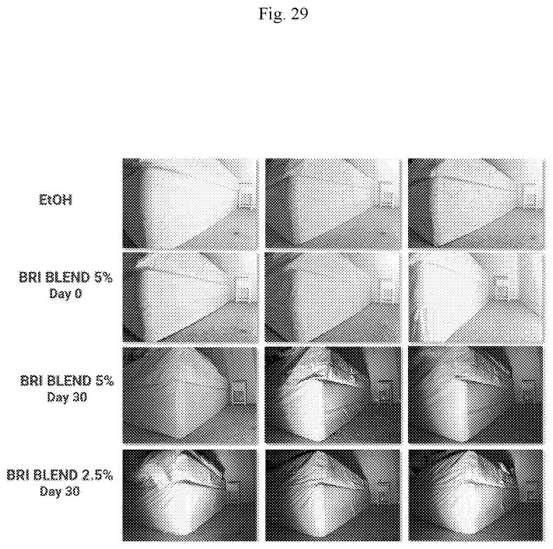

The results are summarized on the FIG. 28 bar chart. On the control nights (EtOH), where no repellent was applied, 60±5.3% of bed bugs fed successfully. On the nights when BRI Blend 5% Day 0 was applied to the bed base, only a single bug (0.67±1.2%) successfully fed across all three replicates. The difference in bed bug activity on the bed was clearly visible in the focus-stacked images (FIG. 29). There was little or no activity on the bed bases where fresh deposits of BRI Blend 5% Day 0 had been applied, compared to considerable bed bug activity on the control nights where only ethanol (EtOH) had been applied.

Encasements treated with BRI Blend 5% were still fully repellent after one month, successfully deterring 100% of bedbugs from feeding. Encasements treated with BRI Blend 2.5% and aged for 1 month were only partially repellent (even though there were not significant statistical differences when compared with 5% Day 0 and 5% Day 30). In this group mean feeding success was 10±8.7%.

Applications of BRI Blend 5% diluted in ethanol were highly effective at deterring hungry bed bugs from feeding. On the control nights, where only ethanol (EtOH) was applied to the bed base, 60% of the bed bugs fed, while on the treatment nights, BRI Blend 5% was applied to the bed base, only a single bug fed in one of six replicates. Treated encasements were still fully effective after one month of storage. BRI Blend 5% repellency effect was effective enough to disrupt intraspecific communication associated with attraction behavior promoted by human host odors like body temperature; CO₂, and skin volatiles (kairomones).

FIG. 26 shows scheme of test bedroom with release point of bed bugs and dispersal trap across doorway.

FIG. 27 shows location of infrared-sensitive time-lapse camera.

FIG. 28 shows the results from Example 7. FIG. 28 shows a bar graph illustrating mean±SD % feeding success of bed bugs in rooms where bed was treated with Ethanol (EtOH), BRI Blend 5% at Day 0 and Day 30 and BRI Blend 2.5% at Day 30. Means followed by the same letter do not differ by the Tukey HSD test (p≤0.001).

FIG. 29 shows bed bug activity in the treated zone for fabric treated with Ethanol (EtOH), BRI Blend 5% at Day 0, BRI Blend 5% Day 30 and BRI Blend 2.5% Day 30.

### Example 8

Repellency Bioassay—Two-Choice Test in Arenas Against German Cockroaches (Blattella germanica)

Two-choice bioassays to verify the repellency effect of some compounds by disrupting intraspecific communication associated with attraction promoted by food odors (kairomones) and/or substrates and textures (harborage/shelter), using adult males and females of Blattella germanica (German cockroach) were performed. Experimental arenas consisted of brand-new wading pools (114.3×20.1 cm, Polygroup Services N.A., Inc., El paso, TX). The bottom of each pool was lined with builder's paper (Pratt Industries, Inc., Conyers, GA) for cockroaches to have traction. The paper was sealed to the pool surface using silicone (Advance Silicone 2® Kitchen & Bath Sealant, Clear, GE, Rocky Hill, CT) to prevent cockroaches from getting underneath the contractor's paper, and to keep them on the surface of the experimental arena. Egg carton lids (15.8 cm×11.4 cm×7.1 cm; Okuna outpost, Rancho Cucamonga, CA) were treated prior the start of the tests with one of the following treatments: only ethanol (as negative control), DEET 10% (as positive control) and BRI Blend 5% (mixture of methyl 2(-3-oxo-2-pentylcyclopentyl)acetate, delta-dodecalactone, 3-methyl-5-ethyl-2-cyclohexenone, gamma methyl dodecalactone, tetrahydromethyl apritone, geranyl cyclopentanone (apritone, cyclopentanone,2-(3,7-dimethyl-2,6-octadienyl)-), 3-methyl-5-(z-3-hexenyl)-2-cyclohexenone, methyl apritol, gamma-tridecalactone, N,N-diethyl-2-(3-oxo-2-pentylcyclopentyl) acetamide, prenyl dihydro jasmonate, gamma-dodecalactone, farnesylcyclopentanone, 3-methyl-5-hexyl-2-cyclohexenol, methyl 2-(3,3-dimethoxy-2-penthylcyclopentyl)acetate and methyl jasmonate).

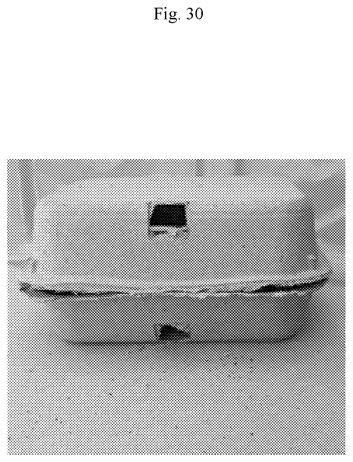

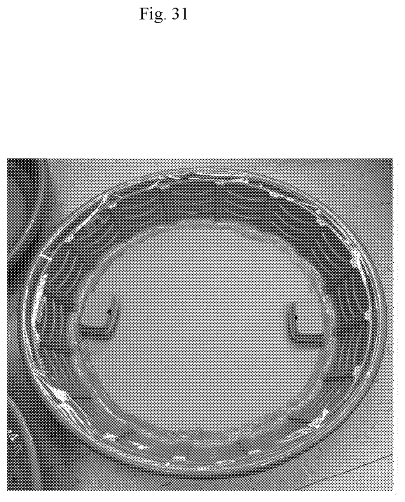

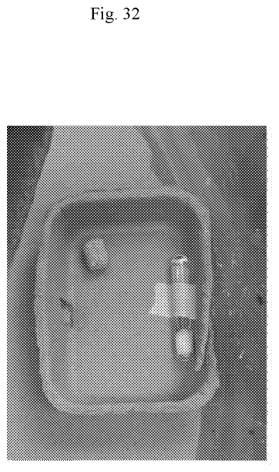

The lids were allowed to dry under a fume hood completely before testing (4 h). Two lids (both treated; 40 g in total applied) were placed together to form a harborage box to promote hiding/sheltering (FIG. 30). The sides of each arena were greased with mineral oil to prevent cockroach escape during the test. Two harborage boxes were placed into each arena; both sides of one box were treated with only ethanol (EtOH), while the other box was treated with one of the three treatments described above (FIG. 31). Each harborage box contained both food (regular dog food) and water (FIG. 32).

Fifty cockroaches (25 males and 25 females) were placed into deli cups and knocked down briefly with CO₂, the deli cups were then inverted with the cockroaches in the center of the arena. The cockroaches were allowed to recover under the up and acclimate in the arena for 20 minutes. The cups were then lifted gently to release the cockroaches into the arena. The cockroaches could choose between the two harborage boxes or remain in the open (arena) with no harborage, which is contrary to their natural behavior. Each experimental unit (replicate) was repeated three times per each treatment, totalizing 150 cockroaches used per treatment. After 24 hours, percent repellency was calculated as follows: Percent Repellency=(Number in untreated side/total number in arena)*100.

Percent repellency was compared among treatment groups using ANOVA, followed by Tukey's HSD test. All statistical tests were performed in JMP (Version 17.0.0 (622753); JMP Statistical Discovery LLC, Cary, NC).

### Results:

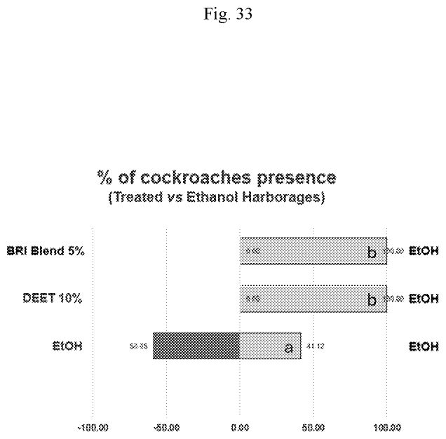

The results are summarized on FIG. 33 bar chart. Both the DEET 10% treatment (DEET 10% vs. ethanol) and the BRI Blend 5% treatment (BRI Blend 5% vs. ethanol) had significantly (F_{2,6}=44.1, p<0.001) greater percent repellency when compared to the ethanol treatment (ethanol vs. ethanol). BRI Blend 5% repellency effect was effective enough to disrupt intraspecific communication associated with attraction behavior promoted by food odors (kairomones) and/or attraction promoted by substrates and textures (harborage/shelter).

FIG. 30 shows two egg cartons stacked together to form a single treated harborage box.

FIG. 31 shows Two-choice arena containing 2 harborages, one treated with ethanol and one treated with one of three treatments (DEET 10%, BRI Blend 5% and Ethanol).

FIG. 32 shows harborage box containing both water and food (regular dog food) acting as attractant stimulus (kairomones) for cockroaches.

FIG. 33 shows the results from Example 8. FIG. 33 shows a bar graph illustrating mean % of cockroaches presence for DEET 10% treatment (DEET 10% vs. ethanol), BRI Blend 5% treatment (BRI Blend 5% vs. ethanol) and EtOH treatment (ethanol vs. ethanol). Means followed by the same letter do not differ by the Tukey HSD test (p≤0.001).

### Example 9

Repellency Bioassay—Two-Choice Test in Arenas Against Brazilian Yellow Scorpion (Tityus serrulatus)

Two-choice bioassays to verify the repellency effect of some compounds by disrupting intraspecific communication associated with attraction promoted substrates and textures (harborage/shelter), using adult females of Tityus serrulatus (Brazilian yellow scorpion) were performed. Experimental arenas consisted of a customized squared Plexiglas structure (50 cm×50 cm×15 cm). The bottom was lined with builder's paper for scorpions to have traction. Egg carton lids were treated prior the start of the tests with one of the following treatments: only ethanol (as negative control) and BRI Blend 5% (mixture of methyl 2(-3-oxo-2-pentylcyclopentyl)acetate, delta-dodecalactone, 3-methyl-5-ethyl-2-cyclohexenone, gamma methyl dodecalactone, tetrahydromethyl apritone, geranyl cyclopentanone (apritone, cyclopentanone,2-(3,7-dimethyl-2,6-octadienyl)-), 3-methyl-5-(z-3-hexenyl)-2-cyclohexenone, methyl apritol, gamma-tridecalactone, N,N-diethyl-2-(3-oxo-2-pentylcyclopentyl) acetamide, prenyl dihydro jasmonate, gamma-dodecalactone, farnesylcyclopentanone, 3-methyl-5-hexyl-2-cyclohexenol, methyl 2-(3,3-dimethoxy-2-penthylcyclopentyl)acetate and methyl jasmonate).

The lids were allowed to dry under a fume hood completely before testing (24 h). The sides of each arena were greased with mineral oil to prevent scorpion escape during the test. Two harborage boxes were placed into each arena; one lid was treated with only ethanol (EtOH), while the other lid was treated with BRI Blend 5.

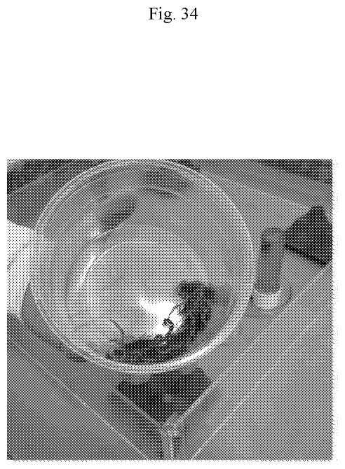

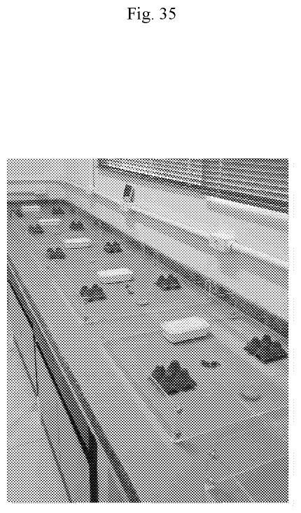

Five scorpions (all females) were placed into deli cups (FIG. 34) and then inverted with the scorpions in the center of the arena. The scorpions were allowed to recover under the up and acclimate in the arena for 20 minutes. The cups were then lifted gently to release the scorpions into the arena. The scorpions could choose between the two harborage lids (BRI Blend 5% or only ethanol) (FIG. 35). Each experimental unit (replicate) was repeated three times per each treatment, totalizing 15 scorpions used per treatment. After 24 hours, percent of choice (presence versus non-presence-repellency) was calculated.

Percent of choice was compared among treatment groups using ANOVA, followed by Tukey's HSD test. All statistical tests were performed using XLSTAT LIFE SCIENCES, version 1.3, 2025 software (Addinsoft, Paris, France).

### Results:

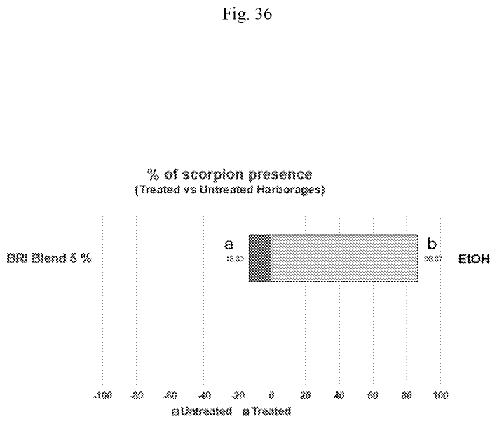

The results are summarized on FIG. 36 bar chart. The lids/harborages treated with BRI Blend 5% had significantly (p<0.001) less presence of scorpions (13.3%) when compared with lids/harborages treated only with ethanol (86.6%). BRI Blend 5% repellency effect was effective enough to disrupt attraction promoted by substrates and textures (harborage/shelter).

FIG. 34 shows female scorpions in a deli cup prior release into the test arenas.

FIG. 35 shows test arenas containing BRI Blend 5% treated lids versus ethanol treated lids.

FIG. 36 shows results from Example 9. FIG. 36 shows a bar graph illustrating mean % of scorpion presence for lids/harborages treated with BRI Blend 5% and lids/harborages treated with only ethanol (EtOH). Means followed by the same letter do not differ by the Tukey HSD test (p≤0.001).

What is claimed is:

1. A method for controlling or repelling one or more pests, the method comprising disrupting intraspecific communication or interspecific communication in said one or more pests, by exposing said one or more pests to a formulation comprising one or more compounds of structure (A) represented by the structure: 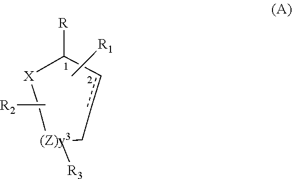
wherein
R is selected from the group consisting of —OH, ═O, —OC(O)R₄, —OR₆, —(OR₆)₂, wherein each R₆ is independently selected from an alkyl group containing from 1 to 4 carbon atoms and R₄ is a branched or straight chain, saturated or unsaturated hydrocarbyl group with zero to two double bonds and from 1 to 15 carbon atoms;
X is O or CH₂, with the proviso that when X is O, then R can only be ═O;
each Z is independently selected from the group consisting of (CH) and (CH₂);
y is a numeral selected from 1 and 2;
R₁ is selected from the group consisting of H or a branched or straight chain, saturated or unsaturated hydrocarbyl group with zero to two double bonds and from 1 to 15 carbon atoms;
R₂ is selected from the group consisting of H and a branched or straight chain, saturated or unsaturated hydrocarbyl group with zero to three double bonds and from 1 to 15 carbon atoms;
R₃ is selected from the group consisting of H and a branched or straight chain, saturated or unsaturated hydrocarbyl group with zero to three double bonds and from 1 to 15 carbon atoms, —(CH₂)ₙOH, —C(O)OR₅, —CH₂C(O)OR₇, —CH₂C(O)R₈, —C(O)NR₉R₁₀, —CH₂C(O)NR₁₁R₁₂ where each of R₅, R₇, R₈, R₉, R₁₀, R₁₁ and R₁₂ is independently selected from H and a branched or straight chain, saturated or unsaturated hydrocarbyl group with zero to three double bonds and from 1 to 15 carbon atoms and n is an integer of from 1 to 12;
the bond between the 2 and 3 positions in the ring structure may be a single or a double bond;
wherein the compounds of structure (A) contain from 11 to 20 total carbon atoms; and
wherein the one or more compounds of structure (A) are present in an amount from about 0.001% by weight to about 99% by weight.

2. The method according to claim 1 wherein the one or more pests are selected from the group consisting of agricultural pests, forestry pests, storage pests, urban pests, and public health pests.

3. The method according to claim 1 wherein the intraspecific communications comprise pheromone-mediated communications, and the interspecific communications comprise allelochemical and visual mediated communications.

4. The method according to claim 3 wherein the pheromone-mediated communications comprise communications associated with mating and aggregation behavior, the effect of sexual and aggregation pheromones, and attraction.

5. The method according to claim 3 wherein the allelochemical-mediated communications comprise communications associated with oviposition behavior, the attraction effect of crops and other substrates, and attraction.

6. The method according to claim 3 wherein the visual mediated communications comprises communications associated with attraction behavior due the effect of colors, shapes, and textures of substrates, and attraction.

7. The method according to claim 1 wherein the one or more pests are selected from the group consisting of pests from Phylum Arthropoda, or from Subphylum Hexapoda, or from Subphylum Chelicerata, or from Class Insecta, or from Class Arachnida.

8. The method according to claim 1 wherein the one or more pests are selected from the group consisting of Blatoddean pests, Coleopteran pests, Dermapteran pests, Dipteran pests, Hemipteran pests, Hymenopteran pests, Lepidopteran pests, Orthopteran pests, Psocodean pests, Siphonapteran pests, Thysanopteran pests, Zygentoman pests, Araneae pests, Ixodidan pests, Mesostigmatan pests, Sarcoptiformes pests, Scorpiones pests, Trombidiformes pests, and Acari pests.

9. The method according to claim 1 wherein the one or more pests are selected from the group consisting of pests from Families Archotermopsidae, Blattidae, Blatellidae, Kalotermitidae, Rhinotermitidae, Termitidae, Anobiidae, Bostrichidae, Brentidae, Buprestidae, Cerambycidae, Cleridae, Crytophagidae, Chrysomelidae, Curculionidae, Dermestidae, Elateridae, Lyctidae, Meloidae, Melolonthidae, Nitidulidae, Scarabeidae, Scolytidae, Silvanidae, Tenebrionidae, Trogossitidae, Forficulidae, Agromyzidae, Anthomyiidae, Cecidomyiiade, Chironomidae, Culicidae, Drosophilidae, Muscidae, Sarcophagidae, Sciaridae, Tabanidae, Tachinidae, Tephritidae, Aleyrodidae, Alydidae, Aphididae, Cercopidae, Cicadellidae, Cimicidae, Coccidae, Coreidae, Diaspididae, Margarodidae, Membracidae, Miridae, Ortheziidae, Pentatomidae, Phyloxeridae, Pseudococcidae, Psyllidae, Reduviidae, Rhyparochromidae, Thaumastocoridae, Apidae, Eulophidae, Formicidae, Siricidae, Vespidae, Cossidae, Crambidae, Depressariidae, Erebidae, Gelechiidae, Geometridae, Gracillariidae, Lyonetiidae, Megalopygidae, Mimallonidae, Nymphalidae, Noctuidae, Phycitidae, Plutellidae, Pyralidae, Riodinidae, Saturnidae, Thaumetopoeidae, Tineidae, Tortricidae, Acrididae, Gryllidae, Gryllotalpidae, Tettigoniidae, Haematopinidae, Linognathidae, Menoponidae, Pediculidae, Phthiridae, Trichodectidae, Hectopsyllidae, Pulicidae, Thripidae, Lepismatidae, Ctenidae, Sicariidae, Theridiidae, Ixodidae, Varroidae, Acaridae, Buthidae, Eriophyidae, Tarsonemidae, Tenuipapidae, and Tetranychidae.

10. The method according to claim 1 wherein the one or more pests are selected from the group consisting of beetles, flies, ants, moths, butterflies, grasshoppers, thrips, mites, true bugs, bed bugs, aphids, weevils, ants, leafhoppers, crickets, mealybugs, scales, psyllids, wasps, ticks, spiders, scorpions, locusts, termites, bees, stinkbugs, caterpillars, larva, whiteflies, crickets, cockroaches, fleas, earwigs, grubs, fruit flies, midges, scarabs, mosquitoes, hornets, silverfishes, firebrats, bristletails, and lice.

11. The method according to claim 1 wherein the one or more pests are selected from the group consisting of pests of fruits and tree nuts, pests of vegetables, pests of field crops, pests of row crops, soil pests, seed pests, pests of ornamentals, pests of herbs and spices, pests of trees, palm tree pests, pests of turf, pests of pasture, forestry pests, pest of greenhouses, storage pests, grain pests, structural pests, urban pests, disease vector pests, public health pests, and veterinary pests.

12. The method according to claim 1 wherein the one or more compounds of structure (A) are present in an amount from about 0.001% by weight to about 90% by weight, or from about 0.001% by weight to about 75% by weight, or from about 0.001% by weight to about 50% by weight, or from about 0.001% by weight to about 25% by weight, or from about 0.001% by weight to about 10% by weight, or from about 0.001% by weight to about 5% by weight, based on the total weight of the formulation.

13. The method according to claim 1 wherein the one or more compounds of structure (A) comprise a compound wherein R is —OH, ═O, O(O)CR; R₁ is H or CH₃; R₂ is H or CH₃; R₃ is H or a branched or straight chain, saturated or unsaturated hydrocarbyl group with zero to three double bonds, and from 1 to 11 carbon atoms; and wherein the compounds of structure (A) contain from 6 to 20 total carbon atoms; or
wherein the one or more compounds of structure (A) comprise a compound wherein R is ═O or —OH, X is CH₂, Z is (CH) or (CH₂), y is 1, the bond between positions 2 and 3 is a single bond, R₁ is H, R₂ is H, and R₃ is an alkenyl group having at least 11 carbon atoms and 1 or 2 double bonds; or
wherein the one or more compounds of structure (A) comprise a compound wherein R is ═O or —OH, X is CH₂, Z is (CH) or (CH₂), y is 1, the bond between positions 2 and 3 is a single bond, R₁ is an alkyl group having at least 5 carbon atoms, R₂ is H, and R₃ is —C(O)OR₅, and R₅ is an alkyl or alkenyl group containing at least 3 carbon atoms; or
wherein the one or more compounds of structure (A) comprise a compound wherein R is ═O, X is O, Z is CH or CH₂, y is 1 or 2, the bond between positions 2 and 3 is a single bond, R₁ is an alkyl group of from 7 to 11 carbon atoms, R₂ is H, and R₃ is H or CH₃.

14. The method according to claim 1 wherein the one or more compounds of structure (A) are selected from the group consisting of 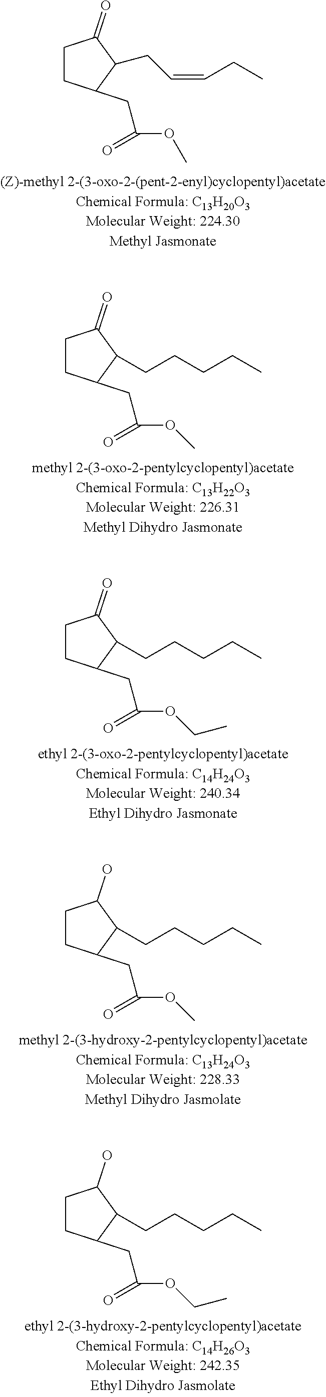 [SMILES: CC/C=C\CC1C(=O)CCC1CC(=O)OC ; CCCCCC1C(=O)CCC1CC(=O)OC ; CCCCCC1C(=O)CCC1CC(=O)OCC ; CCCCCC1C(O)CCC1CC(=O)OC ; CCCCCC1C(O)CCC1CC(=O)OCC] 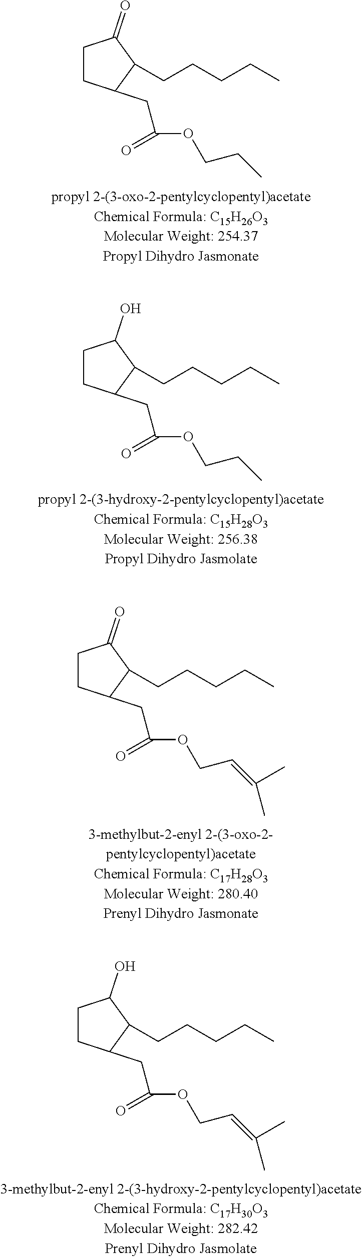 [SMILES: CCCCCC1C(=O)CCC1CC(=O)OCCC ; CCCCCC1C(O)CCC1CC(=O)OCCC ; CCCCCC1C(=O)CCC1CC(=O)OCC=C(C)C ; CCCCCC1C(O)CCC1CC(=O)OCC=C(C)C] 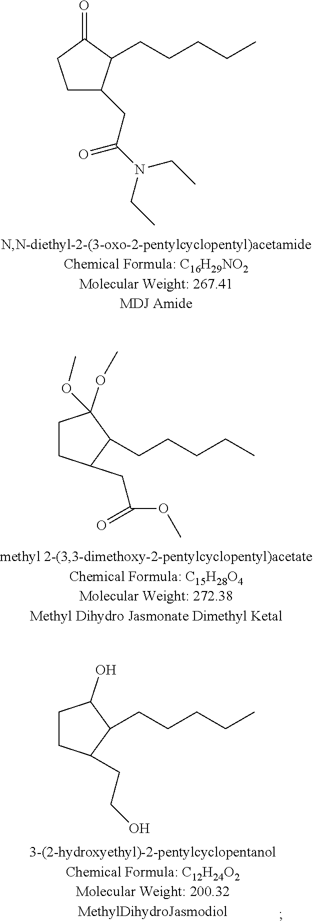 [SMILES: CCCCCC1C(=O)CCC1CC(=O)N(CC)CC ; CCCCCC1C(CC(=O)OC)CCC1(OC)OC ; CCCCCC1C(O)CCC1CCO]
or
wherein the one or more compounds of structure (A) are selected from the group consisting of: 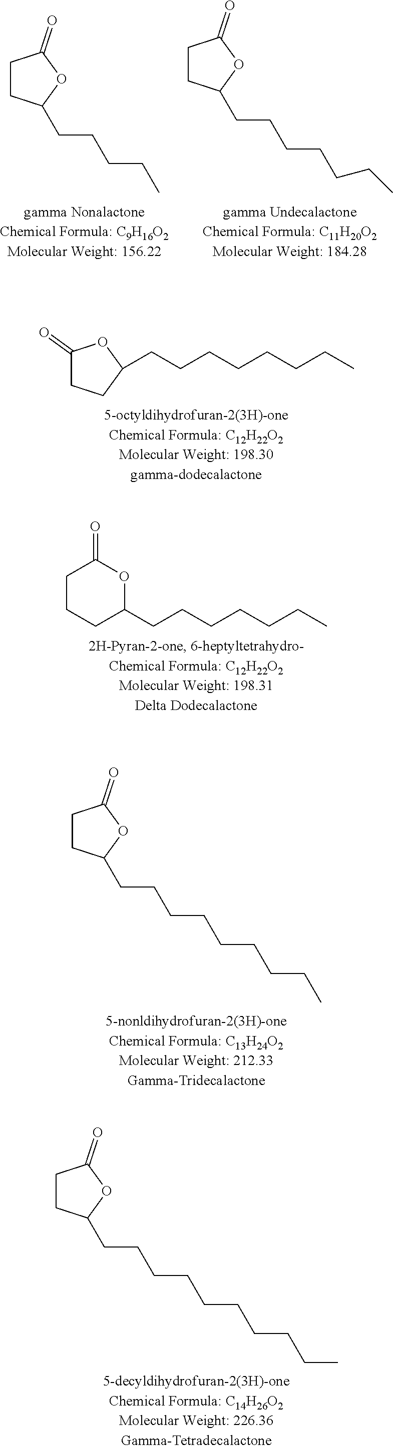 [SMILES: CCCCCC1CCC(=O)O1 ; CCCCCCCC1CCC(=O)O1 ; CCCCCCCCC1CCC(=O)O1 ; CCCCCCCC1CCCC(=O)O1 ; CCCCCCCCCC1CCC(=O)O1 ; CCCCCCCCCCC1CCC(=O)O1] 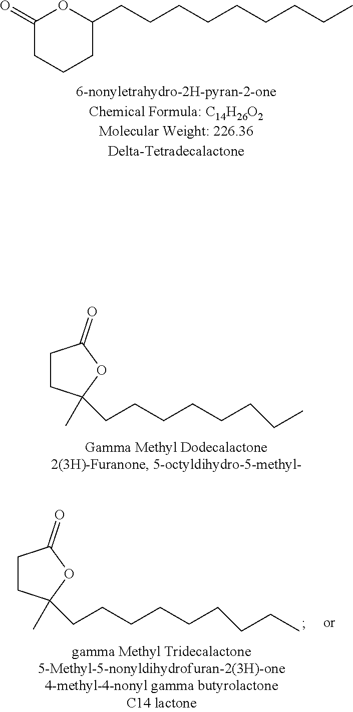 [SMILES: CCCCCCCCCC1CCCC(=O)O1 ; CCCCCCCCC1(C)CCC(=O)O1 ; CCCCCCCCCC1(C)CCC(=O)O1]
wherein the one or more compounds of structure (A) are selected from the group consisting of: 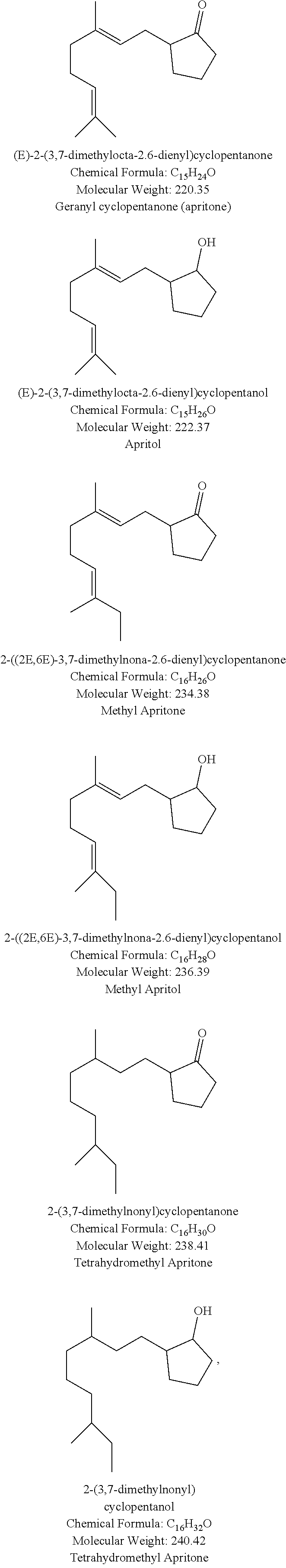 [SMILES: CC(C)=CCC/C(C)=C/CC1CCCC1=O ; CC(C)=CCC/C(C)=C/CC1CCCC1O ; CC/C(C)=C/CC/C(C)=C/CC1CCCC1=O ; CC/C(C)=C/CC/C(C)=C/CC1CCCC1O ; CCC(C)CCCC(C)CCC1CCCC1=O ; CCC(C)CCCC(C)CCC1CCCC1O]
or
wherein the one or more compounds of structure (A) are selected from the group consisting of: 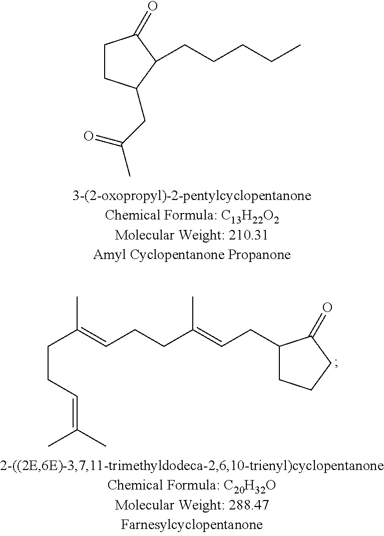 [SMILES: CCCCCC1C(=O)CCC1CC(C)=O ; CC(C)=CCC/C(C)=C/CC/C(C)=C/CC1CCCC1=O]
or
wherein the one or more compounds of structure (A) are selected from the group consisting of:

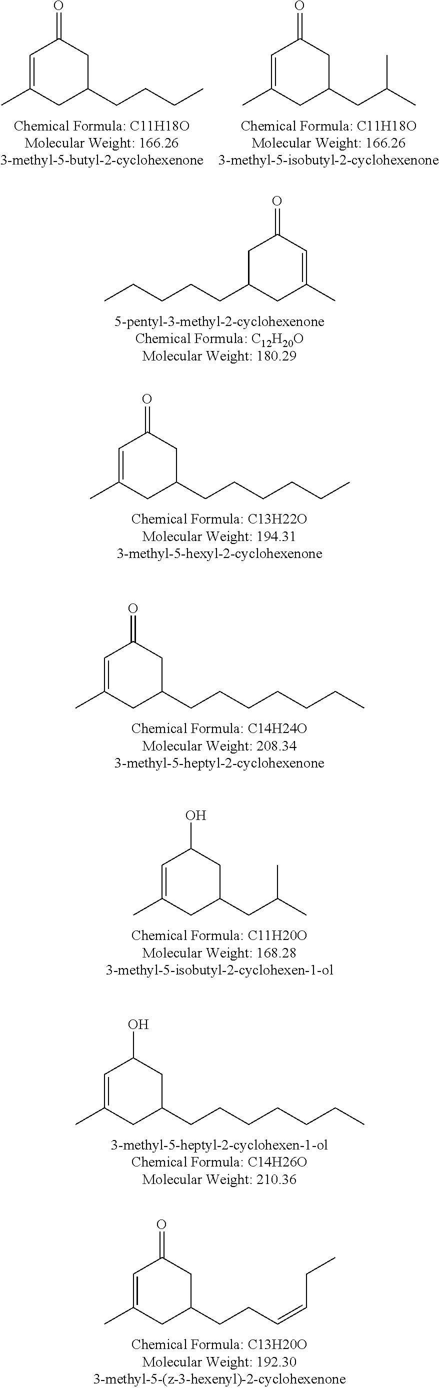

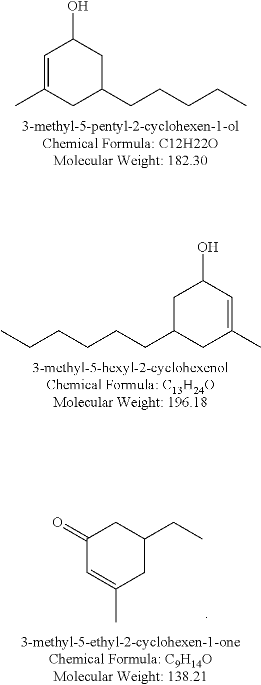

15. The method according to claim 1 wherein the one or more compounds of structure (A) is represented by the formula:

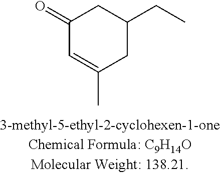

16. The method according to claim 1 wherein the one or more compounds of structure (A) comprise methyl jasmonate, methyl dihydrojasmonate, ethyl dihydrojasmonate, propyl dihydrojasmonate, geranyl cyclopentanone (apritone, cyclopentanone, 2-(3,7-dimethyl-2,6-octadienyl)-), methyl apritone (cyclopentanone, 2-(3,7-dimethyl-2,6-nonadien-1-yl)-), delta-dodecalactone, gamma-dodecalactone, gamma-undecalactone, gamma methyl dodecalactone, gamma-tridecalactone, gamma methyl tridecalactone, gamma-tetradecalactone, 3-methyl-5-ethyl-2-cyclohexenone, 3-methyl-5-propyl-2-cyclohexenone, 3-methyl-5-butyl-2-cyclohexenone, 3-methyl-5-pentyl-2-cyclohexenone, 3-methyl-5-hexyl-2-cyclohexenone, or 3-methyl-5-heptyl-2-cyclohexenone.

17. The method according to claim 1 wherein the formulation further comprises one or more of a carrier or diluent, an organic solvent, a rheological modifier or gelling agent, a preservation agent, a surfactant, or any combination thereof.

18. The method according to claim 1 wherein the formulation further comprises one or more of a wetter, a spreader, a sticker, a penetrant, a buffer, a sequestering agent, a drift reduction agent, a compatibility agent, an anti-foam agent, a cleaning agent, a plasticizer agent, an antifreeze agent, an UV blocking agent, an anti-oxidant agent, an emulsifier, a film former, or any combination thereof.

19. The method according to claim 1 wherein the formulation is formulated into granules, dusts, soluble powders, wettable powders, pastes, emulsifiable concentrates, aerosols, ultra low-volume concentrates, flowable suspensions, oils, sprays, lures, biodegradable flakes, microcapsules, plastic flakes, emulsions, microemulsions, wax emulsions, pellets, natural waxes, synthetic waxes, resins, glues, puffers, membrane systems, film systems, pouches, bubble caps, blocks, monoliths, gels, polyacrylamide plugs, tablets, mesoporous materials, polymer tubes, or any combinations thereof; or
wherein the formulation is formulated into a sprayable, solid, semi-solid, liquid, thermal fogging, or nebulization form.

20. The method according to claim 1 wherein the formulation is a controlled released system, or is diffused, or is released actively or passively.

21. The method according to claim 1 wherein the formulation is distributed in agricultural applications within a total area, perimeter, border, specific rows, lines, or any combination thereof, and is applied manually, mechanically, or electronically in agricultural applications directly or indirectly on crops; or
wherein the formulation is applied or distributed in forestry applications within a total area, perimeter, border, single trees, groups of trees, or any combination thereof, and is applied manually, mechanically or electronically in forestry applications directly or indirectly on trees; or
wherein the formulation is distributed in storage area applications within a total area, perimeter, border, internal areas, external areas, or any combination thereof, and is applied manually, mechanically or electronically, directly or indirectly on storage areas; or
wherein the formulation is distributed in urban area applications within a total area, perimeter, border, internal areas, external areas, homes, buildings, residences, streets, parks, public spaces, or any combination thereof, and is applied manually, mechanically, or electronically, directly or indirectly on urban areas.

22. The method according to claim 1 wherein the formulation is a synergistic formulation.

23. The method according to claim 22 wherein the synergistic formulation produces, when the pests are exposed to the synergistic formulation, a combined repellency effect greater than the sum of the separate repellency effects from the separate compounds of structure (A), at comparable concentrations.

24. The method according to claim 1 the one or more compounds of structure (A) are present in an amount from about 100 kilograms per hectare or less, or about 500 grams per hectare or less, or about 100 grams per hectare or less, about 1 gram per hectare or less, or about 0.1 grams per hectare or less.

25. The method according to claim 1 further comprising applying said formulation to loci where agave, alfalfa, almonds, anise, apples, apricots, artichokes, asparagus, avocados, bananas, barley, basil, bay leaves, beans, beets, bell peppers, berries, blackberries, blueberries, broccoli, Brussels sprouts, buckwheat, cabbage, canola, carrots, cashews, cassava, cauliflower, celery, cherries, chestnuts, chickpeas, cocoa, coconut, coffee, corn, coriander, cotton, cranberry, crucifers, cucumbers, dates, eggplant, flowers, fennel, figs, flax, grapes, guava, hazelnuts, hemp, hop, fodder species including rye grass, Sudan grass, tall fescue, Kentucky blue grass, and clover; fruits, garlic, grapefruit, kale, kiwi, leek, lentils, lettuce, limes, lemons, loquats, lychee. macadamia, mango, melons, millet, mint, mulberry, mustard, nectarines, nuts, oats, oil seed crops, okra, olives, onions, oranges, oregano, papaya, parsley, parsnip, passion fruit, peaches, peanuts, peas, pears, peppers, persimmons, pineapples, pistachios, plums, pomegranate, potatoes, pumpkins, quinoa, rapeseed, raspberries, rice, rosemary, rye, saffron, sage, shallots, sesame, star fruit, sorghum, soybeans, spinach, strawberries, sugarcane, sugar beets, sunflowers, sweet potatoes, tea, tobacco, tomatoes, thyme, vanilla, walnuts, watermelon, wheat or yerba mate is growing, or the seeds thereof are going to be planted; or
applying said formulation to loci where Angelica tree, American elm, Ashe juniper, Balsam fir, Blackwood, Cedar, Chestnut Oak, Douglas-fir, Eastern White pine, Engelman spruce, Eucalyptus, Firs, Gambel oak, Hemlocks, Hickory, Ipe, Jack pine, Juniper, Loblolly pine, Longleaf pine, Mahogany, Oaks, Peroba, Pines, Pinus, Ponderosa pine, Red maple, Redwood, Rubber tree, Shortleaf pine, Spruce, Sugar maple Sugar pine, Wattles, Western hemlock, Western Larch, Western white pine, or White Oak is growing, or the seeds thereof are going to be planted.
